(19) United States
(12) Patent Application Publication
(10) Pub. No.: US 2024/0142379 A1
(43) Pub. Date: May 2, 2024

(54) METHODS AND SYSTEMS FOR IMAGING REACTION PRODUCTS

(71) Applicant: CORNELL UNIVERSITY, Ithaca, NY (US)

(72) Inventors: Peng Chen, Ithaca, NY (US); Rong Ye, Ithaca, NY (US); Xiangcheng Sun, Rochester, NY (US); Xianwen Mao, Singapore (SG)

(21) Appl. No.: 18/144,022

(22) Filed: May 5, 2023

Related U.S. Application Data
(60) Provisional application No. 63/338,793, filed on May 5, 2022.

(51) Int. Cl. G01N 21/64; B01J 19/00; C07F 5/02; C08F 132/08

(52) U.S. Cl. CPC G01N 21/6458; B01J 19/0093; C07F 5/022; C08F 132/08; G01N 21/6402; G01N 21/6428; G01N 2021/6439

(57) ABSTRACT

Methods and systems for reaction product imaging. In various examples, a method is used to image fluorogenic reaction product(s), such as, for example, fluorogenic polymerization product(s) or the like. In various examples, a method of imaging a fluorescent polymerization product comprises a photo-uncaging reaction, a fluorogenic polymerization, and obtaining one or more fluorescence image(s) of one or more of the fluorescent polymerization product(s). In various examples, a system for imaging a fluorescent polymerization product comprises a first laser suitable to initiate a photo-uncaging reaction; and a second laser suitable to obtain one or more fluorescent image(s) of fluorogenic reaction product(s) and the product(s) is/are disposed on a substrate. In various examples, a method and/or a system is used to determine a polymer sequence, reaction kinetics, reaction dynamics, catalysis cooperativity between spatially distinct sites, molecular adsorption onto a surface, or the like.

### CROSS-REFERENCE TO RELATED APPLICATIONS

This application claims the benefit of U.S. Provisional Patent Application No. 63/338,793, filed May 5, 2022; the contents of the above-identified application are hereby fully incorporated herein by reference in their entirety.

### STATEMENT REGARDING FEDERALLY SPONSORED RESEARCH

This invention was made with government support under grant number W911NF-18-1-0217 awarded by the Army Research Office. The government has certain rights in the invention.

### BACKGROUND OF THE DISCLOSURE

Synthetic polymers are fundamental commodities in the modern society. Many of them are copolymers, in which various monomers can differ widely in physiochemical properties, such as charge, polarity, rigidity, solubility, or functional group to provide the copolymer tailorable properties. The sequence of monomers in the polymers is also crucial.

Random, alternating, periodic, block, and gradient synthetic copolymers can differ drastically in their properties even with identical monomer compositions. For biological copolymers, such as proteins or nucleic acids, their sequences can uniquely determine their structure/function or genetic information, respectively. Consequently, sequence determination is a key step in understanding the structure-function relations of copolymers. For proteins or nucleic acids, their sequences could be determined at the single-molecule level, facilitated by that they can be obtained in pure forms where every copy is identical. For synthetic polymers, advanced synthetic approaches have made it possible to make sequence-defined ones to tune, for example, their reactivity and self-assembly behavior. But in general, synthetic copolymers are highly heterogeneous: individual chains differ in length, composition, and sequence, and their structure-property relationships are only defined at the bulk, averaged level. How the microscopic sequence of a synthetic copolymer determines its property remains largely unknown. This knowledge gap and synthetic polymers' ubiquitous heterogeneity call for single-polymer sequencing methods that can resolve and identify individual monomers, preferably in organic solvents where most synthetic polymers are made. Bayley and coworkers have used single-nanopore electrical measurements to track in real time the polymerization of single poly(disulfide)s in water at single-monomer resolution, but the polymer is limited to ˜10 subunits before the nanopore is blocked. Using scanning tunneling microscopy, Guo et al imaged polymerization of single polyethylene of ˜10 subunits on solid surfaces from gaseous ethylene.

### SUMMARY OF THE DISCLOSURE

The present disclosure provides, inter alia, methods and systems for imaging one or more reaction product(s). In various examples, the present disclosure also provides systems for imaging one or more polymerization reaction product(s) (such as, for example, fluorogenic polymerization product(s) and the like).

In various examples, a method of imaging a fluorescent polymerization product or the like comprises: a photo-uncaging reaction, where the photo-uncaging reaction produces a plurality of un-caged monomers, each un-caged monomer comprising a reactive group, and a fluorophore group; a fluorogenic polymerization, where the fluorogenic polymerization comprises reaction of at least a portion of the plurality of the un-caged monomers to form one or more fluorescent polymerization product(s), and where each of the uncaged monomers reacts with a catalyst or a polymer chain disposed on a substrate; and obtaining one or more fluorescence image(s), each fluorescent image comprising one or more of the fluorescent polymerization product(s), where a change or changes in the fluorescence image(s) is/are indicative of one or more feature(s) of the reacted un-caged monomer and/or the catalyst or the substrate. In various examples, the substrate is a particle, a planar substrate, a non-planar substrate, or the like. In various examples, at least a portion of or all the un-caged monomers further comprise a side-chain group or the like, where the fluorophore group is covalently bound to the monomer or the like. In various examples, the side-chain group or the like does not substantially interfere with the fluorogenic polymerization. In various examples, the plurality of uncaged monomers comprises at least two different uncaged monomers. In various examples, at least two different uncaged monomers are different in terms of fluorescence emission. In various examples, the method further comprises, prior to the photo-uncaging reaction, providing a mixture comprising a plurality of caged monomers, each caged monomer comprising a reactive group, a fluorophore group, and a photocleavable caging group. In various examples, all the caged monomers present in the mixture comprise a fluorophore group. In various examples, the un-caged monomer(s) is/are present at a concentration of less than about 10⁻⁹ M. In various examples, the method further comprises, after the fluorogenic reaction and prior to the obtaining the fluorescence image(s), waiting a period of time sufficient for substantially all the unreacted uncaged monomers to diffuse or be removed from proximity to the reacted uncaged monomer(s). In various examples, at least a portion of or all the fluorescence image(s) is/are single-molecule localization microscopy image(s). In various examples, two or more fluorescence images are obtained using different wavelengths. In various examples, the method further comprises substantially or completely bleaching the fluorophore. In various examples, the obtaining the one or more fluorescent image(s) results in bleaching of substantially all or all the fluorophore(s). In various examples, the method further comprises repeating the photo-uncaging reaction, the fluorogenic polymerization, or the obtaining one or more fluorescence image(s), or any combination thereof a desired number of times. In various examples, the method further comprises photocleaving the fluorophore group(s) from substantially all or all the product of the reaction of the un-caged monomer(s) and the catalyst(s), the polymer chain(s), or both. In various examples, the method is used to determine a polymer sequence, reaction kinetics, reaction dynamics, catalysis cooperativity between spatially distinct sites, or molecular adsorption onto a surface.

In various examples, a system for imaging a fluorescent polymerization product or the like comprises: a first laser configured to provide coherent electromagnetic radiation comprising a first wavelength, where the first wavelength is suitable to initiate a photo-uncaging reaction; and a second laser configured to provide coherent electromagnetic radiation comprising a second wavelength, where the second wavelength is suitable to obtain one or more fluorescent image(s) of a product of a fluorogenic polymerization of a monomer comprising a fluorophore and the product is disposed on a substrate. In various examples, the system further comprises one or more reactor(s) or the like, each reactor independently configured to carry out a photo-uncaging reaction and/or a fluorogenic polymerization. In various examples, one or more or all the one or more reactor(s) is/are microfluidic reactors or the like. In various examples, the second laser is configured for activation for a duration sufficient to both fluorescence image and to substantially or completely photobleach a product of a fluorogenic polymerization of a monomer comprising a fluorophore or the like. In various examples, the system further comprises a third laser configured to provide coherent electromagnetic radiation comprising a third wavelength, where the third wavelength is suitable to obtain one or more florescent image(s) of a product of a fluorogenic polymerization of a monomer that is different than the product of the fluorogenic polymerization of that can be fluorescence imaged using the second laser. In various examples, the first laser, the second laser, and third laser, if present, are arranged in a total internal reflectance geometry, epi-illumination geometry, or the like. In various examples, the third laser configured for activation for a duration sufficient to both fluorescence image and to substantially or completely photobleach a product of a fluorogenic polymerization of a monomer comprising a fluorophore or the like. In various examples, the system is configured to fluorescence image a product of a fluorogenic polymerization of a monomer or the like. In various examples, at least a portion of or all the fluorescence image(s) is/are single-molecule localization microscopy image(s) or the like. In various examples, the product is a single polymer chain or a plurality of polymer chains, where each polymer chain of the plurality of polymer chains is separated from the other polymer chains of the plurality of polymer chains by at least about 20 nm.

### BRIEF DESCRIPTION OF THE FIGURES

The patent or application file contains at least one drawing executed in color. Copies of this patent or patent application publication with color drawing(s) will be provided by the Office upon request and payment of the necessary fee.

For a fuller understanding of the nature and objects of the disclosure, reference should be made to the following detailed description taken in conjunction with the accompanying figures.

FIGS. 1a-i show CREATS for single-molecule super-resolution imaging of ROMP at high monomer concentrations. a, Design of CREATS, illustrated by coupling a surface-grafted chain-growth polymerization reaction (e.g., ROMP catalyzed by G2 catalyst) and a fluorogenic photo-uncaging reaction. b, Laser and camera timing diagram for repeated cycles of uncaging, (2-color) imaging, and bleaching the inserted monomers during polymerization. c-e, Structures of three caged monomers and the uncaging reaction scheme (c). Fluorophores are color-coded. The caging group is shaded in grey. f, Fluorescence spectra of monomer A-C after photo-uncaging. g, Fluorescence spectra of monomer A uncaging under 375-nm irradiation (˜30 mW/cm²) over time in CHCl₃. h, Fluorescence intensity at 518 nm vs. time from g. Line: fit with y=abx/(1+bx)+c, where a=73±1, b=1.21±0.07 min⁻¹, c=0±1. i, Scheme of green BODIPY dye-labeled G2 catalyst after grafting onto norbornene-functionalized silica particle bearing a magnetic core.

FIGS. 2a-j show super-resolution imaging of single-polymer growth at single-monomer resolution. a, Fluorescence image of a dye-labeled catalyst on a magnetic marker particle. Purple line: structural contour of the marker particle from SEM, expanded by image pixel size of ˜267 nm (FIG. 8a), (FIGS. 8a-j). Circles and star: localizations of the catalyst from each image and that from the frame-averaged image, respectively. b, Background-subtracted fluorescence intensity trajectory of the labeled catalyst from a, showing a single photobleaching step (blue arrow), characteristic of single molecules. The x-axis is plotted against image frame index instead of time because the images were not taken at consistent time intervals due to our cyclic uncaging, delay, and imaging scheme (g21b). c, A segment of background-subtracted fluorescence intensity trajectory during polymerization on the catalyst in a at [A]=0.1 μM. Vertical dashed lines mark the start of the 488 nm imaging laser. d, Histogram of r from the catalyst in a at [A]=0.1 μM. Solid line: exponential fit with a time constant of 0.10±0.02 h. e, Locations of inserted monomers during polymerization (one green dot: one monomer), overlaid on the catalyst location (blue star) and marker particle contour (purple line) from a. Top and right: 1-dimensional histograms of the monomer locations; their spatial dispersion around the catalyst is ˜49 nm (FWHM of Gaussian fit. f-g, Same as b, but for two marker particles carrying 2 and 7 catalysts, respectively. h, Histogram of number of catalysts per marker particle. Solid line: Gaussian fit centered at 3.0±0.1. i, Same as e, but for the 2 catalysts in f. j, 2-dimensional histogram of the monomer localizations overlaid on the catalyst positions and marker particle contour for the 7 catalysts in g. Bin size: 50² nm². The spatial dispersion of the monomers around each catalyst position is about 22-61 nm in i and j.

FIGS. 3a-f show single-catalyst polymerization kinetics and dynamics at single-monomer resolution. a-b, Single-catalyst TOF vs. monomer concentration [A] (a) and [B] (b). Grey dots and lines: individual catalysts. Red squares: average of 174 (a) and 49 catalysts (b). Red lines: linear fits. c-d, Histograms of single-catalyst first-order kinetic constant for monomer A (c) and B (d) from a-b. Lines: log-normal fits centered at 21 and 24 with standard deviations of 15 and 14 μM⁻¹ h⁻¹, respectively. e, Single-catalyst TOF vs. the polymerization degrees for monomer A. Lines: global fits with y=ax/(x 30 L_{1/2})+c with shared L_{1/2} (=270±50 monomers), which is the polymerization degree where the TOF is half-way toward saturation. f. Green: autocorrelation function of microscopic reaction time τ, C_{τ}(m)= [symbol] Δτ(0)Δτ(m) [symbol] / [symbol] Δτ² [symbol] , where m is the index of monomer A (0.1 μM) insertions in the single-catalyst polymerization trajectory, Δ₉₆ (m)=τ(m)− [symbol] τ [symbol] , and [symbol] [symbol] denotes averaging. C_{τ}(m) here is weight-averaged based on the trajectory lengths from 14 catalysts showing ≥20 turnovers of A. Solid green line: exponential fit, with amplitude of 0.25±0.03 and time constant of 2±1. Black squares: C_{τ}(m) from randomized τ sequences. Error bars: s.d. in a, b, e; s.e.m. in f.

FIGS. 4a-j show single copolymer sequencing. a, Localizations of individual polymerized monomer A (green dots) and B (yellow dots) around a single labeled G2 catalyst (blue star) at A:B=1:1. Purple line: expanded contour of the magnetic marker particle from its SEM image. Additional examples are shown in FIG. 11. b, A segment of background-subtracted 2-color fluorescence intensity trajectory on the catalyst in a, showing the sequence of the grown copolymer. Vertical dashed lines: timing of the 488 and 532 nm imaging lasers. c, Sequences of 6 selected copolymers at A:B=1:1. Green and yellow blocks denote blocks of 3 or more of A and B subunits, respectively; other sequence patterns are in grey. Copolymer 1 is from a, b. More sequences are in Table 1. d, Length distribution of 33 sequenced copolymers. e, Gray: ratio of A/B subunits in the individual sequenced copolymers vs. supplied A/B monomer concentration ratio. Red open squares: binned and averaged results. Red line: diagonal. f, Single-catalyst TOF vs. total monomer concentrations on 25 catalysts. Red open squares: binned and averaged results. Red line: linear fit. g, Distributions of 4 different microscopic monomer insertion time τ during copolymerization at [A]=[B]=0.05 μM. Solid lines: exponential fits, whose decay constants give the r_{AA}, r_{AB}, r_{BA}, and r_{BB} as 1.5±0.2, 0.9±0.1, 0.8±0.1, and 1.5 +0.1 h⁻¹, respectively. h, 1^{st}-order rate constants of the four propagation reactions. X, Y=A or B; XX=AA or BB. i, Distribution of observed total number of A or B monomers in different block sizes in comparison with that of the simulated random copolymers at A:B=1:1. Black line: fit with y=('x/2^{x}, where ('is a constant. The last bin represents blocks of 15 and larger. j, Conditional probability P of sequence fragments extracted from data of 1:1 copolymers and from simulations of random copolymers (averaged from 1000 sets) of the same A:B ratio. Blue line: saturation fit, based on

$$f ( x ) = \frac{a ( x - 1 )}{( x - 1 ) + b} + 0.5 ,$$

so that f(1)=0.5 is guaranteed; a=0.43±0.01, b=1.1±0.1; b here is the value at which the conditional probability is half-way toward saturation. Error bars: s.d. in e-f, h-i, s.e.m. in j.

FIGS. 5a-e show additional experimental design schemes and results. a, Schematic of the chain propagation mechanism in ROMP. b, Scheme of the experimental setup for imaging real-time polymerization reactions in operando via total internal reflection fluorescence microscopy. c, Absorption and emission spectra of uncaged monomers A and B (denoted as A′ and B′) along with the imaging laser lines (488 nm and 532 nm) and emission filters 1540 used in the two-color imaging experiments. A notch filter 1540 is further used to suppress the 532 nm laser light in the A′ detection channel (see d). d, Light splitting/filtering scheme in the two-color imaging experiment. “560 dichroic”: dichroic mirror 1550 at 560 nm (FF560-FDi01); “532 notch”: notch filter 1540 at 532 nm (ZET532TopNotch™). DV2 is a two-channel imaging system. e, Photograph of organic solvents in a glass vial sitting in the home-made photobleaching device turned off (top) and turned on (bottom). The plastic cap of the vial is wrapped by aluminum foil for protection.

FIGS. 6a-b show photo-uncaging of monomer B and C and their fluorescence on-off ratios. a, Time-dependent bulk fluorescence spectra of monomer B after periods of uncaging under 375 nm irradiation in CHCl₃. The fluorescence is excited at 560 nm. Inset: Fluorescence intensity at 595 nm vs. time of 375 nm uncaging irradiation. Line: fit with y=abx/(1+bx)+c, where a=307±6, b=0.53±0.04 min⁻¹, c=14±5. The on-off ratio (a+c)/c is ˜23. b, Time-dependent bulk fluorescence spectra of monomer C after periods of uncaging under 375 nm irradiation in CHCl₃. Fluorescence is excited at 575-nm. Inset: Fluorescence intensity at 627 nm vs. time of 375 nm uncaging irradiation. Line: fit with y=abx/(1+bx)+c, where a=377±25, b=0.41±0.09 min⁻¹, c=77±14. The on-off ratio (a+c)/c is ˜5.9.

FIGS. 7a-l show photo-uncaging properties of monomers and photobleaching and fluorescence intensity properties of the uncaged monomers/fluorophores. a-c, Uncaging condition during polymerization imaging should complete monomer uncaging in 1-2 cycles. a, Imaging scheme of uncaging kinetics of monomer A (or B) immobilized in a PMMA matrix on a quartz slide immersed in toluene. This experiment is carried out in the same setup as in the polymerization imaging experiment, except that a fixed amount of solvent stays in the reaction flow cell in this experiment instead of a constant supply of monomer solution in the polymerization imaging. The purpose of this experiment is to explore the 375 nm illumination conditions (intensity and duration) for complete uncaging of monomer A (or B) in 1˜2 cycles; the 488 nm (or 532 nm) illumination & imaging step in each cycle guarantees total photobleaching of the uncaged monomers within the same cycle (see d-i). b, Solid olive circles: the total intensity of the first frame in each imaging cycle vs. the cycle index in the experiment described in a. Olive line: fit of olive data with I=A+Be^{-x/t}, where 1=6±1 cycles, A=(2.06±0.01)×10⁸, B=(2.5 +0.2)×10⁷. Solid orange square: results from imaging similar to a, except that monomer B instead of monomer A is imaged using 532 nm laser. Orange line: fit of orange data with I=A+Be^{-x/t}, where t =7±1 cycles, A=(3.40±0.06)×10⁷, B=(1.32±0.06)×10⁷. c, Black square: results from imaging similar to a, except that 375 nm illumination is 3 s per cycle. Black line: fit with I=AA+Be^{-x/t}, where t=2±1 cycles. Red circle: results from imaging similar to a, except that the power of 375 nm illumination is 30 mW. Red line: fit with I=A+Be^{-x/t}, where 1=2±2 cycles. d-i, 488 nm (d-g) and 532 nm (h-i) laser imaging conditions ensure complete photobleaching of uncaged monomers during each imaging cycle. d, Total intensity per frame (0.1 s exposure time) vs. imaging time in a representative imaging cycle after uncaging at 10 nM of monomer A under 33.0 mW of 488 nm illumination over an area of 0.015 mm². Line: fit with I=A+Be^{-x/t}, where time constant I=1.8±0.1 s, A=(2.53±0.02)×10⁸, B=(6.41±0.04)×10⁷. e, Histogram of time constants in 720 cycles of uncaged monomer A photobleaching (as shown in d), with an average of 2.2±0.3 s. f, Total intensity per frame (0.1 s exposure time) vs. imaging time from uncaged monomer A immobilized in a PMMA matrix on a quartz slide. Line: fit with I=A+Be^{-x/t}, where time constant I=1.4±0.1 s, A=(2.31±0.02)×10⁸, B=(3.74±0.08)×10⁸. g, Histogram of time constants in 25 fields of view of uncaged monomer A immobilized in a PMMA matrix photobleaching (as shown in f), with an average of 2.3±0.2 s. h, Total intensity per frame (0.1 s exposure time) vs. imaging time in a representative imaging cycle after uncaging at 10 nM of monomer B under 12.9 mW of 532 nm illumination over an area of 0.015 mm². Line: fit with I=A+Be^{-x/t}, where time constant I=5.8 +0.7 s, A=(1.92±0.02)×10⁸, B=(2.8±0.1)×10⁷. i, Histogram of time constants in 129 cycles of monomer B photobleaching (as shown in h), with an average of 4 +1 s. j-k, Photobleaching lifetime of dye-labeled catalyst. j, Total intensity per frame (0.1 s exposure time) vs. time in a representative imaging experiment of dye-labeled catalysts loaded on marker particles deposited onto the flow cell under 33.0 mW of 488 nm illumination over an area of 0.015 mm². Line: fit with I=A+Be^{-x/t}, where time constant I=1.3±0.1 s, A=(2.32±0.03)×10⁸, B=(1.32 +0.01)×10⁹. k, Histogram of the single-molecule photobleaching lifetime of 174 dye-labeled catalysts; time constant of an exponential fit (solid line) gives a photobleaching time constant of 1.1±0.2 s. 1, Histogram of single-molecule intensity of Compound 14 (the catalyst labeling reagent imaged at 0.1 s/frame under 33.0 mW of 488 nm illumination over an area of 0.015 mm², with an average of (1.7+0.6)×10⁴ EMCCD counts (sample size: 4594). Error are s.d. in the caption of this figure.

FIGS. 8a-j show additional results on imaging homopolymerization of monomer A. a-c, SEM images corresponding to particles shown in FIGS. 2a/e, 2i, and 2j, respectively. d, Histogram of r from 174 catalysts at [A]=0.1 μM. Solid line: exponential fit with a time constant of 0.48±0.02 h, the inverse of which gives the rate (=TOF in this case). e, Histogram of TOF from 174 catalysts at 2 nM of monomer A, with average ± s.d. of 0.14±0.11 h⁻¹ per catalyst. Solid line: Gaussian fit. f, Histogram of polymerization degree from single polymers grown on 174 catalysts, with average ±s.d. of 35±22. Solid line: lognormal fit. g, Histogram of detected turnovers in 2 h on 109 particles without catalysts, giving an average apparent TOF of 0.009 h⁻¹ particle 1. The detection frequency on particles without catalysts is trivial compared with the TOF on single catalysts. h, Histogram of detection frequencies of fluorescence bursts in 50 regions—randomly chosen in the open areas scattering image outside marker particles, with an average of 0.010±0.005 h⁻¹ per unit area of 100×100 nm2, an area comparable to the cluster size of events detected around a catalyst, where 100 nm is about the twice of the 1-dimensional FWHM of detected events around a catalyst. The analyzed regions were 1˜3 μm² in area, but the detection frequencies reported here is scaled down proportionally to the 100 nm × 100 nm unit area. This analysis shows that the detection frequency off marker particles is much lower than that on marker particles. i, Histogram of the fluorescence on time τₒₙ of 474 fluorescence bursts within marker particles. Line: exponential fit with a time constant of 2.2±0.1 s, consistent with the photobleaching lifetime of monomer A under similar conditions. j, Histogram of the fluorescence on-time of 498 fluorescence bursts outside marker particles. Line: exponential fit gives a time constant of 0.7±0.2 s. The straight average and s.e.m are 0.98 and 0.06 s, respectively. The on-time of fluorescence bursts outside marker particles is shorter than the on-particle ones, because the former has contributions from desorption of uncaged monomers or fluorescent impurities that temporarily adsorb on the quartz slide. All unspecified errors in the caption are s.d.

FIGS. 9a-g show surface effects on polymerization kinetics of monomer A. a-c, Method to evaluate the effects of PD on TOF. a, Green dots: scatter plot of microscopic monomer insertion time r vs. PD from 1727 reactions on 174 catalysts at 0.1 μM of monomer A (green dots); different polymers start at different PD at the beginning of imaging under this concentration. Vertical grey lines: equally spaced edges that separate the data into different bins. Black squares: averages in each bin, whose inverse gives the TOF at the corresponding PD. p: Pearson correlation coefficient. b, Single-catalyst TOF vs. the polymerization degrees for monomer A. Lines: global fits with y=ax/(x+L_{1/2})+c with shared L_{1/2} (=270±50 monomers), which is the polymerization degree where the TOF is half-way toward saturation. Reproduced from FIG. 3e. c, Limiting rate on a surface a and limiting rate away from a surface a+c (from fittings parameters in b) vs. monomer concentration [A]- Errors are s.d. d-f, Alternative method to evaluate effects of PD on TOF. d, 3-dimentional scatter plot of TOF vs. monomer concentration [A] and polymerization degree (PD) from 174 catalysts using an alternative method. The data were from a titration experiment that was carried out in the order of increasing monomer concentrations over the same set of catalysts. For each catalyst, the TOF at each monomer concentration was plotted vs. the final PD in the corresponding concentration as one data point. e-g, Scatter plots of TOF vs. [A] in different ranges PD: PD<10 (e), 10≤PD<20 (f), and PD ≥20 (g) by sorting the data points in d. Solid squares in e-g are averages. Solid lines in e-g: linear fit. The data in e-g demonstrate at similar polymerization degree, TOF still follows first-order kinetics with regard to the monomer concentration.

FIGS. 10a-d show additional results on the fluorescence on time distribution, surface effects and temporal dynamics of homopolymerization of monomer B. a, Histogram of the fluorescence on time Ton of 316 fluorescence bursts within marker particles. Line: exponential fit with a time constant of 3.3 +0.1 s. b, Single-catalyst TOF vs. the polymerization degrees for monomer B. Lines: global fits with y=ax / (x+L_{1/2})+c with sharedL_{1/2} (=210 +40 monomers), which is the polymerization degree where the TOF is half-way toward saturation. c, Limiting rate on a surface a and limiting rate away from surface a+c (from b) vs. monomer concentration [B]. d, Dark yellow: Averaged autocorrelation functions for 5 polymers that had ≥10 turnovers at [B]=0.1 μM. Dark yellow line: exponential fit, with the amplitude of 0.20±0.02 and time constant of 2±1. Orange: Averaged autocorrelation functions for 46 polymers that had >10 turnovers at [B]=0.03 μM. Orange line: exponential fit, with the amplitude of 0.02±0.01 and time constant of (0.2±3.7)×103. Errors are s.d.

FIGS. 11a-g show additional examples of the spatial distributions of both monomers and the catalysts on marker particles in copolymerization. a-c, Localizations of individual polymerized monomer A (green dots) and B (yellow dots) around a single labeled G2 catalyst (blue star) at A:B=1:1. Purple line: expanded contour of the magnetic marker particle from its SEM image. d-f, SEM images of the marker particles shown in a-c, respectively. The images shown here had higher resolution than the one used for edge detection. g, SEM images of the marker particle shown in FIG. 4a.

FIG. 12 shows a general design of monomers for CREATS imaging and sequencing of synthetic polymers.

FIGS. 13 shows a general design of monomers for CREATS imaging and sequencing of synthetic polymers.

FIGS. 14a-d show examples of reaction products and polymerizations.

### DETAILED DESCRIPTION OF THE DISCLOSURE

Although claimed subject matter will be described in terms of certain examples, other examples, including examples that do not provide all the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/-0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent radicals and multivalent radicals, such as, for example, divalent radicals, trivalent radicals, and the like).

Illustrative examples of groups include:

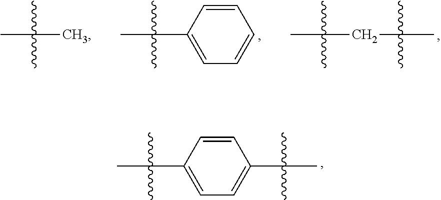

and the like.

The present disclosure provides methods of imaging reaction products. The present disclosure also provides systems for imaging reaction products.

In an aspect, the present disclosure provides methods of imaging reaction products. A reaction product may be referred to as a molecule or the like. In various examples, a method comprises production of a fluorescent reaction product or fluorescent reaction products, obtaining one or more fluorescence image(s) of at least a portion of (e.g., one or more) of the fluorescent reaction product(s), and optionally, photobleaching (independent of the obtaining fluorescence image(s)) the fluorescent reaction product(s). In various examples, a reaction product is a polymerization product (such as, for example, a fluorescent polymerization product) or the like. In various examples, a reaction product is a compound product (such as, for example, a compound product formed by reaction of two or more reactants (e.g., a coupling reaction, such as, for example, a Suzuki coupling reaction, Heck reaction, or any other reaction that can link two organic groups together through covalent bonds, or the like) or the like. Non-limiting examples of methods of imaging reaction products are disclosed herein.

In various examples, a method of imaging a reaction product or products comprises: providing a reaction mixture comprising one or more reactant(s), one or more photo-uncaging reaction(s); one or more fluorogenic reaction(s) (e.g., where at least a portion of or all one or more or all the reactant(s) each comprise one or more fluorophore group(s) (e.g., where each fluorophore of a fluorophore group exhibits a distinct fluorescence emission) and, optionally, at least a portion of or the remainder of the reactants(s) do not comprise fluorophore group(s)) (e.g., where the reactant(s) comprising fluorophore group(s) are at very low concentration (such as, for example, less than about 10⁻⁹ M) relative to reactant(s) that do not comprise fluorophore group(s)) (e.g., where the reaction is a solution or liquid reaction, solid-supported reaction, or the like) (e.g., where the reaction is a catalyzed reaction); obtaining one or more fluorescence image(s) (which may be at different wavelength(s)) (e.g., where at least a portion or all the fluorescence image(s) are single-molecule localization microscopy image(s) or the like); optionally, photobleaching (independent of the obtaining fluorescence image(s)) the fluorogenic reaction product(s); and optionally, repeating the photo-uncaging reaction(s), the fluorogenic polymerization, the obtaining one or more fluorescence image(s) or photobleaching (independent of the obtaining fluorescence image(s)) the fluorogenic reaction product(s), if carried out, a desired number of times. In various examples, a change or changes in fluorescence is/are indicative of one or more feature(s) of the fluorogenic reaction and/or reaction product(s) (such as, for example, reaction/product characteristic(s), reaction/product propert(ies), reaction/product structural feature(s) (e.g., individual reaction product structure, or the like) or the like).

In various examples, a method of imaging a reaction product or reaction products is a method of imaging a fluorescent polymerization product or the like. In various examples, a method comprises CREATS (coupled reaction approach toward super-resolution-imaging) or the like. Non-limiting examples of methods of imaging polymerization product(s) disclosed herein.

In various examples, a method comprises single molecule fluorescence imaging or the like. In various examples, a method comprises single molecule fluorescence imaging of a polymerization reaction product or the like.

In various examples, a method of imaging a polymerization product or products comprises a photo-uncaging reaction; a fluorogenic polymerization reaction; and obtaining one or more fluorescence image(s) (such as, for example, obtaining one or more fluorescence image(s) of a reaction product (e.g., a fluorescent polymerization product or products or the like)). In various examples, a change or changes in fluorescence is/are indicative of one or more feature(s) of a polymerization reaction product.

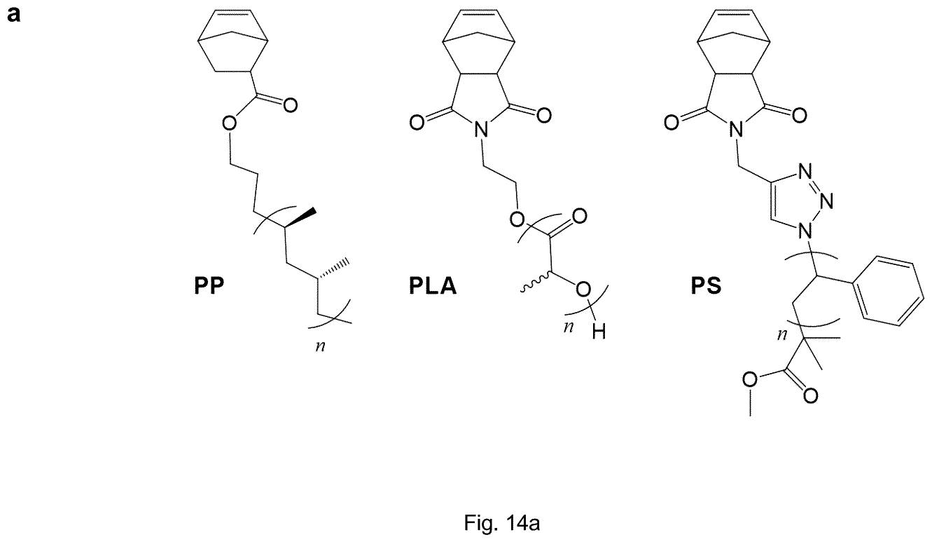

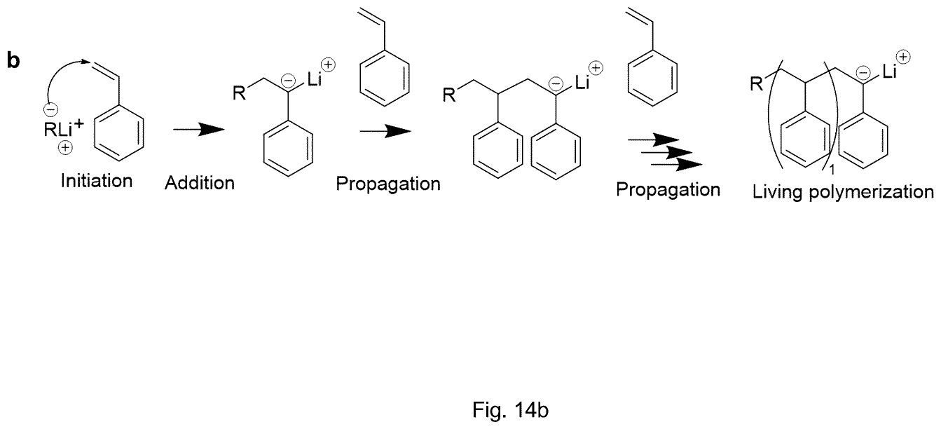

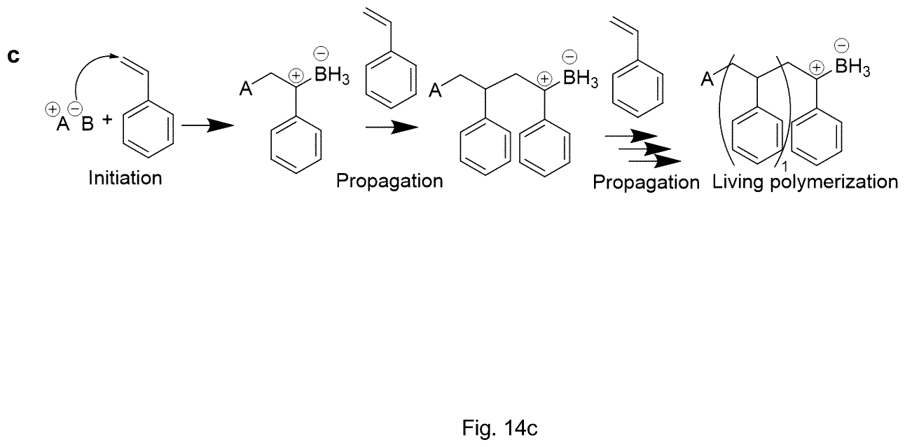

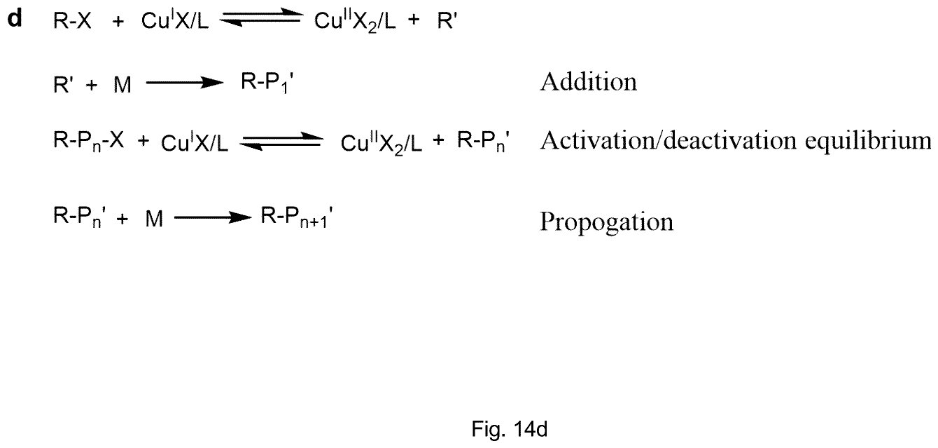

A method can image various reaction products. In various examples, a reaction product is a compound, a polymer, or the like. In various examples, a method images a product of a reaction of a monomer (such as, for example, a fluorogenic monomer or the like) with another monomer (which may be the same or different than the monomer), a polymer chain (which may or may not be fluorescent), or the like). In various examples, a method images a product or products of a reaction of a monomer (such as, for example, a fluorogenic monomer or the like) with a catalyst or the like. In various examples, a method images a reaction product or products of a chain growth polymerization (such as, for example, a chain growth polycondensation or the like) or the like. In various example, a method images a reaction product or products of a living polymerization reaction (such as, for example, an anionic living polymerization, a cationic olefin polymerization, or the like) or the like. In various examples, a method images a product or products of a ring-opening polymerization or the like. In various examples, a method images a reaction product or products of an atom transfer radical polymerization (ATRP) or the like. In various examples, a polymer chain is a homopolymer chain or a copolymer chain (such as, for example, a random copolymer chain, an alternating copolymer chain, a block copolymer chain (e.g., a polymer chain comprising one or more blocks or the like), a tapered copolymer chain, or the like). In various examples, these reaction products are polymer products. In various examples, a method images a reaction product or products of a peptide synthesis or the like. In various examples, a reaction product or products is/are nucleic acid product(s) (such as, for example, RNA, DNA, or the like). Non-limiting examples of polymerization products (which may be fluorogenic polymerization products are shown in FIG. 14.

Various substrates 1200 can be used. In various examples, a plurality of polymer groups and/or a plurality of catalysts is disposed on a substrate. In various examples, a polymerization product or polymerization products is/are disposed on a substrate. In various examples, a polymerization product or polymerization products is/are disposed on a substrate. In various examples, a polymerization product or polymerization products is/are covalently or non-covalently bonded to a substrate. In various examples, a substrate comprises one or more conducive material(s), one or more nonconductive material(s), one or more transparent material(s), one or more nontransparent materials, or the like, or any combination thereof. In various examples, a substrate comprises a solid surface (such as, for example, a planar surface or a non-planar surface). Non-limiting examples of substrates include particles, planar substrates, non-planar substrates, or the like, which may be conducive, nonconductive, transparent, nontransparent, or the like, or any combination thereof, and the like, and combinations thereof. Non-limiting examples of particles include beads, metal particles (such as, for example, gold particles and the like), silica coated metal particles, or the like, or any combination thereof. In various examples, a metal particle is a magnetic particle or the like. In various examples, a metal particle is a nanoparticle or the like. In various examples, a particle comprises one or more linear dimension(s) (such as, for example, a longest linear dimension (e.g., a diameter or the like) of about 10 nm (nm=nanometer(s)) to about 10,000 nm (or greater), including all integer nm values and ranges therebetween, or the like).

In various examples, a substrate further comprises one or more image marker(s). In various examples, a substrate further comprises one or more image marker(s) disposed on at least a portion of a surface of a substrate. In various examples, an image marker is a fluorescent material or the like. Non-limiting examples of fluorescent materials are known in the art. Non-limiting examples of image markers include nanodiamonds, metal particles (such as, for example, gold particles and the like), fluorescent beads, and the like, and any combination thereof. In various examples an image marker is a nanoparticle.

Various catalysts can be used. In various examples, a catalyst or a plurality of catalysts is/are disposed on a substrate. Combinations of catalysts can be used. In various examples, two or more different catalysts are disposed on a substrate. In various examples, a catalyst is any catalyst typically used in a reaction (such as, for example, a polymerization reaction or the like) described herein. In various examples, a catalyst is an initiator or the like.

Suitable catalysts are known in the art. Non-limiting examples of catalysts include chain growth polymerization catalysts (such as, for example, chain growth polycondensation catalysts or the like) and the like. In various examples, a catalyst is a living polymerization catalyst (such as, for example, an anionic living polymerization catalyst, a cationic olefin polymerization catalyst, or the like) or the like. In various examples, a catalyst is ring-opening polymerization catalyst or the like. In various examples, a catalyst is an atom transfer radical polymerization (ATRP) or the like. In various examples, a catalyst is a peptide synthesis catalyst or the like. In various examples, a catalyst is a nucleotide synthesis catalyst or the like.

A photo-uncaging reaction comprises cleaving a caging group from a monomer. In various examples, a photo-uncaging reaction comprises cleaving a caging group from a monomer by irradiation of the monomer comprising a caging group with electromagnetic radiation or the like (such as, for example, irradiation of the monomer with coherent electromagnetic radiation provided by a laser (e.g., a first laser of a system of the present disclosure)) or the like. In various examples, a photo-uncaging reaction comprises irradiating a mixture comprising a plurality of caged monomers, each caged monomer comprising a reactive group, a fluorophore group, and a photocleavable caging group.

In various examples, a monomer comprises a linking group that links (e.g., covalently links or the like) a caging group to a fluorophore group. In various examples, a linking group is a photocleavable group, a chemically cleavable group, or the like. Various linking groups (and methods forming linking groups, which may be conjugation methods or the like) are known in the art. Non-limiting examples of linking groups include nitrobenzyl groups, coumarin conjugates (or groups), RuBEP photolinkers (or groups), a-thioacetophenone-type linkers (or groups), 3-acetyl-9-ethyl-6-methylcarbazole (AEMC) linkers (e.g., comprising substitutions at both the phenacyl and benzylic positions with carboxylic acids (which may be the same or different) or the like, structural analogs thereof, and the like, and groups formed therefrom. In various examples, a monomer comprises a photocleavable linking group and a

photo-uncaging reaction comprises reaction (such as, for example, photoreaction or the like) of the photocleavable group after irradiation of the monomer with electromagnetic radiation or the like, which results in cleavage of at least a portion of, substantially all, or all the caging group(s) and production of a fluorescent monomer. In various examples, the monomer is irradiated with coherent electromagnetic radiation provided by a laser (e.g., a first laser of a system of the present disclosure)) or the like.

In various examples, two or more monomers, each monomer comprising a fluorophore group exhibiting a different fluorescence emission wavelength, are uncaged substantially simultaneously or simultaneously. In various examples, after uncaging the two or more monomers, one or more multicolor image(s) is/are obtained.

A method can comprise various fluorogenic reactions. In various examples, a fluorogenic reaction is that produces a fluorescent reaction product. In various examples, a fluorogenic reaction produces a fluorescent compound or the like. In various examples, a fluorogenic reaction is a fluorogenic polymerization or the like. In various examples, a fluorogenic polymerization is a polymerization reaction that produces a fluorescent polymer product. A fluorescent compound or polymer product emits electromagnetic radiation (fluorescence emission radiation) comprising one or more or a plurality of wavelength(s) resulting from irradiation of the fluorescent compound or polymer product with electromagnetic radiation (absorption radiation). In various examples, emission radiation comprises one or more or a plurality of wavelength(s) different from the emission radiation.

A method can comprise various fluorogenic polymerizations. In various examples, a fluorogenic polymerization is a polymerization reaction that produces a fluorescent polymer product . A fluorescent polymer product emits electromagnetic radiation (fluorescence emission radiation) comprising one or more or a plurality of wavelength(s) resulting from irradiation of the fluorescent polymer product with electromagnetic radiation (absorption radiation). In various examples, emission radiation comprises one or more or a plurality of wavelength(s) different from the emission radiation.

In various examples, a fluorogenic polymerization is a solution polymerization, a liquid polymerization or the like. In various examples, a fluorogenic polymerization is solid-supported fluorogenic polymerization, or the like. In various examples, a fluorogenic polymerization is a catalyzed polymerization or the like.

A fluorogenic polymerization can comprise various monomers. Combinations of monomers can be used. In various examples, at least a portion of the monomers comprise fluorophore group(s) or the like. In various examples, at least a portion of the monomers comprise fluorophore group(s) or the like and/or at least a portion of the monomers do not comprise fluorophore group(s) or the like. In various examples, all the monomers comprise fluorophore group(s) or the like.

In various examples, a fluorogenic polymerization comprises two or more different monomers. In various examples, the different monomers are different in terms of fluorophore(s), fluorescent emission (such as, for example, florescence emission wavelength or the like), one or more structural feature(s), or the like, or any combination thereof.

Various compounds that can be polymerized can be monomers. In various examples, a monomer is a monomer typically used in a polymerization reaction, such as, for example, an olefin polymerization, an additional polymerization, or the like. In various examples, a monomer is a monomer typically used in a living polymerization reaction such as, for example, an anionic living polymerization, a cationic living polymerization, or the like.

In various examples, where at least a portion of or the remainder of the monomer(s) do not comprise fluorophore group(s), the monomer(s) comprising fluorophore group(s) are at low concentration relative to monomer(s) that do not comprise fluorophore group(s). In various examples, in these cases, the monomer(s) comprising fluorophore group(s) are present at less than about 10⁻⁹ M (e.g., about10⁻⁹ M to about 10⁻¹² M).

In various examples, a monomer comprises a reactive group, one or more fluorophore group(s), and one or more caging group(s) (e.g., where the number of caging groups corresponds to the number of fluorophores) (which may be referred to as a caged monomer). In various examples, a monomer (which may be an un-caged monomer) comprises a reactive group and one or more fluorophore group(s).

A monomer can comprise various reactive groups. In various examples, a reactive group is a group suitable for reaction in a polymerization reaction. In various examples, a reactive group is a carbon-carbon double bond, carbon-halide single bond, or the like, or any combination thereof. In various examples a carbon-carbon double bond is an internal double bond (e.g., a carbon-carbon double bond comprised within a cyclic hydrocarbon or a cyclic hydrocarbon group, such as, for example, a cyclic olefin, a cyclic olefin group, or the like, or the like). In various examples a carbon-carbon double bond is a terminal double bond (e.g., a carbon-carbon double bond comprised within a hydrocarbon or a hydrocarbon group, such as, for example, a linear or branched olefin, a linear or branched olefin group, or the like, or the like).

Non-limiting examples of monomers include cyclic olefins (such as, for example, norbornene, cyclooctene, structural analogs thereof, and the like, and any combination thereof), acyclic olefins (such as, for example, alkyl olefins, styrene, structural analogs thereof, and the like, and any combination thereof), alkyl halides, structural analogs thereof, and the like, macromers thereof, and any combination thereof.

A monomer may further comprise various fluorophore groups (which may be referred to, in the alternative as, as fluorophore tags) or the like. In various examples, a monomer comprises one or more fluorophore group(s) or the like. A fluorophore group comprises one or more fluorophore(s). In various examples, a fluorophore group is covalently bound to the monomer (such as, for example, covalently bound to a monomer, covalently bound to a side-chain that is covalently bound to a monomer, or the like, of a monomer). A covalent bond can be formed by various conjugation groups (which may be groups that form a direct bond between a fluorophore and a monomer). Various direct bonding groups (and methods of forming direct bonding groups, which may be conjugation methods or the like) are known in the art. Non-limiting examples of fluorophores include 4,4-difluoro-4-bora-3a,4a-diaza-s-indacene (BODIPY), fluorescein, rhodamines, cyanines, structural analogs thereof, and the like, and groups formed therefrom, and any combination thereof.

In various examples, a monomer further comprises a linking group (such as for example, a side-chain group or the like). In various examples, a linking group (such as for example, a side-chain group or the like) links (such as, for example, by covalent bonding or the like) one or more fluorophore(s) to a monomer (such as, for example, a monomer group). In various examples, a linking group is cleaved in an uncaging reaction. In various examples, a linking group is a photocleavable group, a chemically cleavable group, or the like. Various linking groups (and methods forming linking bonding groups, which may be conjugation methods or the like) are known in the art. Non-limiting examples of linking groups include nitrobenzyl groups, coumarin conjugates, RuBEP photolinkers, a-thioacetophenone-type linkers, 3-acetyl-9-ethyl-6-methylcarbazole (AEMC) linkers (e.g., comprising substitutions at both the phenacyl and benzylic positions with different carboxylic acids, structural analogs thereof, and the like, and groups formed therefrom.

In various examples, a linking group is a side-chain group (which may be referred to, in the alternative, as a side chain). Non-limiting examples of side-chain groups include alkyl groups (such as, for example, C₁ to C₂₀ alkyl groups, including all integer number of carbons and ranges therebetween) and the like. In various examples, an alkyl group comprises an linear structure, a branched structure, a dendritic structure, or other types of structural architecture, or the like, or any combination thereof.

In various examples, a linking group (such as, for example, a side-chain group or the like) does not substantially interfere, interfere at an observable amount, or interfere at all with the fluorogenic polymerization. Side-chain group interference can be determined by methods known in the art. In various examples, side-chain group interference is determined by nuclear magnetic resonance spectroscopy, mass spectrometry, or other analytical methods that can assay reaction progress, or the like.

A monomer may further comprise various photocaging groups (which can be referred to, in the alternative, as caging groups). In various examples, a photocaging group is a quenching group or the like. A monomer comprising fluorophore group(s) and photocleavable caging group(s) can be referred to as caged monomer). In various examples, a photocleavable caging group is in proximity to a fluorophore group such that the fluorescence of a fluorophore group is substantially or completely quenched. Non-limiting examples of photocaging groups (e.g., quenching groups or the like) are known in the art.

In various examples, a method further comprises, after the fluorogenic reaction, waiting a period of time prior to the obtaining the fluorescence image(s). In various examples, a period of time is sufficient for substantially all or all the unreacted uncaged monomers to diffuse (such as, for example, in a static system or the like) or be removed (such as, for example, in a dynamic system or the like) from proximity to the reacted uncaged monomer(s). In various examples, substantially all or all the unreacted uncaged monomers are removed from proximity (such as, for example, an observation volume (e.g., within about 100 nm to about 200 nm from a substrate surface, a diffraction-limited area (e.g., about 300 nm by about 300 nm), or the like) to the reacted uncaged monomer(s) by a flow (such as, for example, a liquid (e.g., a solvent or the like), which may be in a reactor (e.g., a microfluidic reactor or the like). In various examples, a fluorescent reaction product or fluorescent reaction products (such as, for example, fluorescent polymerization product(s)) is/are spatially separated from the other fluorescent reaction products (such as, for example, other fluorescent polymerization product(s)), if present, such that a desired image or images of the fluorescent product or fluorescent products (such as, for example, fluorescent polymerization product(s)) is/are obtained.

Fluorescence images can be obtained using various means and by various methods. In various examples, obtaining one or more fluorescence image(s) comprises optical microscopy or the like. In various examples, obtaining one or more fluorescence image(s) comprises imaging (in a single image or multiple images (such as, for example, a movie or the like)) a single polymer chain or a portion thereof, a single catalyst, or the like, or any combination thereof. In various examples, obtaining one or more fluorescence image(s) comprises imaging (in a single image or multiple images (such as, for example, a movie or the like)) multiple individual polymer chains, each with a catalyst, or the like, or any combination thereof. In various examples, one or more fluorescence image(s) are obtained with nanometer precision. In various examples, one or more fluorescence image(s) exhibit nanometer localization of one or more reaction product(s) (such as, for example, fluorescent polymerization product(s)). In various examples, obtaining one or more fluorescence image(s) comprises obtaining one or more super-resolution image(s) or the like.

In various examples, one or more individual fluorescence image(s) are obtained. In various examples, 1 to 2,000 images, including all integer number of images and ranges therebetween (e.g., 1 to 10, 1 to 50, 1 to 100, 1 to 500, or 1 to 1,000 images) (e.g., for each cycle). In various examples, a plurality of images is obtained (such as, for example, a movie or the like) (e.g., for each cycle). In various examples, at least a portion of or all the images are single color images (such, as for example, single wavelength images) or the like. In various examples, at least a portion of or all the images are multicolor (such, as for example, multiwavelength images) or the like. In various examples, at least a portion of or all the fluorescence image(s) are single-molecule localization microscopy image(s) or the like.

In various examples, a fluorescence image or a plurality of fluorescence images is obtained over a desired time. In various examples, a fluorescence image or plurality of fluorescence images is obtained over about 1 ms (ms=millisecond(s)) to about 1,000 s (s=second(s)), including all integer millisecond values and ranges therebetween. In various examples, a fluorescence image is obtained over about 1 ms to about 1 s. In various examples, a plurality of fluorescence images is obtained over about 10 ms to about 1,000 s (e.g., about 0.01 s to about 1 s or about 100 ms s to about 1 s). In various examples, the time for a photo-uncaging reaction and imaging is shorter than the time of a fluorogenic polymerization reaction to add a single monomer.

In various examples, a cycle (such as, for example, an individual photo-uncaging reaction and fluorescence imaging) is carried out at in a desired cycle time. In various examples, a cycle is carried out in a cycle time of about 0.01 cycle/minute (cycle/min) to about 100 cycle/min, including all integer cycle/min values and ranges therebetween (e.g., 0.01 cycle/min to about 10 cycle/min). In various examples, a cycle is carried out at in cycle time of about 1 cycle/min or a number of cycles/min as necessary, so that the cycle time is comparable to or faster than the turnover time of a polymerization reaction. In various examples, a photo-uncaging reaction and imaging is carried out at in a desired cycle time.

In various examples, a plurality of fluorescence images is obtained at a desired rate. In various examples, a plurality of fluorescence images is obtained at a rate of about 1 frame/second (frame/sec) to about 1000 frame/sec, including all integer frame/sec values and ranges therebetween. In various examples, a plurality of fluorescence images is obtained at a rate of about 100 frames/sec.

In various examples, obtaining one or more image(s) comprises data analysis. In various examples, data analysis comprises quantitative photo-activated location of reaction product or products comprising a fluorophore group (such as, for example, fluorescent polymerization product(s) or the like). In various examples, a data analysis further comprises fluorescence filtering, drift correction, OM-SEM correlation, space-time filtering, or the like, or any combination thereof. Without intending to be bound by any particular theory, it is considered fluorescence filtering, drift correction, OM-SEM correlation, space-time filtering, or the like, or any combination thereof can increase imaging data reliability.

Quantitative photo-activated location of reaction product or products comprising a fluorophore group (such as, for example, fluorescent polymerization product(s) or the like) can be carried out by analysis of one or more fluorescence image(s). In various examples, quantitative photo-activated location is image-based quantitative photo-activated location. In various examples, quantitative photo-activated location comprises localization of one or more reaction product(s) (such as, for example, fluorescent products(s) (e.g., fluorogenic polymerization product(s) or the like) or the like. In various examples, quantitative photo-activated location comprises localization as a function of time of one or more reaction product(s) (such as, for example, a fluorogenic polymerization product(s) or the like). In various examples, localization as a function of time of one or more reaction product(s) (such as, for example, a fluorogenic polymerization product(s) or the like) is used to determine one or more feature(s) of a reaction product or products and/or one or more features of a reaction or reactions (e.g., reaction(s) of a monomer or monomers with a polymer, a catalyst, or the like, or combination thereof). In various examples, quantitative photo-activated location comprises identifying single reaction product fluorescence image(s) or potential single reaction product fluorescence image(s) or the like. In various examples, quantitative photo-activated location comprises identifying single reaction product fluorescence image(s) or potential single reaction product fluorescence image(s) or the like in a single image. In various examples, quantitative photo-activated location comprises identifying single reaction product fluorescence image(s) or potential single molecule fluorescence image(s) or the like in a plurality of images (such as, for example, in a series of images, a movie or the like). In various examples, each fluorescence image is a single-color image or a multicolor image. In various examples, each of the images of the plurality of images comprises substantially the same or the same field of view.

In various examples, a single reaction product fluorescence image or a potential single molecule fluorescence image is a pixel with an intensity value greater than the mean pixel intensity plus about six standard deviations or the like. In various examples, quantitative photo-activated location further comprises, determining the centroid position of one or more fluorescent reaction product(s) by fitting an area (such as, for example, about 1 to about 3 square microns) comprising a pixel of a single molecule fluorescence image or a potential single reaction product fluorescence image with a two-dimensional Gaussian point spread function (PSF), Bessel function, or the like. In various examples, the fitting provides one or more or all of a standard deviation (σₓ, σ_{y}, which quantifies the PSF width), an integrated intensity of the PSF, or a localization error (Errₓ, Err_{y}) of a centroid position.

Fluorescence filtering comprises rejecting certain potential fluorescent reaction product(s) based on one or more propert(ies) of a Bessel function, or the like of a single reaction product fluorescence image or a potential single reaction product fluorescence image of a potential fluorescent reaction product. In various examples, the propert(ies) is/are not reasonable for a single reaction product event. In various examples, any single reaction product fluorescence image or potential single reaction product fluorescence image of a potential fluorescent reaction product with a PSF σₓ or σ_{y} less than 100 nm is rejected. Without intending to be bound by any particular theory, it is considered that a potential single reaction product fluorescence image with a PSF σₓ or of less than 100 nm is rejected because such an image is representative of “hot” pixels since their PSF are too narrow for a single reaction product event (for example, the ideal, theoretical σₓ, σ_{y} of the diffraction-limited PSF is about a quarter of the fluorescence emission wavelength (e.g., about 150 nm for a BODIPY dye). In various examples, any potential single reaction product fluorescence image with a PSF width greater than 100 nm and less than a filter threshold value (for example, σ_{filter}, usually about 500 nm is selected as a single-molecule events.

Drift correction comprises correcting for stage drift during fluorescence imaging. In various examples, each image comprises one or more (e.g., at least four or more) image marker(s) (which may be referred to in the alternative as position markers).

In various examples, a substrate (such as, for example, a particle or the like) is an image marker. In various examples, the substrate does not further comprise any exogenous image marker. In various examples, one or more image marker(s) (e.g., at least four image or more markers) are localized in each fluorescence image. In various examples, localization of the one or more image marker(s) (e.g., an average of the image marker(s) localization) relative to the corresponding image marker(s) localization in an initial or reference image (which may be the first image in a series of images) (e.g., a drift distance or average drift distance) is used to correct for stage drift during fluorescence imaging.

In various examples, all fluorescence images from an imaging cycle are averaged to generate an averaged frame “AF” and a localization of one or more image marker(s) (e.g., at least four image markers) is determined for each AF and compared with their corresponding localizations in the first AF in an imaging cycle to obtain a drift distance for each image marker. The drift distances from multiple image markers in each cycle are averaged to give an average drift distance for that cycle, and this average drift distance applied to correct the localizations of each potential single reaction product fluorescence image of a potential fluorescent reaction product in each frame in that cycle. As an illustrative example, an imaging cycle comprises 100 frames in 10 s and it is assumed the drift in 10 s is negligible compared with the localization error.

OM-SEM correlation comprises selecting symmetrically shaped objects that are visible in both the optical microscopy (OM) image(s) and an SEM image or images and establishing an OM-SEM correlation. In various examples, a symmetrically shaped object is an image marker or the like. In various examples, an image marker or markers is/are a nanoparticle or nanoparticles (such as, for example, metal nanoparticle(s) (e.g., Au nanoparticle(s), silica-coated magnetic particle(s), and the like, and any combination thereof). In various examples, intensity-weighted centroids of each position marker that is present in both the OM and SEM images is calculated, and these c intensity-weighted centroids used to establish a transformation relation (e.g., translational and/or rotational relation(s)) from the SEM image to the OM image. In various examples, a transformation relation is an overlay error (e.g., an overlay error comprising translational error and/or rotational error). In various examples, OM-SEM correlation further comprises edge detection on the SEM image. In various examples, edge detection is carried out using a MATLAB build-in function (“edge, ‘canny’, [0.2, 0.7]”). In various examples, edge detection generates a contour of an image marker or markers. In various examples, one or more spatial coordinate(s) of an image marker or markers is correlated to (e.g., mapped on or the like) and OM image. In various examples, the correlation determines an image marker boundary or image marker boundaries, which may be used to distinguish between on-particle and off-particle events.

Space-time filtering comprises selecting potential single reaction product fluorescence image of a potential fluorescent reaction product(s) associated with a substrate. In various examples, a potential single reaction product fluorescence image of a potential fluorescent reaction product associated with a substrate is selected based on the presence of a selected shape in the image (for example, an on-particle event or the like). In various examples, a potential single reaction product fluorescence image of a potential fluorescent reaction product associated with a substrate is selected using the “inpolygon” function of MATLAB or the like. In various examples, space-time filtering further comprises identifying single reaction product fluorescence image of a fluorescent reaction product(s). In various examples, a single reaction product fluorescence image of a fluorescent reaction product is identified based on the timing and location of a potential single reaction product fluorescence image of a potential fluorescent reaction product associated with a substrate.

In various examples, obtaining one or more image(s) comprises data analysis of one or more image(s) that provides one or more feature(s) of a reaction product. In various examples, data analysis is used to determine reaction product features such as, for example, reaction kinetics (e.g., chain-length kinetics or the like), reaction dynamics (e.g., temporal dynamics or the like), catalysis cooperativity between spatially distinct sites, molecular adsorption onto a surface, determination of the sequence of a reaction product comprising a polymer, or the like, or any combination thereof of a reaction or a plurality of reactions.

In various examples, a method comprises photobleaching. In various examples, obtaining one or more image(s) results in substantially or completely photobleaching at least a portion of or all a product or products comprising a fluorophore group (such as, for example, a fluorescent polymerization product or the like). In various examples, photobleaching is carried out independently from obtaining one or more image(s). In various examples, photobleaching (e.g., obtaining one or more image(s) or independent photobleaching) is carried out using one or more laser(s) (such as, for example, irradiation of the reaction product(s) with coherent electromagnetic radiation provided by a laser or lasers (e.g., a second laser and/or a third layer of a system of the present disclosure)) and the laser emission(s) results in substantially or completely photobleaching at least a portion of or all a reaction product or products comprising a fluorophore group. In various examples, substantially or completely photobleaching comprises photochemical alteration of a fluorophore such that it is substantially unable or unable (e.g., permanently unable) to fluoresce.

A photo-uncaging reaction, a fluorogenic polymerization, obtaining one or more fluorescence image(s), and photobleaching, if carried out independently of the obtaining one or more fluorescence image(s) (which may be referred to as a cycle) may be repeated. In various examples, a photo-uncaging reaction(s), a fluorogenic polymerization, obtaining one or more fluorescence image(s), and photobleaching, if carried out independently of the obtaining one or more fluorescence image(s) are repeated (such as, for example, independently repeated, repeated in any order, or both) a desired number of times (e.g., tens, hundreds, thousands, or more depending on, for example, the desired size of a polymerization reaction product (e.g., a fluorogenic polymerization product or the like) or the like). In various examples, a photo-uncaging reaction(s), a fluorogenic polymerization, obtaining one or more fluorescence image(s), and photobleaching, if carried out independently of the obtaining one or more fluorescence image(s) are repeated (such as, for example, independently repeated, repeated in any order, or both) 1 to 5000 times, including all integer number of repetitions and ranges therebetween (e.g., 1 to 2500, 1 to 1500, 1 to 1000, 1 to 500, 1 to 250, 1 to 100, 1 to 50, 2 to 2500, 2 to 1500, 2 to 1000, 2 to 500, 2 to 250, 2 to 100, 2 to 50, 10 to 2500, 10 to 1500, 10 to 1000, 10 to 500, 10 to 250, 10 to 100, 10 to 50 or the like).

In various example, at least a portion of or all the monomers comprises one or more photocleavable fluorophore groups(s) and after obtaining one or more fluorescence image(s) or obtaining all the fluorescence image(s) in a method, a method further comprises photocleaving substantially all or all the photocleavable fluorophore groups(s). In various examples, the photocleaving is carried by irradiating the product with electromagnetic radiation comprising a wavelength or wavelengths suitable to initiate a photocleaving reaction. In various examples, the photocleaving is carried by irradiating the product with coherent electromagnetic radiation (such as, for example, coherent electromagnetic radiation provided by a laser or lasers or the like).

In various examples, a method further comprises chemically cleaving substantially all or all the chemically cleavable fluorophore group(s). In various examples, a method further comprises contacting one or more reaction product(s) with one or more reagent(s) or the like, where the contacting results in chemically cleaving substantially all or all the chemically cleavable fluorophore group(s).

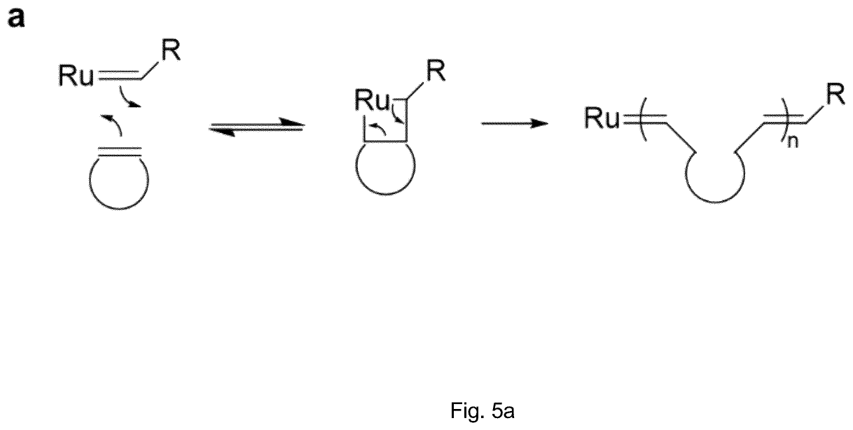

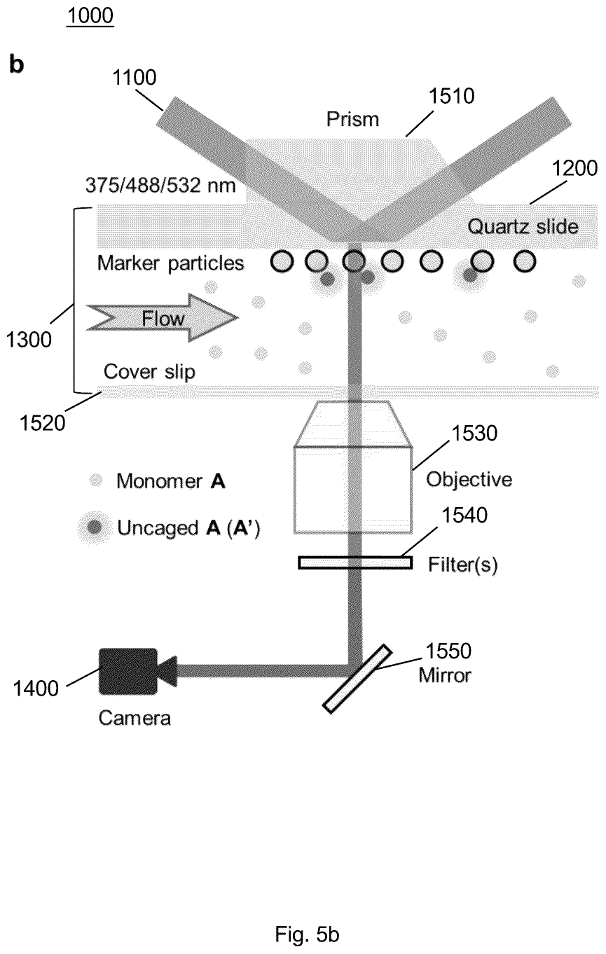

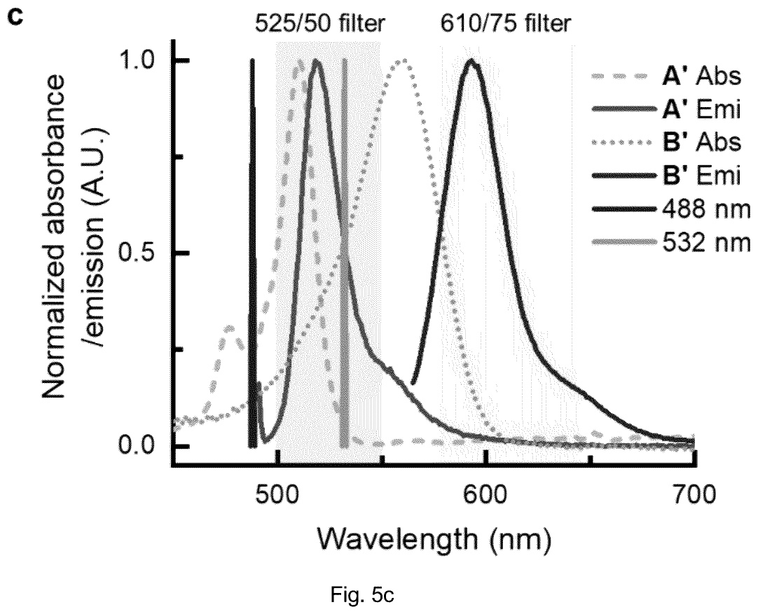

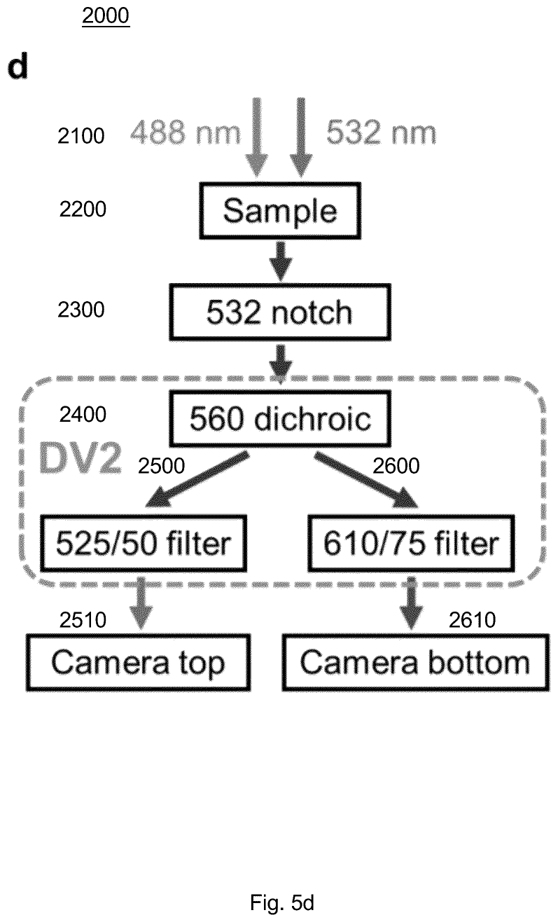

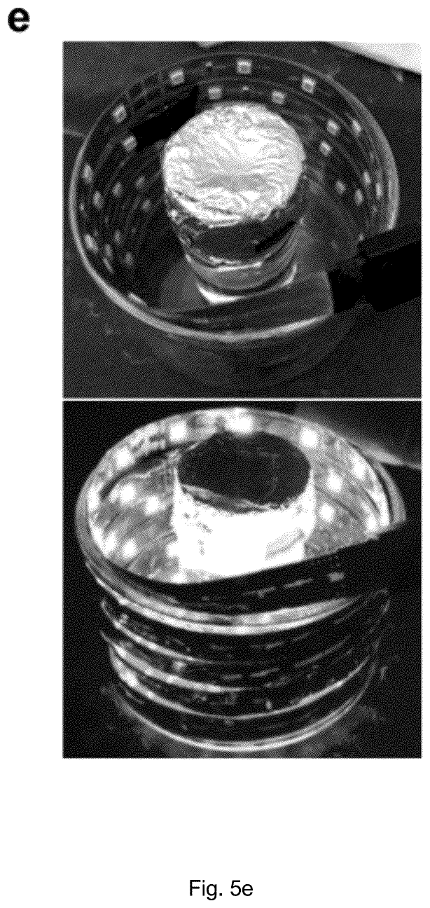

In various examples, a method 2000 for imaging a fluorescent polymerization product is shown in FIG. 5d. Method 2000 at 2100 comprises providing one or more laser input(s) 1100 from one or more laser(s). At 2200, a sample (such as, for example, a reaction product) receives (e.g., is exposed to or the like) the one of more laser input(s) 1100. At 2300, a filter 1540 (e.g., a notch filter or the like) is used to suppress one or more fluorescence emission wavelength(s). At 2400, a mirror 1550 (e.g., a dichroic mirror or the like) is used to reflect one or more fluorescence emission wavelength(s) into a two-channel imaging system. A first channel 2500 passes through a filter 1540 and at 2510 is input into a top of a camera 1400. A second channel 2600 passes through a filter 1540 and at 2610 is input into a bottom of a camera 1400.

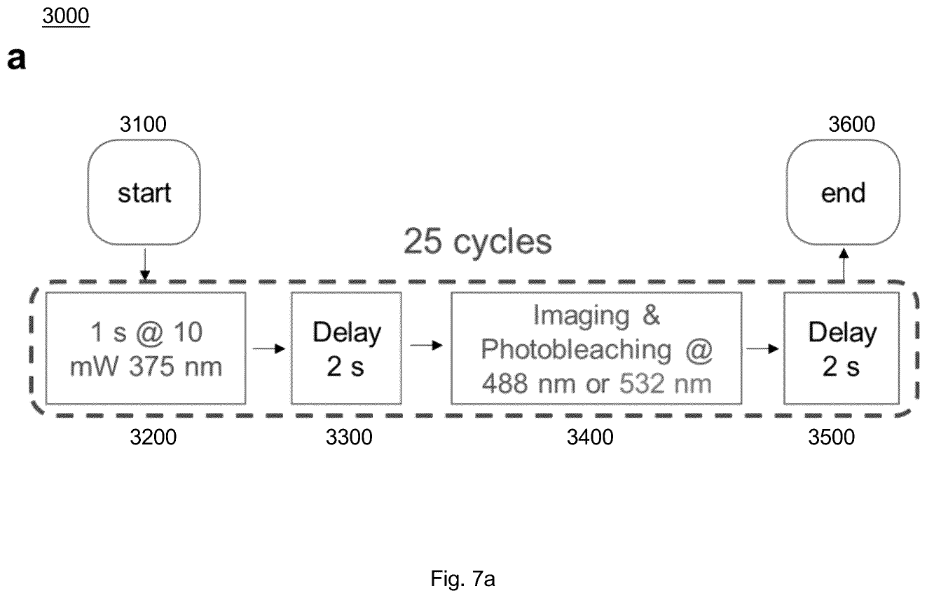

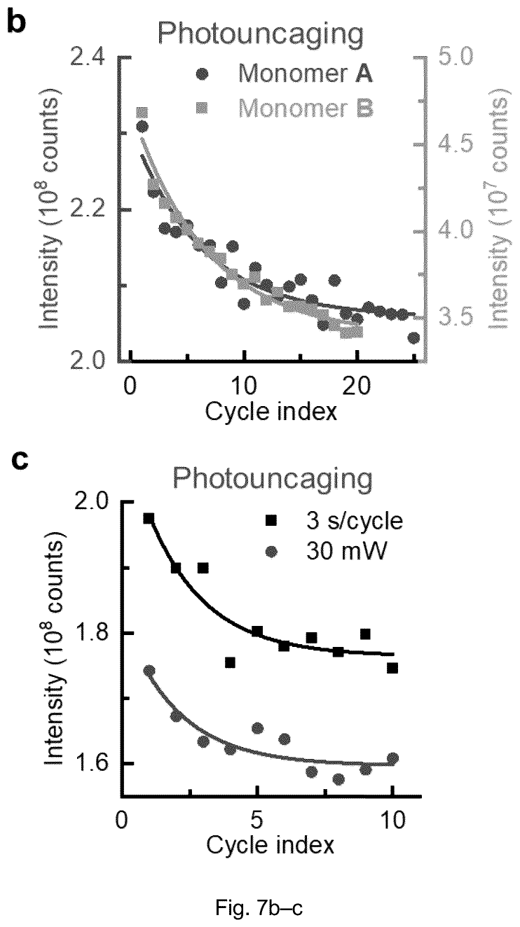

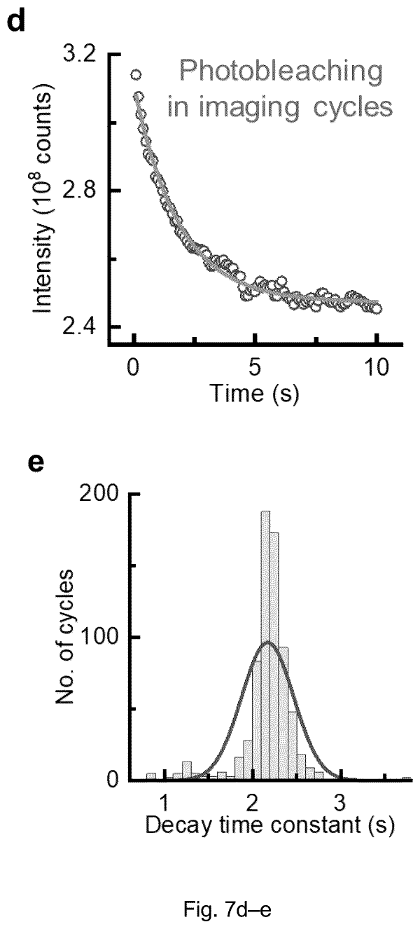

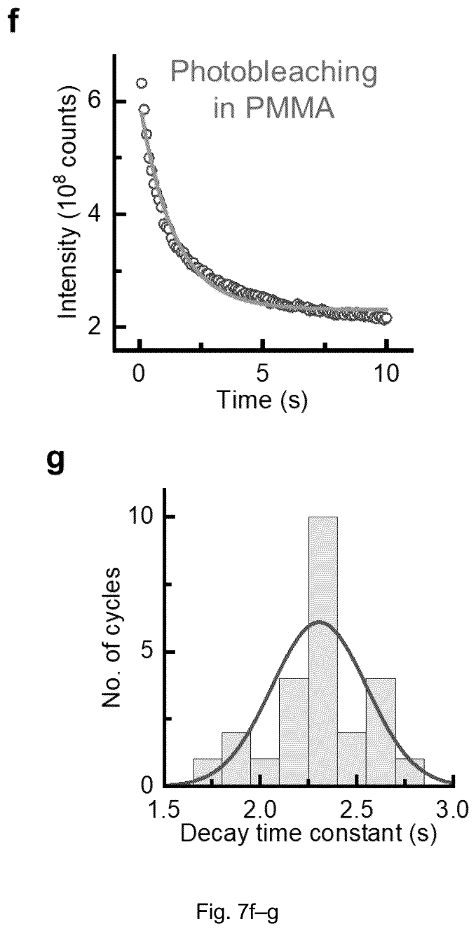

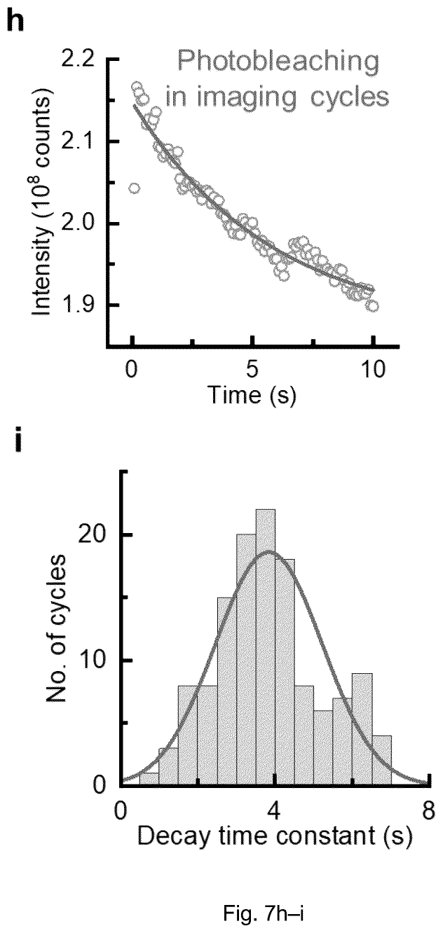

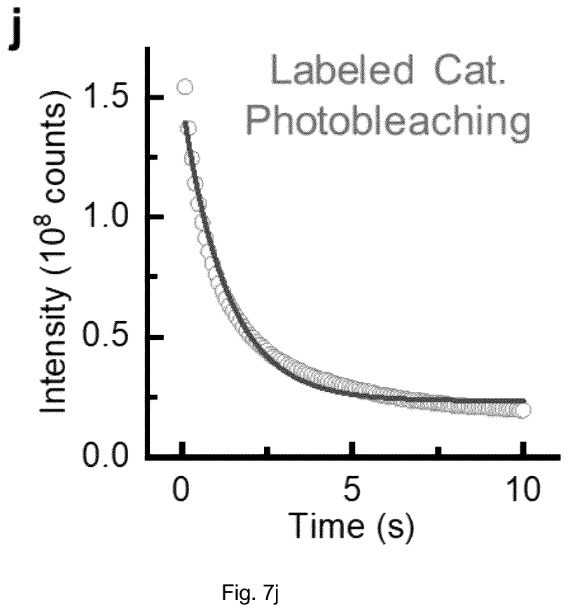

In various examples, a method 3000 for cyclic photo-uncaging reaction and imaging is shown in FIG. 7a. In various examples, an individual photo-uncaging reaction and imaging is carried out at in a desired cycle time. At 3100, the cyclic photo-uncaging reaction and imaging method begins. At 3200, a photo-uncaging reaction occurs. After the photo-uncaging reaction, a time delay at 3300 occurs. Subsequent to the time delay at 3300, imaging and photobleaching occurs at 3400. In various examples, one or more image(s) is/are obtained. After imaging and photobleaching at 3400, a second time delay occurs at 3500. The method 3000 may repeat for a desired number of cycles. After completion of the desired number of cycles, the method 3000 ends at 3600.

A method can be used to determine or are indicative of various features of a reaction (such, as for example, a polymerization reaction or the like). In various examples, a method is used to determine or are indicative of one or more feature(s) (such as, for example, characteristic(s), propert(ies), or the like, or any combination thereof) of a reaction (such as, for example, a polymerization reaction or the like). In various examples, a change or changes in fluorescence are indicative of one or more reactant (such as, for example, monomer) and/or reaction product propert(ies), structural features (such as, for example, the sequence of a polymerization product (e.g., individual polymer chains of the polymer product, monomer-catalysts product, or the like)). In various examples, a method is a polymer sequencing method or the like.

In various examples, a method is used to determine reaction kinetics (such as, for example, chain-length kinetics or the like), reaction dynamics (such as, for example, temporal dynamics or the like), screen catalysts, in catalyst development, catalysis cooperativity between spatially distinct sites, molecular adsorption onto a surface, or the like, or any combination thereof of a reaction or a plurality of reactions.

In an aspect, the present disclosure provides systems for imaging reaction products. In various examples, a system images one or more reaction product(s). Non-limiting examples of systems for imaging reaction products are disclosed herein.

In various examples, a system is used for imaging polymerization product(s) (such as, for example, fluorescent polymerization product(s)). Non-limiting examples of systems for imaging polymerization products are disclosed herein.

In various examples, a system is configured to carry out polymer sequencing and/or imaging (such as, for example, optical imaging or the like) or the like. In various examples, the imaging is optical imaging or the like. In various examples, the optical imaging comprises fluorescence imaging one or more reaction product(s) (such as, for example, single polymer chain(s) or a portion thereof, one or more catalyst-monomer reaction product(s), or the like, or any combination thereof. In various examples, the optical imaging comprises simultaneously imaging a plurality of polymer chains or a portion thereof, a plurality of catalysts, or the like, or any combination thereof. In various examples, a system comprises an optical microscopy system (e.g., a fluorescence microscopy system or the like) or the like.

In various examples, a system for imaging a fluorescent polymerization product or products, comprises a plurality of lasers. In various examples, a system further comprises one or more reactor(s) 1300, each reactor 1300 configured to carry out a reaction (e.g., a fluorogenic polymerization or the like) and/or one or more cameras 1400, each camera 1400 independently configured for imaging a reaction product or products (such as, for example, fluorogenic polymerization product(s) or the like).

In various examples, a system 1000 for imaging a fluorescent polymerization productor products, comprises: a first laser configured to provide coherent electromagnetic radiation comprising a first wavelength, where the first wavelength is suitable to initiate a photo-uncaging reaction; and a second laser configured to provide coherent electromagnetic radiation comprising a second wavelength, where the second wavelength is suitable to obtain one or more fluorescent image(s) of one or more reaction product(s) and the reaction product(s) is/are disposed on a substrate. In various examples, a system further comprises one or more reactor(s) 1300, each reactor 1300 configured to carry out a reaction (e.g., a fluorogenic polymerization or the like) and/or one or more cameras 1400, each camera 1400 independently configured for imaging a reaction product (such as, for example, a fluorogenic polymerization product or the like).

In various examples, a system 1000 for imaging a fluorescent polymerization product or products, comprises: a first laser configured to provide coherent electromagnetic radiation comprising a first wavelength, where the first wavelength is suitable to initiate a photo-uncaging reaction; and a second laser configured to provide coherent electromagnetic radiation comprising a second wavelength, where the second wavelength is suitable to obtain one or more fluorescent image(s) and/or substantially or completely photobleach one or more or all fluorophore(s) of one or more reaction product(s) (e.g., reaction product(s) disposed on a substrate or the like) 1200, a third, a fourth, and a fifth laser configured to provide coherent electromagnetic radiation comprising a third or fourth or fifth wavelength, respectively, where the third, the fourth, and the fifth wavelength are independently suitable to obtain one or more fluorescent image(s) (e.g., where the third, the fourth, and the fifth wavelength are each a different color or comprise one or more different wavelengths of the other imaging lasers) of one or more reaction product(s) (e.g., reaction product(s) disposed on a substrate or the like). In various example, optionally, the third, optionally, the fourth, or optionally, the fifth laser configured to both obtain one or more fluorescent image(s) and/or substantially or completely photobleach one or more or all fluorophore(s) of the reaction product(s) (e.g., reaction product(s) disposed on a substrate or the like). In various examples, a system 1000 further comprises one or more reactor(s) 1300, each reactor 1300 configured to carry out a reaction (e.g., a fluorogenic polymerization or the like) and/or one or more camera(s) 1400, each camera 1400 independently configured for imaging one or more reaction product(s) (such as, for example, a fluorogenic polymerization product or the like).

In various examples, a system 1000 for imaging a fluorescent polymerization product is shown in FIG. 5b. System 1000 comprises one or more laser input(s) 1100 from one or more laser(s) (not depicted), substrate 1200, one or more reactor(s) 1300, one or more camera(s) 1400, and other system 1000 components 1500 such as prism 1510, cover slip 1520, objective 1530, one or more filter(s) 1540, and mirror 1550.

Various lasers can be used. Combinations of different lasers can be used. Non-limiting examples of lasers include lasers configured to provide (e.g., emit or the like) one or more visible wavelengths (such as, for example, one or more wavelengths in the range of about 400 nm to about 700 nm), and the like, any combination thereof. In various examples, each of the lasers is configured to provide coherent electromagnetic radiation comprising a different wavelength or wavelengths than the other lasers. As an illustrative example, a first laser is a 488 nm laser and a second laser is a 532 laser.

In various examples, a system comprises one or more additional lasers(s). In various examples, a system comprises a third laser, and optionally, a fourth laser, and optionally, a fifth laser. In various examples, a third laser comprises (or emits or the like) a third wavelength, and optionally, a fourth laser comprises (or emits or the like) a fourth wavelength, and optionally, a fifth laser comprises (or emits or the like) a fifth wavelength. In various example, a third wavelength is configured to obtain one or more fluorescent image(s) of one or more reaction product(s) (such as, for example, in synchronization and/or sequentially with any one or more or all the other lasers), and optionally, a fourth wavelength is configured to obtain one or more fluorescent image(s) of one or more reaction product(s) (such as, for example, in synchronization and/or sequentially with any one or more or all the other lasers), and optionally, a fifth wavelength is configured to obtain one or more fluorescent image(s) of one or more reaction product(s) (such as, for example, in synchronization and/or sequentially with any one or more or all the other lasers). In various examples, each of the wavelengths (e.g., a first wavelength, a second wavelength, and a third wavelength, or the like) are different.

In various examples, one or more of the laser(s) is/are configured to initiate a photo-uncaging reaction. In various example, one or more of the laser(s) is/are configured to provide a laser power of about 1 mW/cm² (mW/cm²=milliwatt(s)) to about 100 mW/cm², including all 0.1 mW values and ranges therebetween (e.g., about 10 mW and about 5mW to about 50 mW). In various examples, one or more of the laser(s) is/are configured to obtain one or

more fluorescent image(s) and/or photobleach one or more fluorophores of one or more or all (or substantially all or all) of the reaction product(s). In various example, one or more of the laser(s) is/are configured to provide a laser power of about 3 mW/cm² to about 350 mW/cm², including all 0.1 mW values and ranges therebetween (e.g., about 33 mW and about 15 mW to about 175 mW).

In various examples, one or more or all the lasers are arranged in total internal reflectance geometry, epi-illumination geometry, or the like, or any combination thereof. In various examples, a first laser, a second laser, and optionally, a third laser, and optionally, a fourth laser, and optionally, a fifth laser are arranged in total internal reflectance geometry, epi-illumination geometry, or the like, or any combination thereof.

In various examples, a system is configured to obtain a plurality of fluorescence images obtained over a desired time. In various examples, a system is configured to obtain a plurality of fluorescence images over about 1 ms (ms=millisecond(s)) to about 1,000 s (s=second(s)), including all integer millisecond values and ranges therebetween. In various examples, a fluorescence image is obtained over about 1 ms to about 1 s. In various examples, a system is configured to obtain a plurality of fluorescence images over about 10 ms to about 1,000 s (e.g., about 0.01 s to about 1 s or about 100 ms s to about 1 s). In various examples, the time for a photo-uncaging reaction and imaging is shorter than the time of a fluorogenic polymerization reaction to add a single monomer.

In various examples, a system is configured to carry out a photo-uncaging reaction and imaging in a desired cycle time. In various examples, a system is configured to carry out a cycle in a cycle time of about 0.01 cycle/minute (cycle/min) to about 100 cycle/min, including all integer cycle/min values and ranges therebetween (e.g., 0.01 cycle/min to about 10 cycle/min). In various examples, a system is configured to carry out a cycle in cycle time of about 1 cycle/min or a number of cycles/min as necessary, so that the cycle time is comparable to or faster than the turnover time of a polymerization reaction. In various examples, a photo-uncaging reaction and imaging is carried out at in a desired cycle time.

In various examples, a system is configured to obtain a plurality of fluorescence images at a desired rate. In various examples, a system is configured to obtain a plurality of fluorescence images at a rate of about 1 frame/second (frame/sec) to about 1000 frame/sec, including all integer frame/sec values and ranges therebetween. In various examples, a system is configured to obtain a plurality of fluorescence images at a rate of about 100 frames/sec.

Various reactors 1300 can be used. In various examples, a reactor is a microfluidic reactor or the like. In various examples, at least a portion of or all the one or more reactor(s) is/are configured to form a substrate comprising polymer chains or catalyst disposed thereon. In various examples, at least a portion of or all the one or more reactor(s) is/are configured to a react one or more monomer(s) with a polymer chain or chains and/or a catalyst or catalysts or form one or more reaction product(s), which may be disposed on a substrate. In various examples, at least a portion of or all the monomers comprise one or more fluorophore group(s). In various examples, a reactor is configured to provide one or more additional reagent(s) (such as, for example, acids, bases, or the like, or any combination thereof).

In various examples, a reactor (such as, for example, a microfluidic reactor or the like) is configured to flow a liquid (such as, for example, solution or the like) over a substrate (such as, for example, substrate comprising a plurality of polymer chains (which may be the same or two or more different polymer chains), a plurality of catalysts (which may be the same catalysts or two or more different catalysts), or the like disposed on a surface of a substrate. In various examples, the flow results in steady-state monomer reaction kinetics. In various examples, a reactor is configured to remove (e.g., prior to imaging) substantially all or all the unreacted uncaged monomers from proximity (such as, for example, an observation volume (e.g., within about 100 nm to about 200 nm from a substrate 1200 surface, a diffraction-limited area (e.g., about 300 nm by about 300 nm), or the like) to reacted uncaged monomer(s). Various cameras 1400 can be used. Combinations of cameras 1400, which may be

different cameras, can be used. It may be desirable that a camera 1400 have sufficient sensitivity to identify single reaction product fluorescence or the like. Non-liming examples of suitable cameras 1400 are known in the art. Combinations of different lasers can be used. In various examples, a camera 1400 or cameras 1400 is/are an electron multiplying charge coupled device (EM-CCD), a complementary metal oxide semiconductor (CMOS) detector (or camera), or the like, or any combination thereof.

In various examples, one or more laser(s) and one or more camera(s) are configured to initiate a photo-uncaging reaction and obtain after a desired time one or more fluorescent image(s) of one or more reaction product(s). In various examples, one or more laser(s) and one or more camera(s) 1400 are configured to initiate a photo-uncaging reaction and obtain after a period of time one or more fluorescent image(s) of one or more reaction product(s), where the period of time is sufficient for substantially all or all the unreacted uncaged monomers to diffuse (such as, for example, in a static system or the like) or be removed (such as, for example, in a dynamic system or the like) from proximity to the reacted uncaged monomer(s). In various examples, the period of time is such that substantially all or all the unreacted uncaged monomers are removed from proximity (such as, for example, an observation volume (e.g., within about 100 nm to about 200 nm from a substrate 1200 surface, a diffraction-limited area (e.g., about 300 nm by about 300 nm), or the like) to the reacted uncaged monomer(s) by a flow (such as, for example, a liquid (e.g., a solvent or the like), which may be in a reactor (e.g., a microfluidic reactor or the like).

A system may further comprise one or more additional component(s). Non-limiting examples of additional components include one or more electrode(s) independently connected to an external power source or sources. In various examples, the electrode(s) and/or the power source(s) are independently configured to modulate, drive, influence, or the like, or any combination thereof a reaction of a monomer or monomers with a polymer or catalyst. Other non-limiting examples of additional component(s) are chosen from components typically found in optical microscopes (e.g., fluorescence optical microscopes or the like) or the like.

The following Statements describe various examples of methods of polymer sequencing and/or imaging and systems of the present disclosure and are not intended to be in any way limiting:

Statement 1. A method of polymer sequencing and/or imaging comprising one or more step(s) of the methods described herein.

Statement 2. A method of polymer sequencing and/or imaging comprising a photo-uncaging reaction; a fluorogenic polymerization (e.g., where at least a portion of or all the monomer(s) comprise one or more fluorophores (e.g., where each fluorophore has a distinct fluorescence emission) and, optionally, at least a portion of or the remainder of the monomer(s) do not comprise fluorophore(s)) (e.g., where the monomer(s) comprising fluorophore(s) are at very low concentration (such as, for example, less than about 10⁻⁹ M) relative to monomer(s) that do not comprise fluorophore(s)) (e.g., where the polymerization is a solution or liquid polymerization, solid-supported polymerization, or the like) (e.g., where the polymerization is a catalyzed polymerization); obtaining one or more fluorescence image(s) (which may be at different wavelength(s)) (e.g., where the fluorescence image(s) are single-molecule localization microscopy image(s) or the like); and optionally, one or more or all the repeating the photo-uncaging reaction, the fluorogenic polymerization, or the obtaining one or more fluorescence image(s) a desired number of times, where a change or changes in fluorescence are indicative of one or more feature(s) (e.g., reaction/product properties, reaction/product structural features (such as, for example, the sequence of the polymer product (e.g., individual polymer chains of the polymer product)) or the like).

Statement 3. A method according to Statement 1 or 2, where the method is used to determine reaction kinetics, reaction dynamics, screen catalysts, in catalyst development, catalysis cooperativity between spatially distinct sites, molecular adsorption onto a surface, or the like.

Statement 4. A system configured to carry out polymer sequencing and/or imaging (e.g., as described herein, such as, for example, a method of any of Statements 1-3).

Statement 5. A system for optical sequencing of single synthetic polymers, comprising: one or more reactor(s) configured to immobilize a non-fluorogenic monomer to a surface-grafted polymer and to link the non-fluorogenic monomer with a pro-fluorescent sidechain; a first laser, having a first wavelength, configured to photo-uncage the pro-fluorescent sidechain of the immobilized monomers; and a second laser, having a second wavelength, configured to image the immobilized monomers and to bleach the immobilized monomers following the imaging of the immobilized monomers.

Statement 6. The system for optical sequencing of single synthetic polymers according to

Statement 5, where the one or more reactor(s) is/are configured to immobilize a plurality of different non-fluorogenic monomers to one or more surface-grafted polymers. Statement 7. The system for optical sequencing of single synthetic polymers according to Statement 6, where the one or more reactor(s) is/are configured to link at least some of the plurality of different non-fluorogenic monomers with a pro-fluorescent sidechain. Statement 8. The system for optical sequencing of single synthetic polymers according to

Statement 7, where the one or more reactor(s) is/are configured to link at least some of the plurality of different non-fluorogenic monomers with one of a plurality of pro-fluorescent sidechains.

Statement 9. The system for optical sequencing of single synthetic polymers according to Statement 5 to Statement 8, further comprising a third laser, having a third wavelength, configured to image the immobilized monomers in cooperation with the second laser. Statement 10. The system for optical sequencing of single synthetic polymers according to any one of claim 5 to claim 9, where the second laser is activated for a duration sufficient to both image and to photobleach a respective fluorophore of the pro-fluorescent sidechain.

The steps of the methods described in the various embodiments and examples disclosed herein are sufficient carry out the methods of the present disclosure. Thus, in an embodiment, a method consists essentially of a combination of the steps of the methods disclosed herein. In another embodiment, a method consists of such steps.

The following examples are presented to illustrate the present disclosure. They are not intended to be limiting in any manner.

### EXAMPLE 1

The following are examples of methods of polymer sequencing and/or imaging and systems for polymer sequencing and/or imaging.

Optical sequencing of single synthetic polymers. Synthetic polymers made of various monomers have broad applications because of their remarkable and tunable properties, in which the chain sequences play crucial roles. Advanced synthetic approaches have made it possible to make sequence-defined polymers to tune, for example, their reactivity and self-assembly behavior. But in general, the microscopic sequences of synthetic copolymers are unknown, as well as inaccessible to traditional measurements, due to their ubiquitous high heterogeneity in individual chain's length, composition, and sequence. A real-time optical sequencing of single synthetic copolymers (e.g., of greater than 100 monomers) under living polymerization conditions was developed. Multi-color imaging of polymer growth by single catalysts at single-monomer resolution was achieved through CREATS (coupled reaction approach toward super-resolution-imaging). CREATS converts any reaction to be fluorogenic for single-molecule localization microcopy of chemical reactions at high reactant concentrations. It was found that the chain propagation kinetics of surface-grafted polymerization shows temporal dynamics and chain-length dependence, attributable to neighboring monomer interactions and surface electrostatic effects, respectively. Moreover, the microscopic sequences of individual copolymers, first-of-its-kind information to our knowledge, reveal their tendency of forming block polymers instead of random or alternating polymers, and more importantly, quantify the distribution of individual block sizes that are inaccessible from bulk measurements. It is expected this sequencing capability paves the way for structure-function correlation studies of synthetic polymers at the single-chain level and for decoding information in sequence-encoded polymers. CREATS for imaging polymerization. Using single-molecule fluorescence to image

reactions, including polymerizations, has two important requirements: (1) it may be important the target fluorescent species be at ultralow concentrations (<10⁻⁹ molar typically) so that individual fluorescent molecules can be spatially separated beyond diffraction-limited resolution (˜300 nm) and imaged, and (2) the reactant (e.g., monomer) concentration needs to be sufficiently high to have appreciable reaction kinetics. To satisfy these two requirements, a well-known strategy is to use fluorogenic reactions, in which nonfluorescent reactants can be supplied at high concentrations while the fluorescent products are few. Most polymerization reactions are not adaptable to be fluorogenic, however. Previous single-molecule fluorescence studies of polymerizations used dye-labeled monomers at 10⁻¹³-to-10⁻⁹ molar mixed with ˜10⁻³-to-10⁻² molar unlabeled monomers to satisfy the two requirements. But under such conditions, merely 1 out of >10⁶ inserted monomers were detectable, making the complete polymerization inaccessible, and single polymer growth at single-monomer resolution is yet to be achieved via fluorescence imaging.

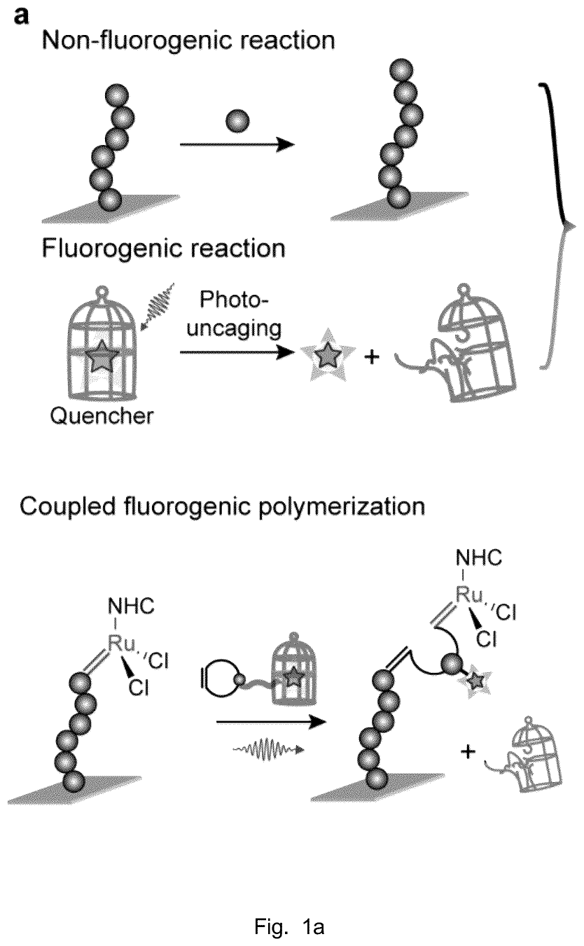

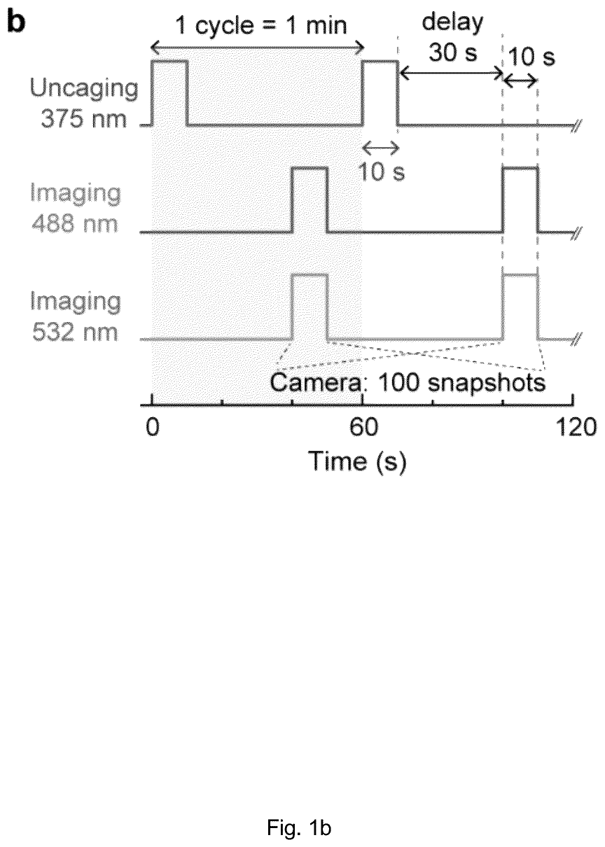

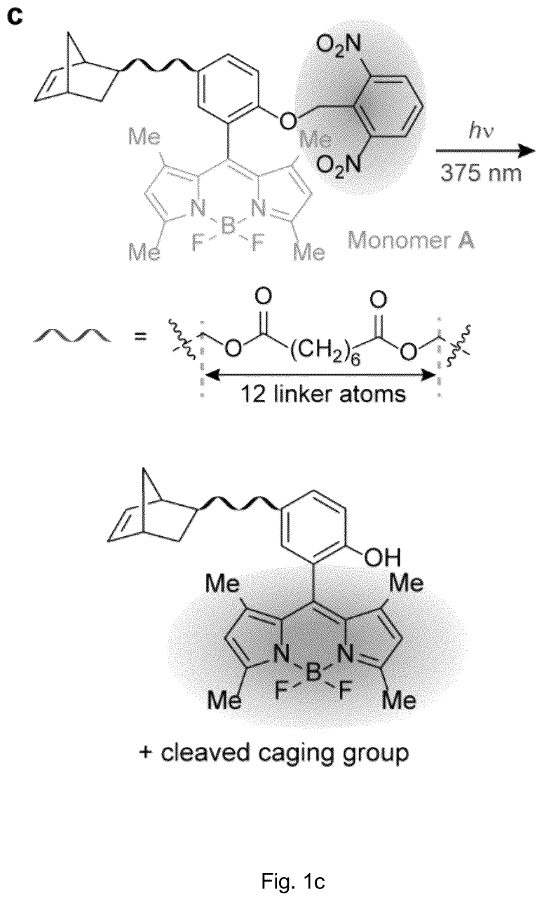

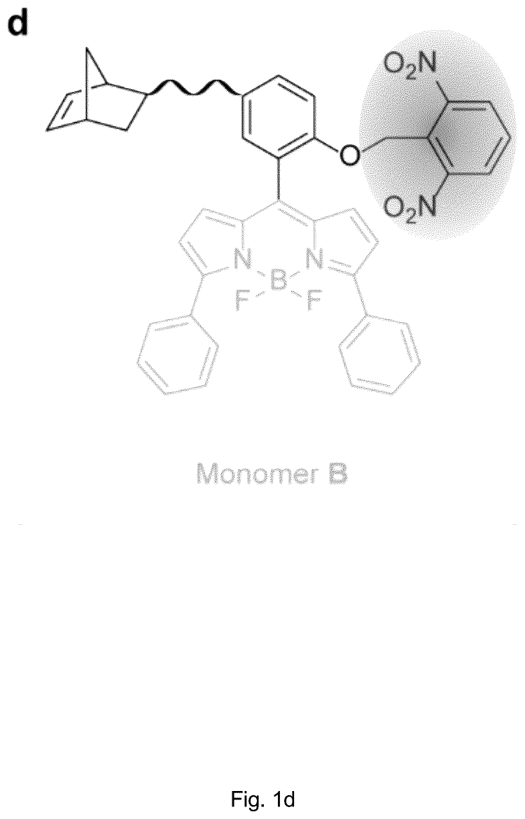

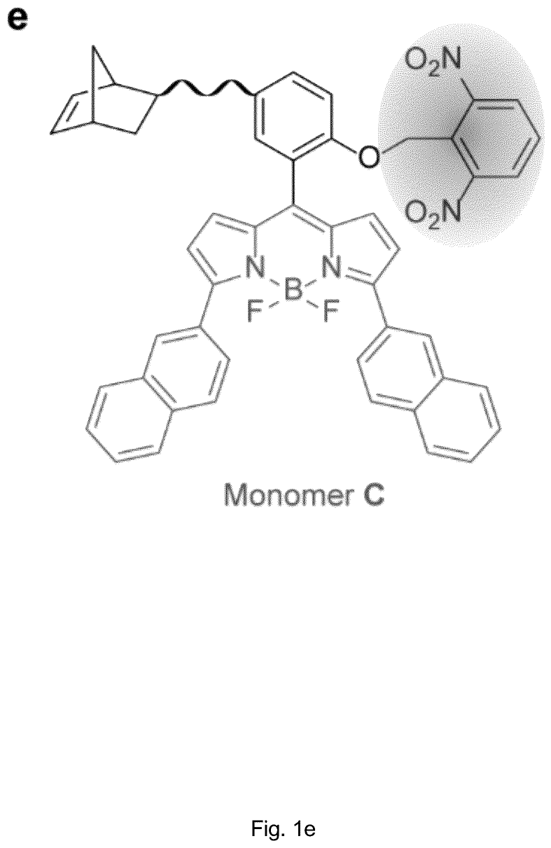

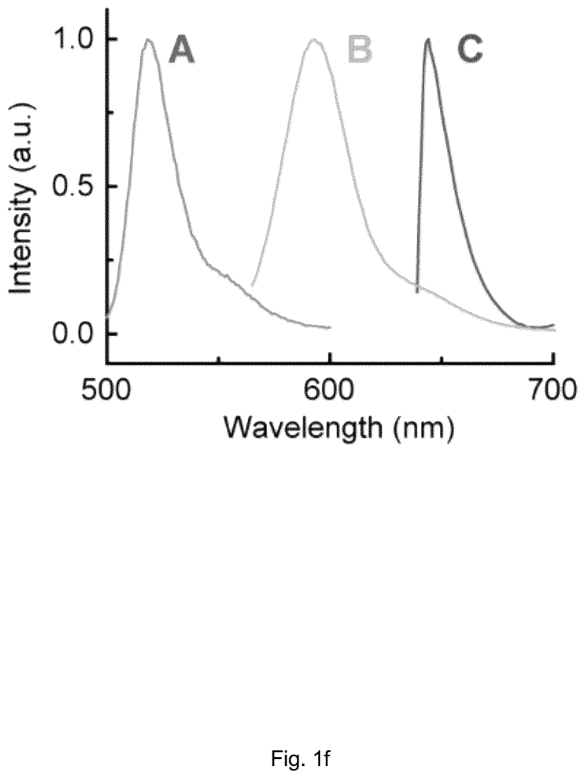

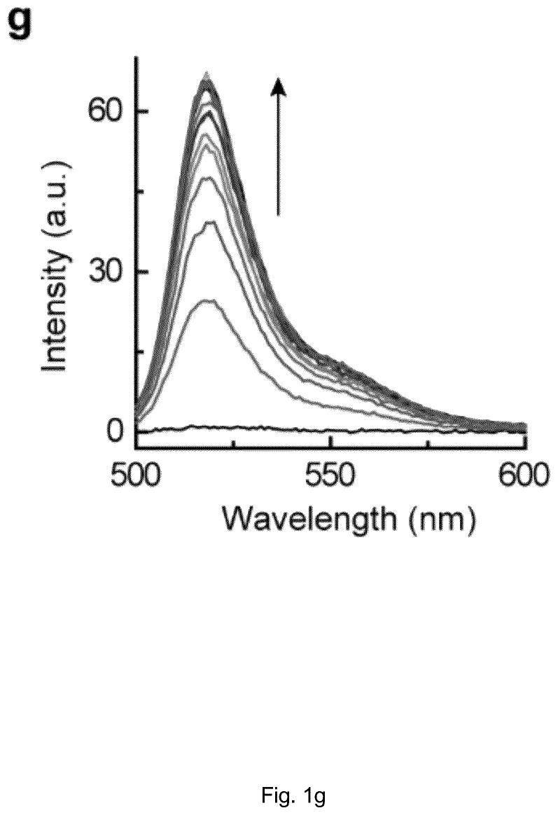

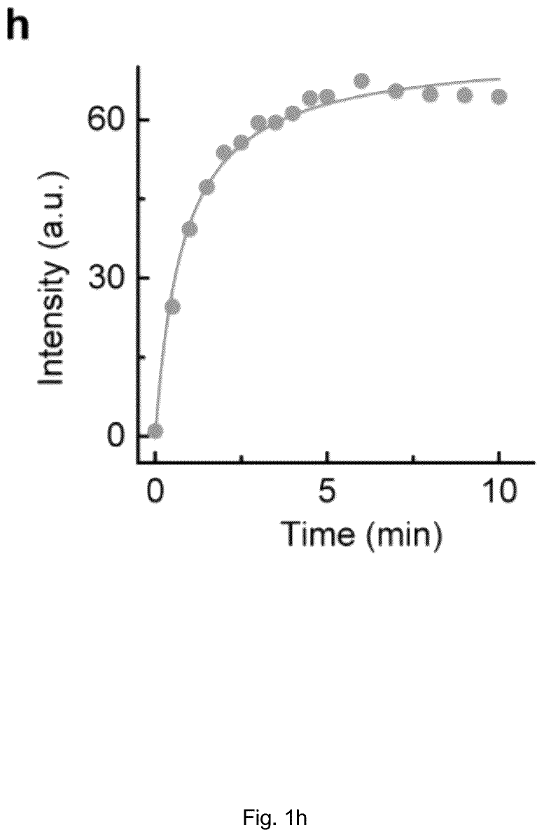

CREATS, a coupled reaction approach toward super-resolution-imaging, was devised as a general strategy to render reaction fluorogenic. FIG. 1a illustrates CREATS using as an example a surface-grafted chain-growth polymerization, which are important for surface modifications in organic electronics and tissue engineering. Monomer polymerization is not fluorogenic (FIG. 1a, upper left). Another separate reaction is fluorogenic (FIG. 1a, lower left). By linking the monomer and the pro-fluorescent reactant, we have a coupled reaction, in which the fluorogenic component reports the polymerization reaction (FIG. 1a, right).

CREATS was implemented to initially study the ring opening metathesis polymerization (ROMP) catalyzed by Grubbs' 2^{nd} generation (G2) catalyst (FIG. 1a, right), a widely used reaction for synthesizing polymers with tunable sizes, shapes, and functions. The fluorogenic reaction is a photo-uncaging reaction (FIG. 1a, lower left). The monomer norbornene is coupled to a pro-fluorescent sidechain, comprising a BODIPY-based fluorophore that is quenched via photo-induced electron transfer by a caging group (i.e., 2,6-dinitrobenzyl), whose photo-cleavage restores the fluorescence (FIGS. 1a and c-e). During polymerization in a microfluidic reactor, monomers are supplied continuously to achieve steady-state kinetics (FIG. 5b). A laser (375 nm) first uncages the monomers that are inserted into surface-grafted polymers (FIG. 1b, top). After a delay to allow uncaged free monomers to diffuse out of the observation volume, promoted by the solution flow, a second laser is used to image the inserted, immobilized monomers and subsequently bleach them, before the uncaging-imaging-bleaching cycle repeats (FIG. 1b, middle/bottom). All lasers are in total-internal-reflection geometry, where the evanescent field allows for small observation volume and better background suppression at higher monomer concentrations. The uncaging-imaging-bleaching cycling rate is performed faster than the polymerization to capture each monomer during real-time polymerization, where each inserted monomer is imaged and localized to nanometer precision (via single-molecule localization microscopy; Methods).

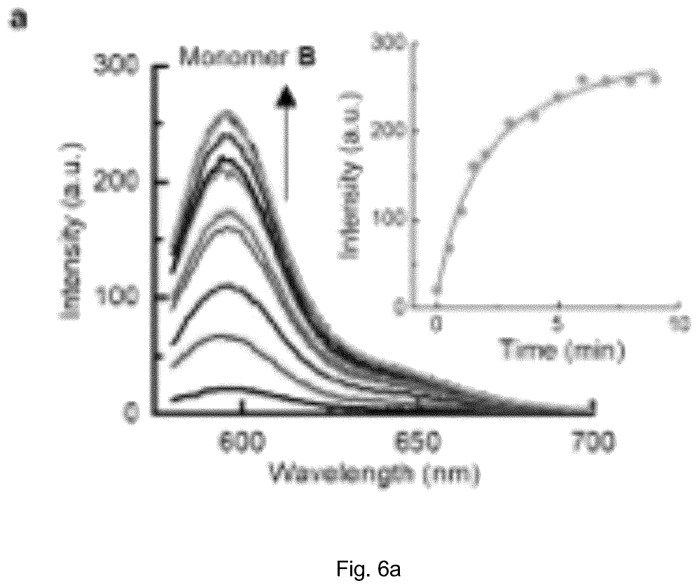

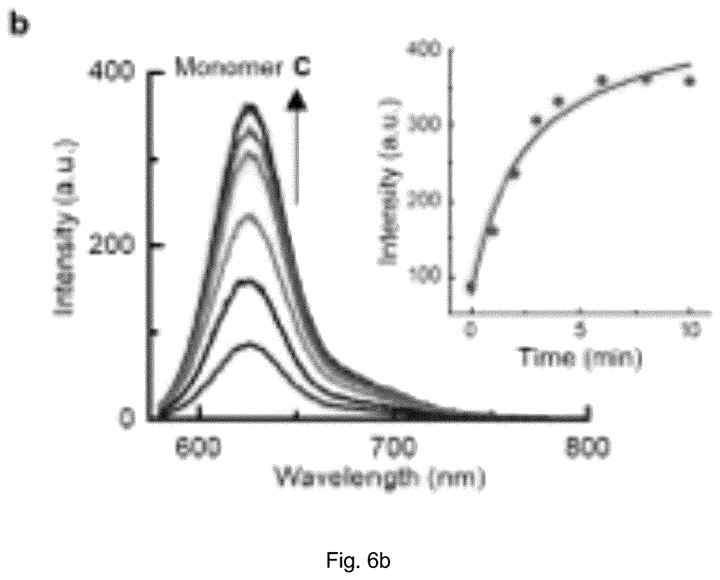

Three monomers (endo- and exo-mixtures) were synthesized, each carrying a BODIPY-based pro-fluorescent sidechain whose uncaged product emits green, yellow, or red fluorescence to be differentiable during copolymerization (FIGS. 1c-f). They can be photo-uncaged efficiently (FIGS. 1g-h). The green monomer has the highest fluorescence on-off ratio of ˜100 (FIG. 1g); the yellow and red monomers have on-off ratios of ˜23 and 5.9 (the latter is too low for further use), respectively (FIGS. 6a-b). Neither of these monomers contain functional groups that would interfere with G2-catalyzed ROMP, as shown by bulk reaction measurements. The 12-atom-long spacer between norbornene and the fluorophore is crucial for their ROMP, as a short 3-atom spacer inactivates the monomer, likely due to steric hinderance.

The G2 catalyst was labeled with the green BODIPY fluorophore and grafted it onto silica-coated magnetic marker particles (hundreds of nanometers in size) to be dispersed sparsely in the microfluidic reactor (FIG. 1i; FIG. 5b). The grafting reaction also initiates the G2 catalyst for subsequent ROMP reactions. The magnetic particles ease the removal of un-grafted catalysts in air-free environment, help locate the catalysts, which can further be counted and localized to nanometer precision via single-molecule fluorescence imaging.

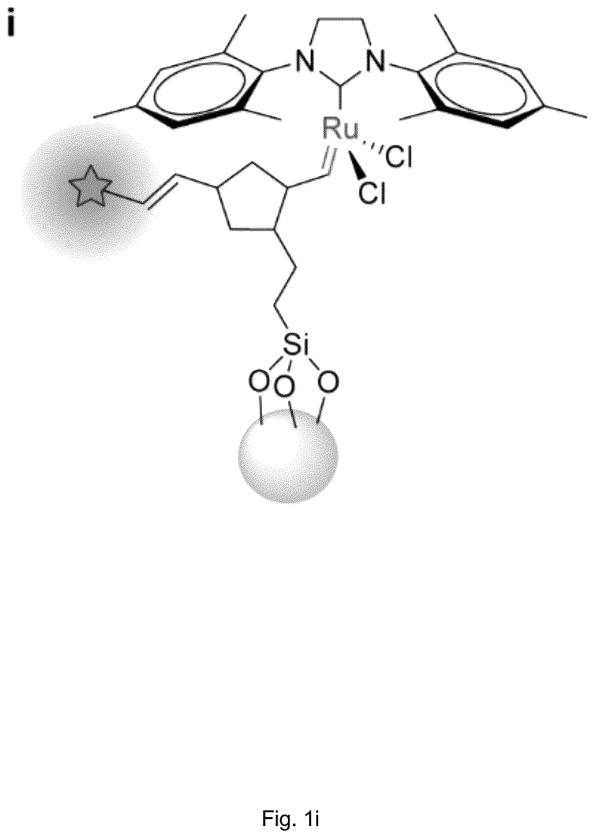

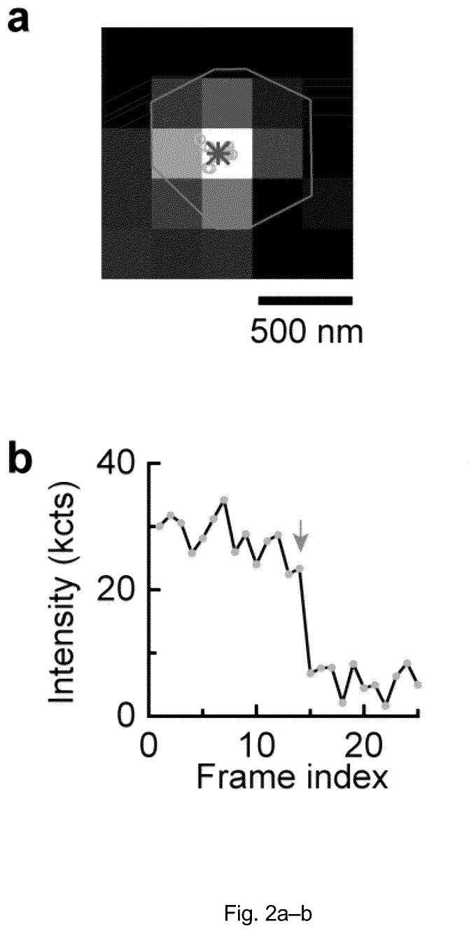

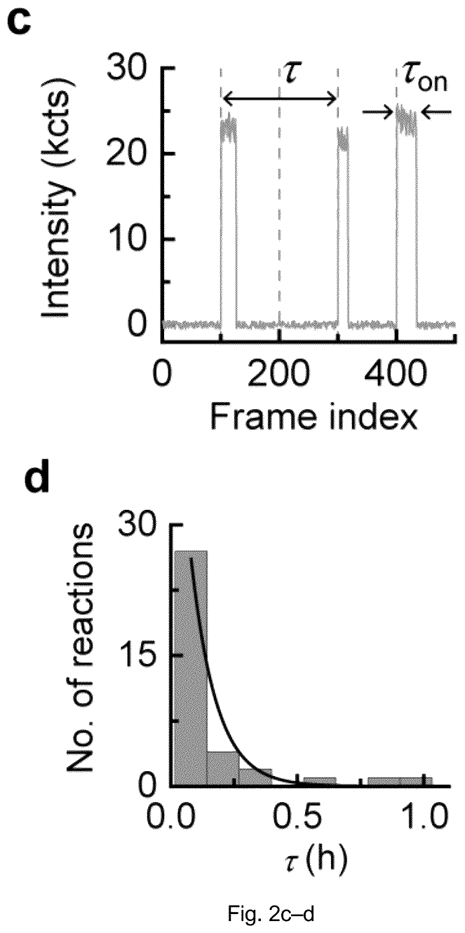

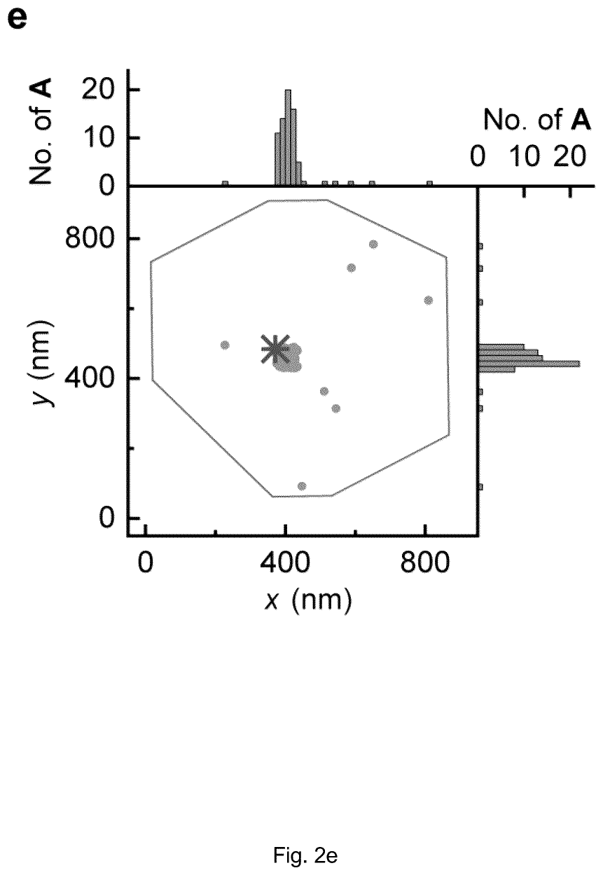

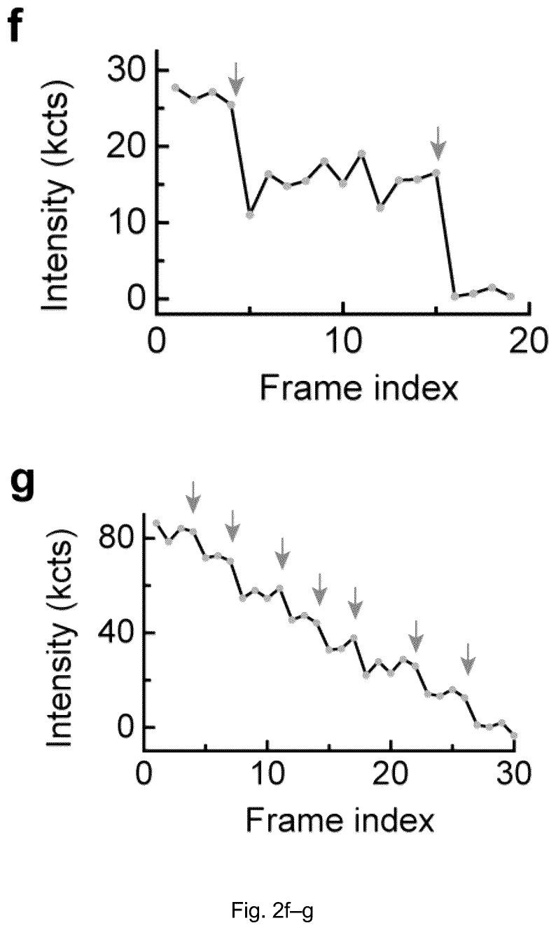

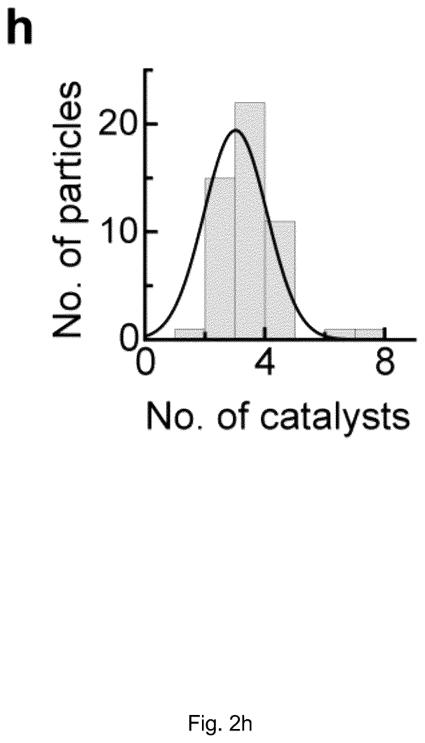

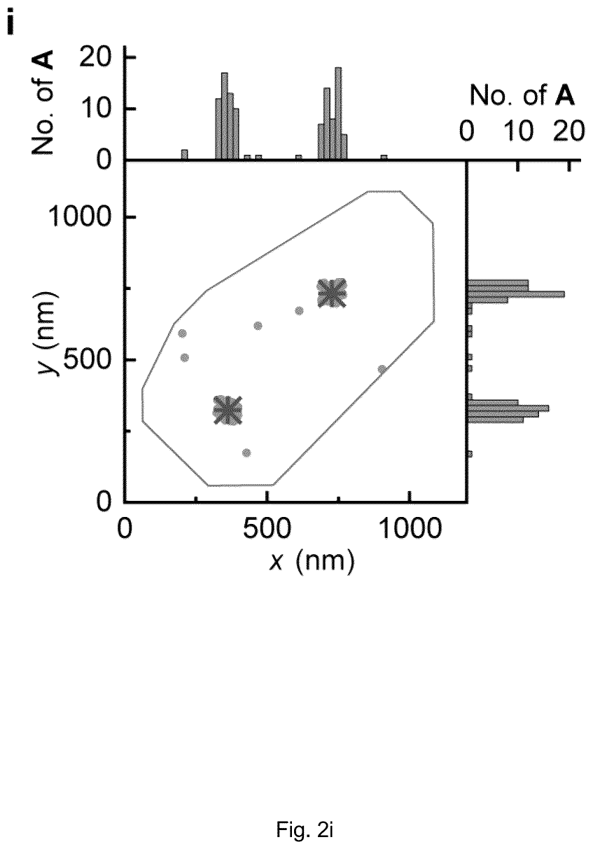

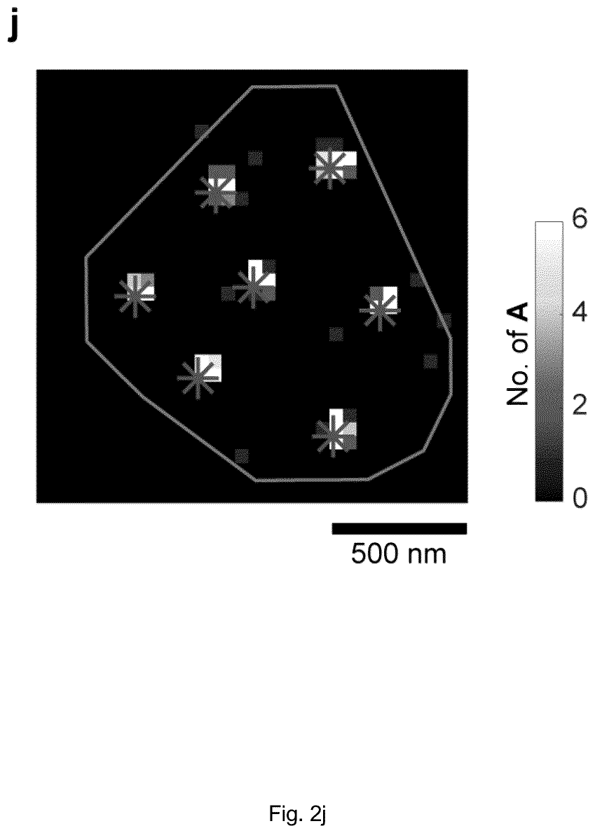

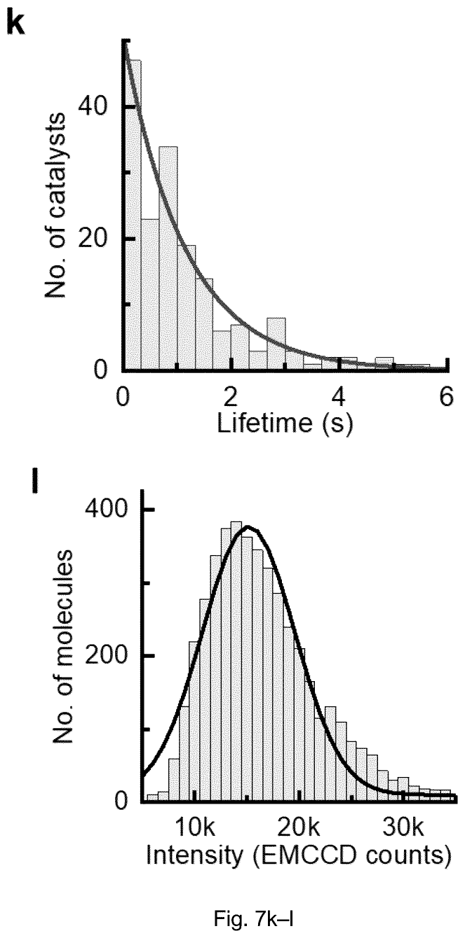

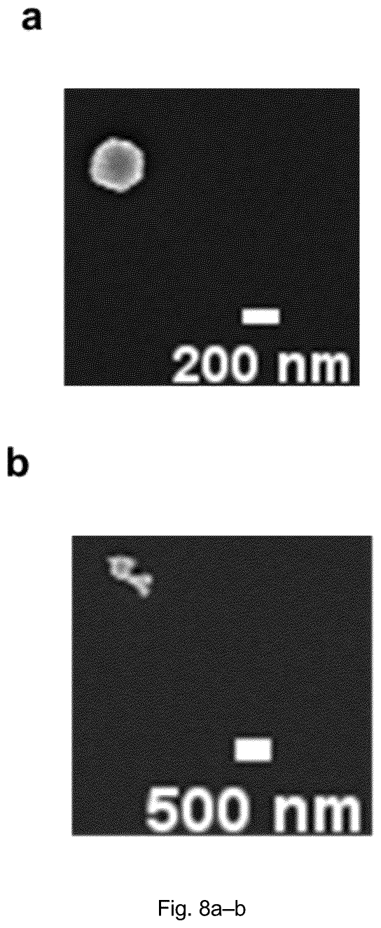

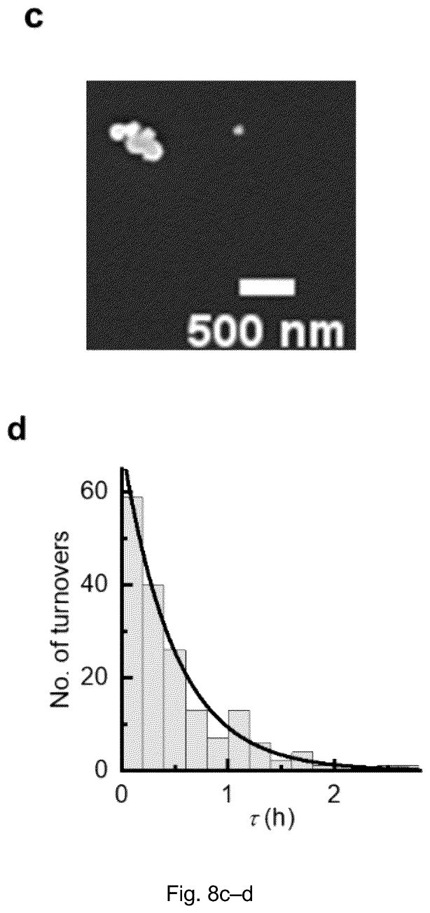

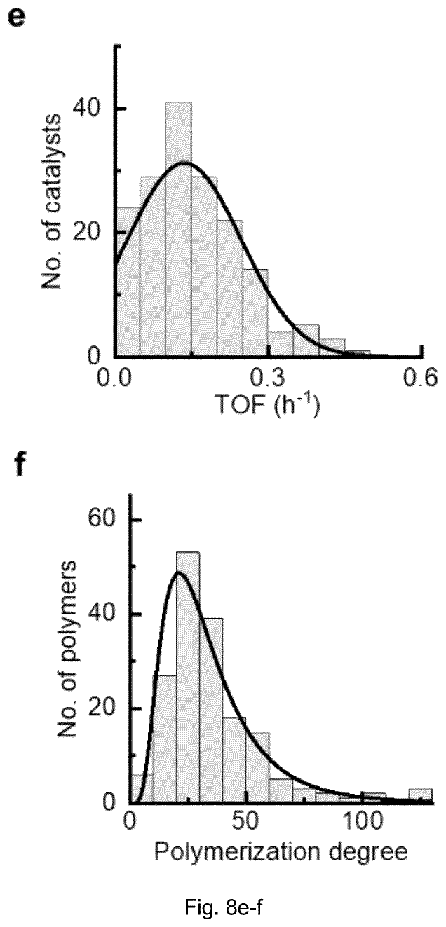

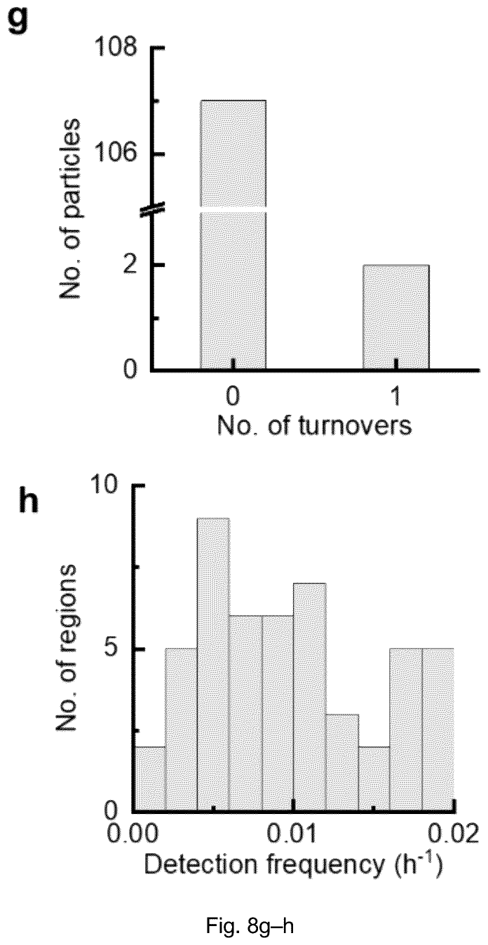

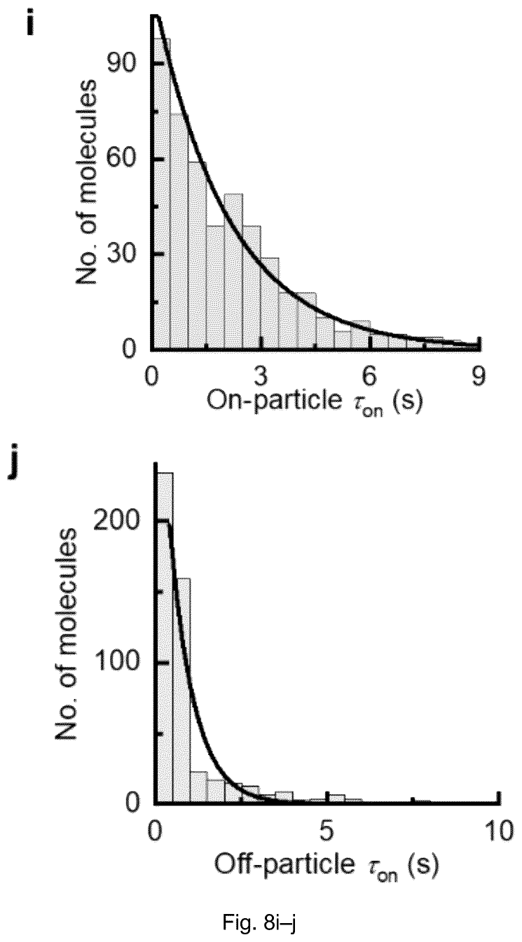

Monomer-resolved single-polymer growth. With CREATS, a homo-polymerization of monomer A in n-hexane under N2-protected conditions was studied. A single labeled-G2-catalyst on a magnetic marker particle of ˜200 nm in diameter was first imaged, localized to nanometer precision, and then photobleached (FIGS. 2a, b), in correlation with scanning electron microscopy of the marker particle (FIGS. 8a-j). Upon flowing the monomer solution into the reactor cell to have steady-state polymerization kinetics, uncaging and imaging cycles were performed at 1 cycle minute 1 to sample the inserted monomers (FIG. 1b). The 375-nm uncaging laser was on for 10 seconds, giving a photo-uncaging efficiency of ˜95% within two cycles. After a 30-second delay for uncaged free monomers to diffuse away, the 488-nm imaging laser was turned on for 10 seconds (much longer than the 2.2±0.3 s photobleaching lifetime of the green fluorophore under such imaging conditions; FIGS. 7d-g), during which fluorescence images were captured continuously (100 ms frame⁻¹). A typical fluorescence intensity trajectory from a single catalyst shows on-off bursts of fluorescence during polymerization, with fluorescence-on levels at expected intensities for individual monomer insertion events (FIG. 2c). The fluorescence-on time (τₒₙ) also follows an exponential distribution and averages at 2.2±0.1 s, expected for single fluorophore photobleaching (FIG. 7d-g). Moreover, not every imaging cycle detected a monomer (FIG. 2c), consistent with the stochastic nature of single-molecule reaction kinetics. The time separation τ from one burst to the next is the microscopic monomer insertion time, while [symbol] τ [symbol] ⁻¹, where [symbol] [symbol] denotes time-averaging, is the turnover frequency (TOF) of the catalyst. Moreover, the distribution of τ, either from a single catalyst (FIG. 2d) or compiled from many catalysts (FIG. 8d), follows a single exponential, indicating that the underlying polymerization kinetics contains merely a single rate-limiting step under our reaction conditions.

The single-monomer resolution also allowed for nanometer-level localization of the individual polymerized monomers. They cluster around the catalyst position on the marker particle (FIG. 2e), further supporting that they are inserted by the same catalyst during polymerization. At [A]=2 nM, the TOF is 0.14±0.11 h⁻¹ per catalyst, averaged from 174 catalysts (FIG. 8e). In contrast, control analyses on marker particles without catalysts give an apparent rate of insignificant value (<0.01 h⁻¹ per particle; FIG. 8g). Fluorescence bursts are also detected off the marker particles, attributable to mostly nonspecific adsorption of uncaged free monomers onto the slide (or sometimes noise-induced false detections); the detection frequency there is only 0.004±0.003 h⁻¹ in a diffraction-limited area, negligible compared with catalyst TOF. Moreover, [symbol] τₒₙ [symbol] for the off-particle events is 1.0±0.1 s (FIG. 8j), significantly shorter than that for the on-catalyst events, which is expected for nonspecifically adsorbed monomers that can undertake desorption besides photobleaching.

Some marker particles contain multiple catalysts (FIG. 2h). The number of catalysts and their locations can be determined from catalyst fluorescence photobleaching steps and corresponding imaging localizations (FIGS. 2f-g). On such marker particles, the positions of polymerized monomers form discrete nano-sized clusters, each around a single catalyst (FIGS. 2i-j). Such super-resolved multi-catalyst cases showcase the power of imaging single-polymer growth at single-monomer resolution.

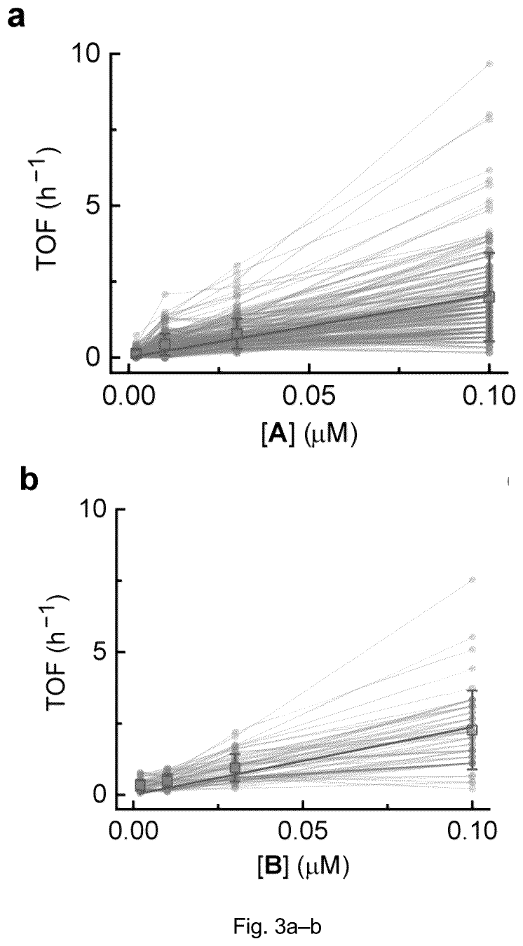

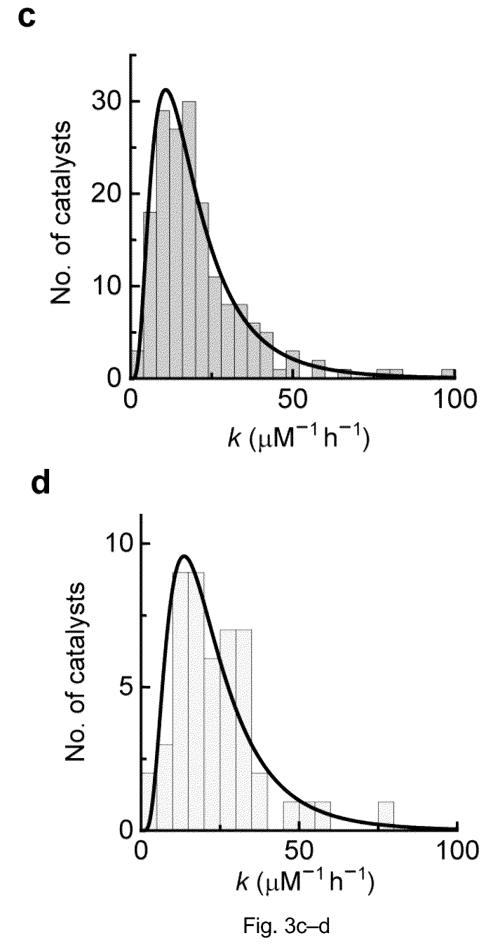

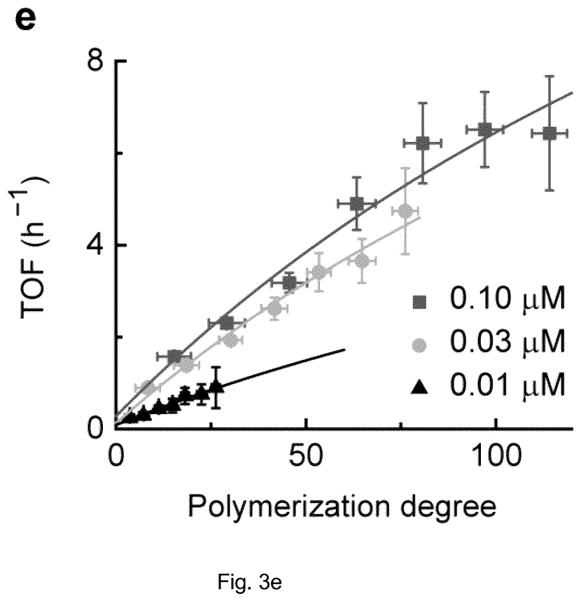

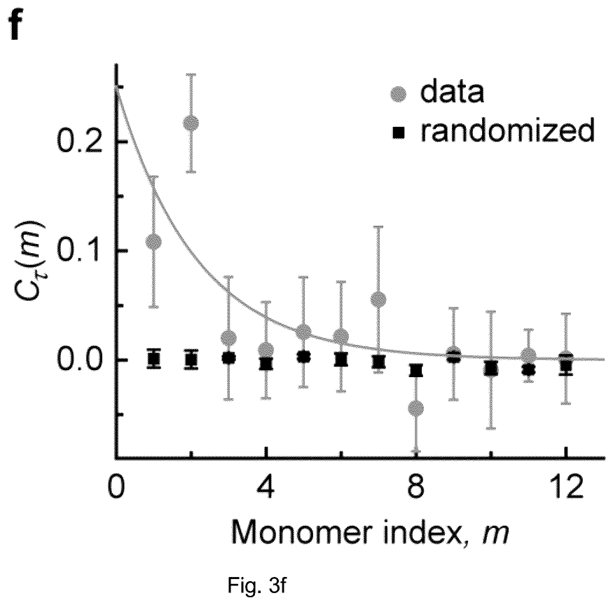

Real-time growth kinetics and dynamics. Real-time single-catalyst polymerization at single-monomer resolution immediately enables us to determine single-chain polymerization kinetics. Using CREATS, we titrated [A] systematically to 0.1 μM, growing individual polymers of 10¹ to 10² subunits, with dispersion Ð=1.36, typical for such linear polymers (FIGS. 8a-j). The TOF is linear to [A] at both the single-catalyst/polymer level and on average (FIG. 3a), expected for ROMP at nM-to-μM monomer concentrations. The first-order rate constant k of individual polymers follows a lognormal distribution, averaging at 21±5 μM⁻¹ (h⁻¹ (FIG. 3c), consistent with well-known kinetic dispersion of synthetic polymers, and here quantified at the single-polymer level. Similar first-order kinetics is also observed for monomer B, with its k averaging at 24±8 μM⁻¹ h⁻¹ (FIGS. 3b, d) and possessing comparable reactivity to A.

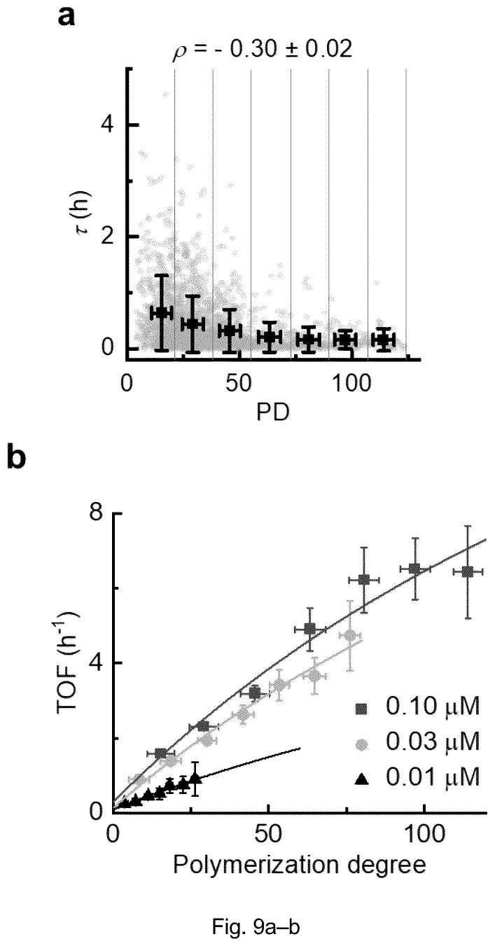

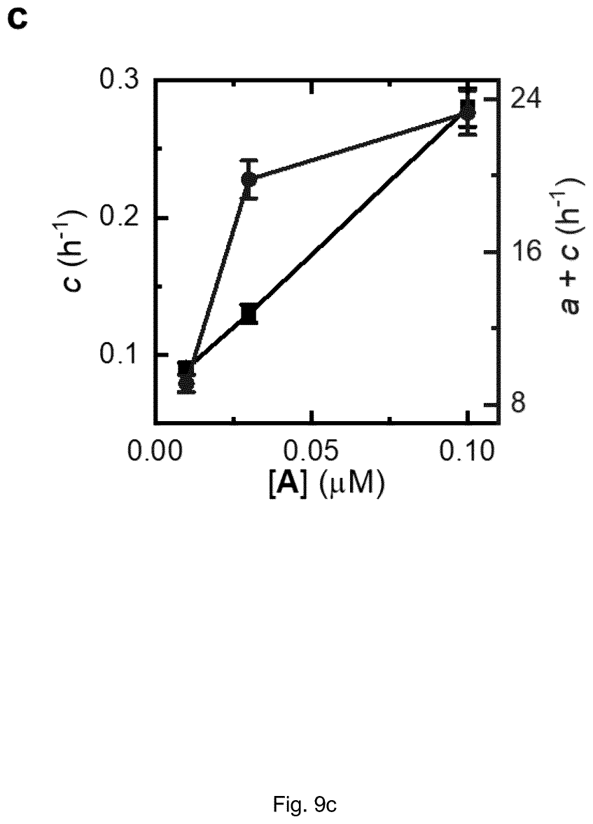

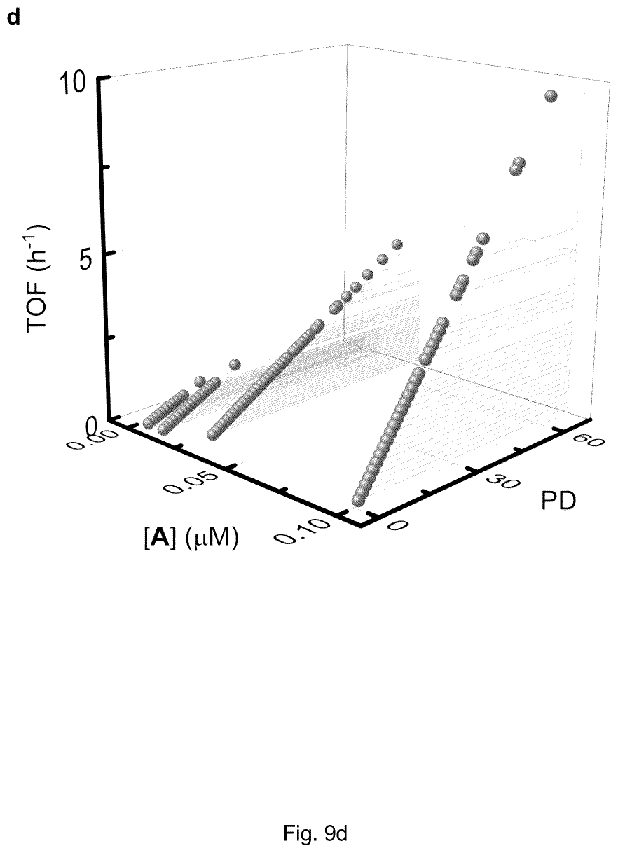

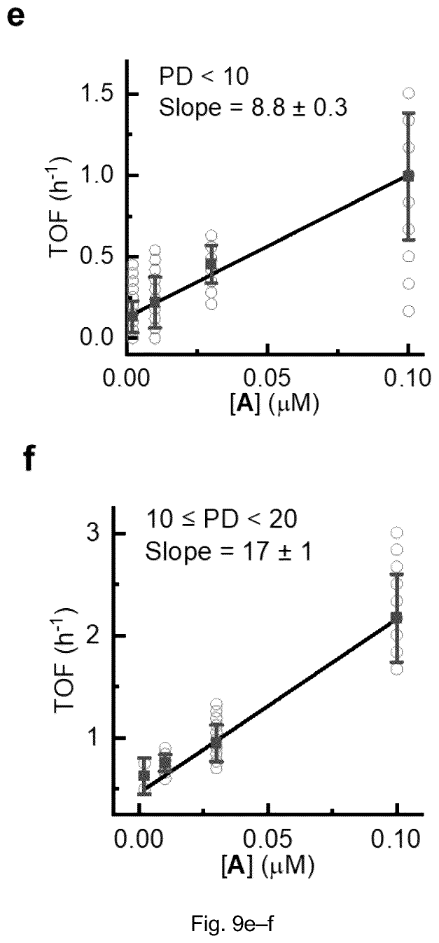

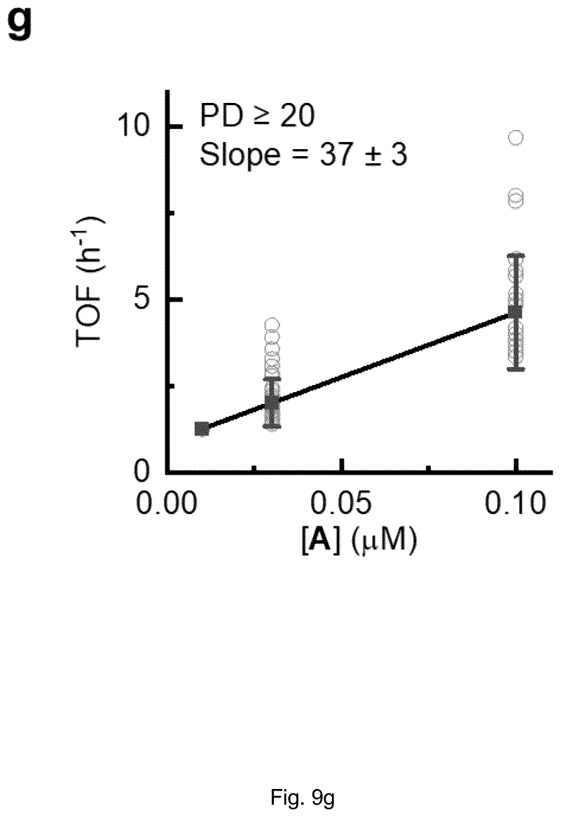

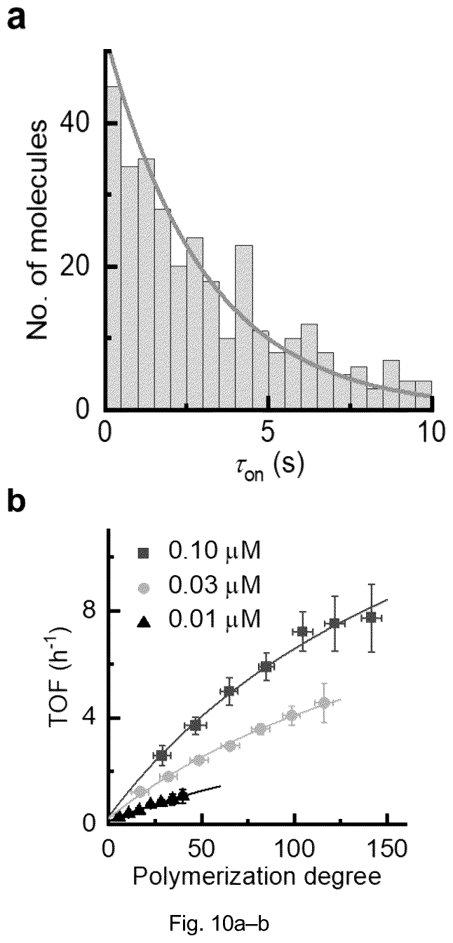

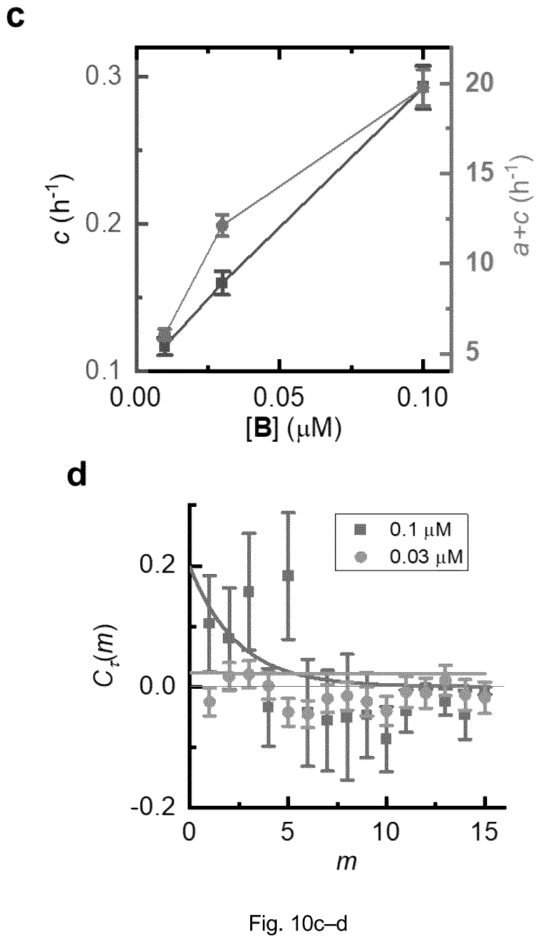

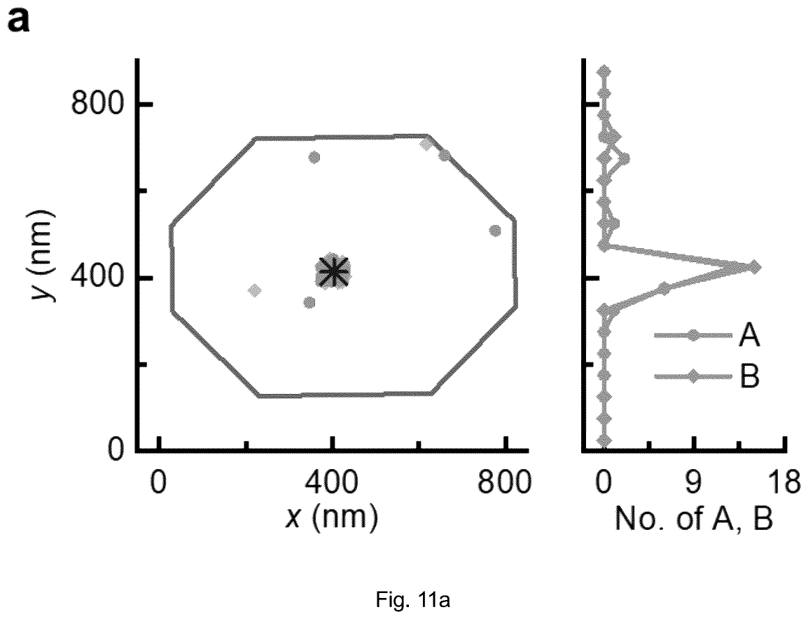

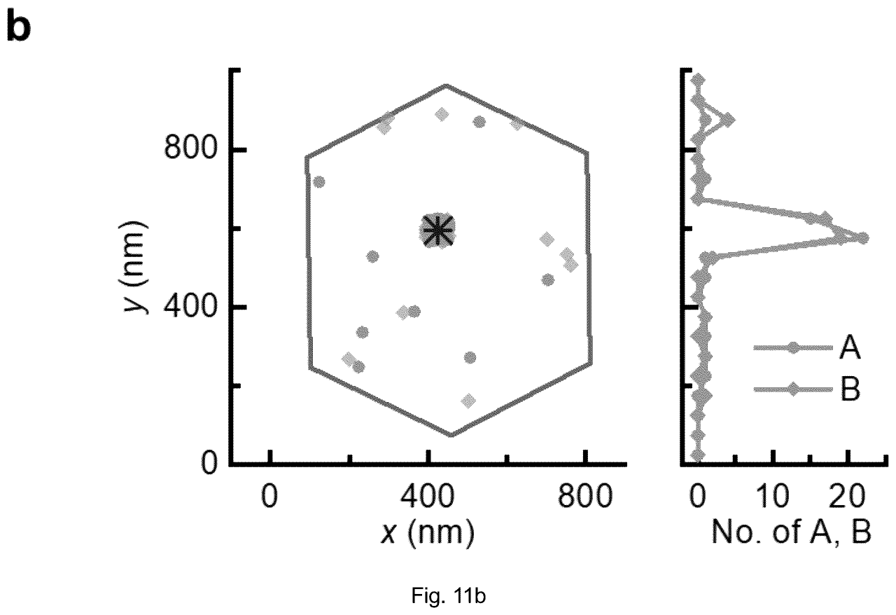

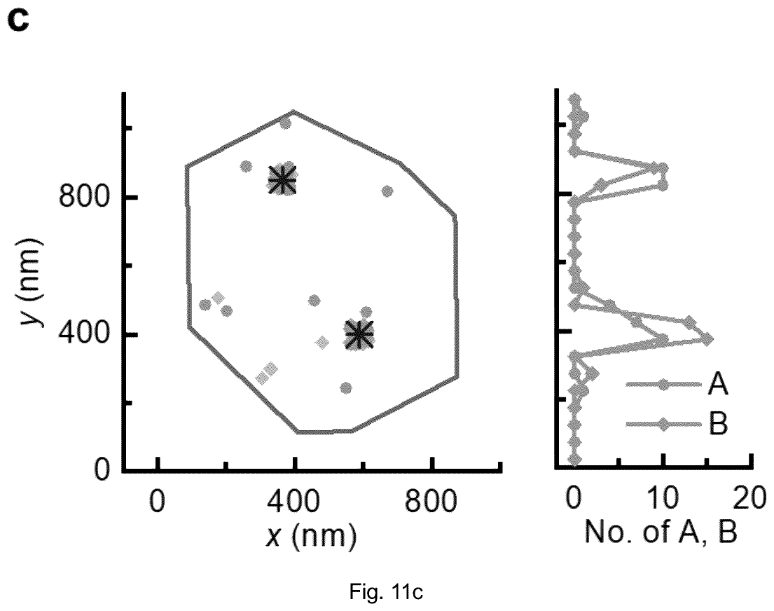

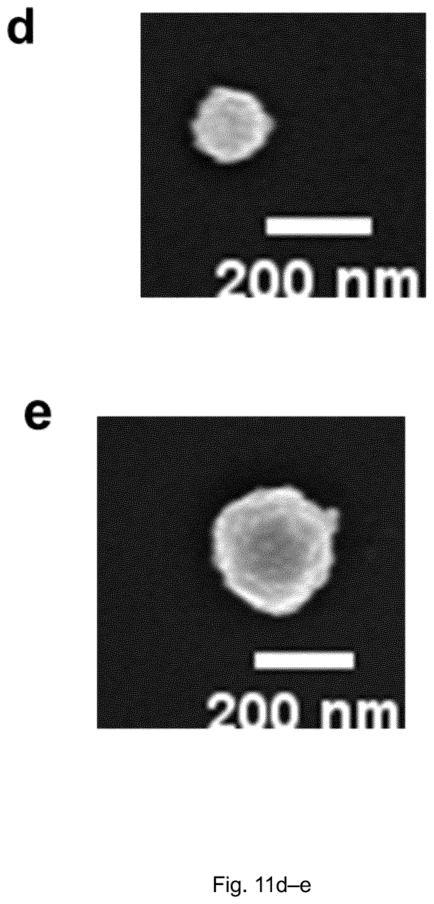

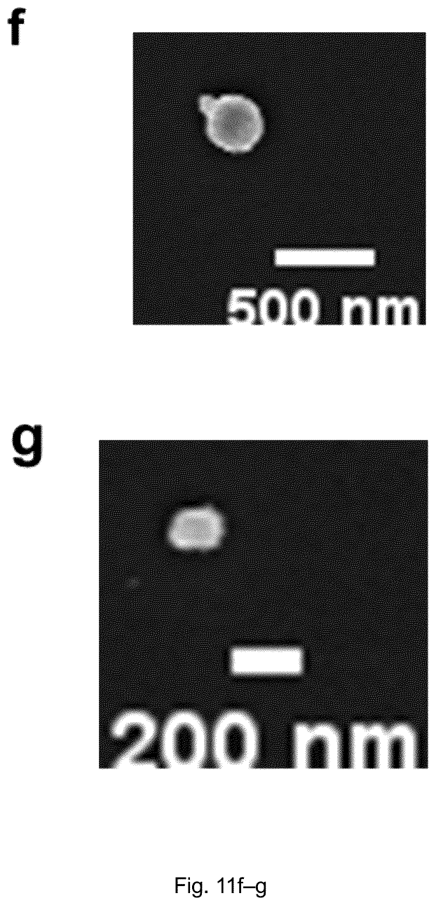

The surface-grafted polymerization here also enables examining surface effects on polymerization kinetics, which is challenging to study at the bulk level due to kinetic dispersion. Strikingly, at each monomer concentration, the single-catalyst TOF shows a clear dependence on the polymerization degree, initially increases and eventually saturates to a rate of substantially larger (FIG. 3e). (Note that at the same polymerization degree or upon extrapolating to zero or infinite polymerization degree, first-order kinetics still holds; FIGS. 9c-g; FIGS. 9a-g) L_{1/2}, the polymerization degree where the TOF is half-way toward saturation, is ˜270 monomers, corresponding to an end-to-end distance of ˜20-to-380 nm; this distance is comparable to the ˜30 nm Bjerrum length in n-hexane, at which electrostatic interactions are comparable to thermal energy. Similar behaviors were observed for monomer B polymerization (FIGS. 10b-c). Therefore, this polymerization-degree-dependent polymerization kinetics likely stems from the influence of surface electrostatics, a ubiquitous surface property that could broadly affect surface-grafted polymerizations.

The single-monomer-resolution polymerization trajectories also allow us to compute the autocorrelation function of the microscopic reaction time τ vs. the turnover index to evaluate time-dependent dynamics. At [A]=0.1 μM, this autocorrelation, averaged over many polymers, shows a clear exponential decay with a time constant of 2±1 turnovers, a behavior indiscernible for randomized τ sequences (FIG. 3f). Such autocorrelation reflects a temporal memory effect in polymer growth, where an earlier faster monomer insertion tends to be followed by two faster insertions. Moreover, at lower [A] where monomer binding to the catalyst is more rate-limiting, the autocorrelation amplitude becomes indiscernible (FIG. 10a), suggesting that this memory effect originates more from monomer insertion than from monomer binding in the catalytic cycle. Such temporal dynamics, observed also for monomer B (FIG. 10k) and inaccessible from bulk polymerization studies, suggests that underlying dynamic processes (e.g., intra-chain neighboring monomer interactions) could modulate polymerization kinetics on surfaces or in solution).

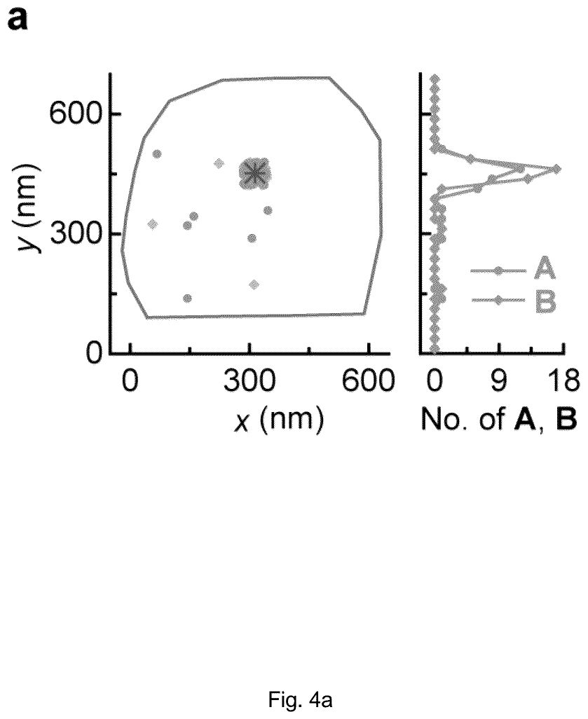

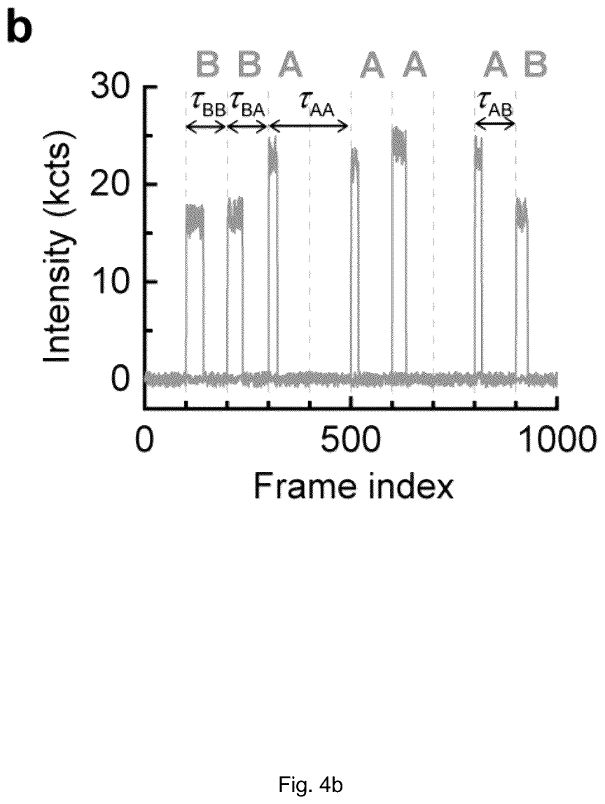

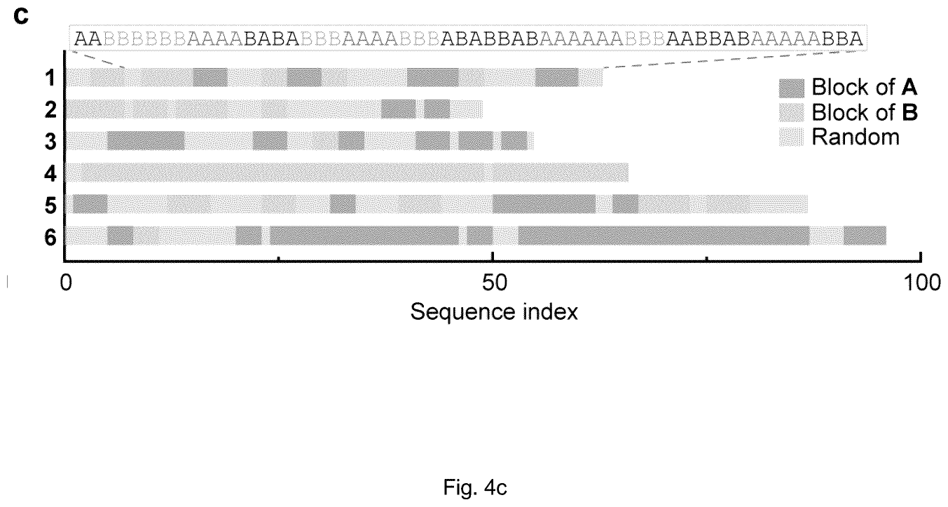

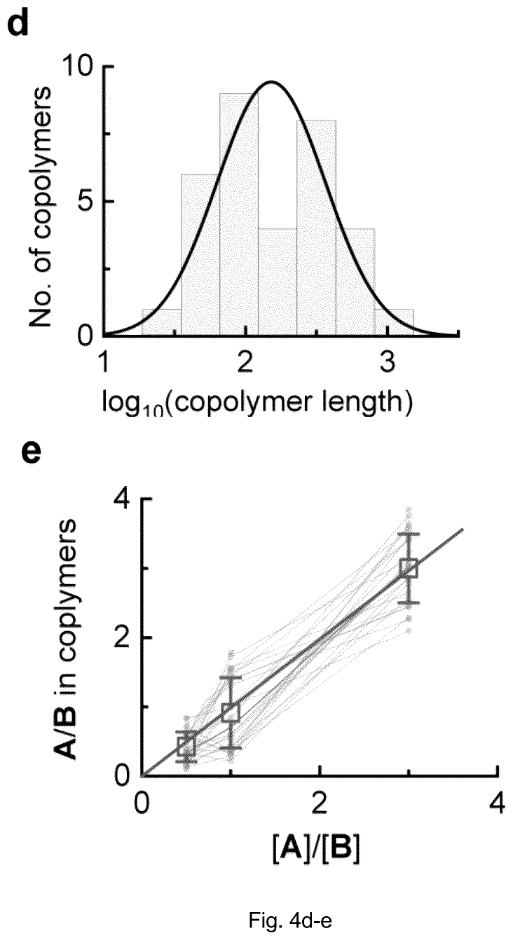

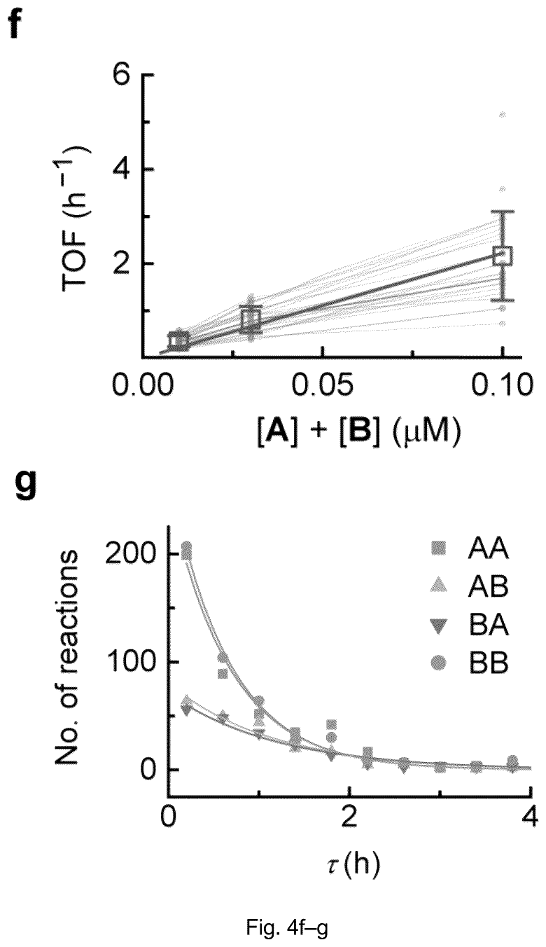

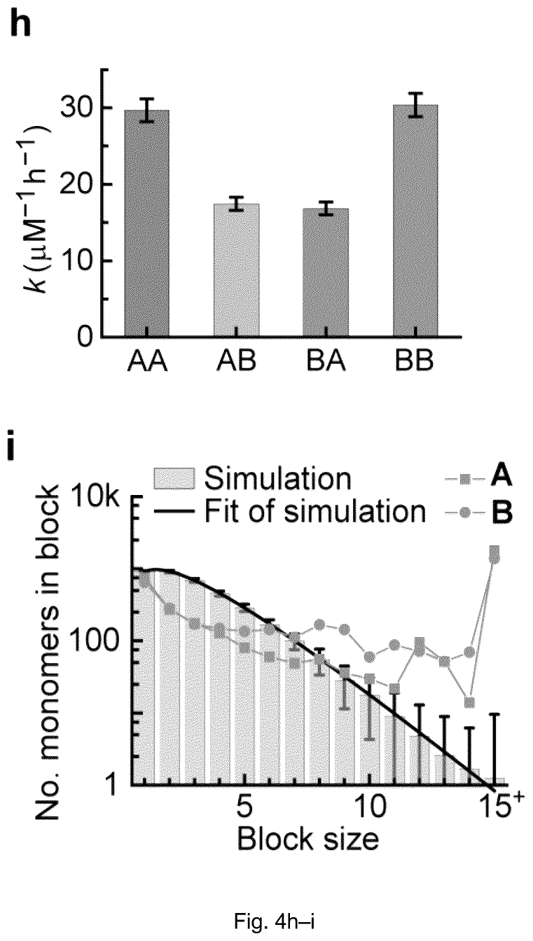

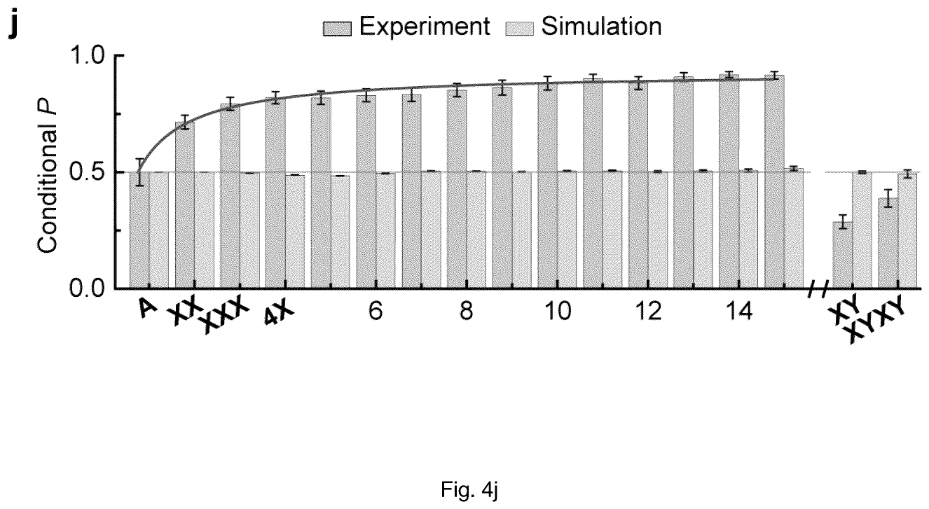

Single copolymer sequencing. Having achieved imaging single-catalyst polymerization at single-monomer resolution with monomer A or B, sequencing single polymers during copolymerization was carried out. We used 488 and 532 nm lasers to excite the uncaged A and B simultaneously for two-color imaging (FIG. 1b and Methods). At the molar ratio of A:B=1:1 with a total 0.1 μM monomer concentration, the polymerized A and B monomers cluster together at the same catalyst (FIG. 4a), consistent with their copolymerization. In the corresponding single-catalyst copolymerization fluorescence trajectories (FIG. 4b), the color of inserted monomers immediately reports the copolymer sequence, a first-of-its-kind polymer sequence information. Approximately 30 copolymers (FIG. 4c)were sequenced; their lengths follow a log-normal distribution (FIG. 4d). The average monomer composition is 1:1 (FIG. 4e), as expected from A and B's comparable ROMP reactivity.

We are unaware of any existing methods for sequencing such synthetic copolymers. Therefore, to further test the method, the ratio and the total concentration of the two monomers was varied. The average compositions of the sequenced copolymers directly follow the ratios of monomers (FIG. 4e); the single-catalyst TOF also scales linearly with the total monomer concentration (FIG. 4f); both support our sequencing fidelity.

The single-catalyst copolymerization fluorescence trajectories also resolve 4 different microscopic monomer insertion time: τ_{AA}, τ_{AB}, τ_{BB}, and τ_{BA}, depending on the identity of the inserting monomer and the preceding one in the growing chain (FIG. 4b). All of them follow single-exponential distributions expectedly, but with clearly different decay constants (FIG. 4g). The corresponding four 1^{st}-order rate constants differ accordingly (FIG. 4k), indicating that a preceding monomer affects the insertion kinetics of the next and consistent with our earlier observation of temporal memory effect in polymerization dynamics (FIG. 3f). The two reactivity ratios, r₁(=k_{AA}/K_{AB}) and r₂(=k_{BB}/K_{BA}), can predict copolymer sequence patterns, which can be estimated by bulk measurements. Both ratios here are >1, reflecting a tendency of chain propagation to insert the same monomer during copolymerization to form blocks. Therefore, the microscopic sequence patterns in the individual 1:1 copolymers were examined, which were measured over extended reaction time (>48 h) to obtain longer copolymer chains. Compared with the simulated random copolymers which also have continuous block segments whose size distribution follows x/2^{x} scaling, the experimentally observed A (or B) blocks show clearly higher occurrences for larger blocks (FIG. 4i), quantifying the prediction from the reactivity ratios.

The conditional probabilities of sequence fragments were further analyzed, i.e., the probability of the last monomer given the prior sequence in the fragment. For single-subunit fragments, the overall probability for either A or B is 0.5, as expected for 1:1 copolymers (FIG. 4j). For XX fragments (X=A or B), its conditional probability is significantly higher than 0.5 for simulated random copolymers (FIG. 4j). More importantly, this higher conditional probability is more pronounced for XXX fragments and then plateaus toward longer blocks—it reaches ˜90% of the plateau at ˜4-monomer blocks, reflecting the tendency of forming longer blocks in these copolymers. Moreover, the conditional probabilities for alternating fragments like XY and XYXY are significantly lower than those for random copolymers (FIG. 4j). Taken together these copolymers tend to form homo-blocks of ˜4 monomers longer than those in random copolymers.

CREATS was developed for imaging single-catalyst polymerization at single-monomer resolution in real time, with access to high reactant concentrations. This approach is generalizable for other types of chemical reactions and enabled quantification of the effects of surface-grafting on polymerization kinetics and uncover the temporal dynamics of single-chain growth, both of which are challenging to access in bulk measurements. The microscopic sequences of individual chains from such imaging not only map the sequence patterns of synthetic copolymers but also enable future structure-function correlation studies at the single-chain level, for example in coupling to magnetic tweezers measurements on single-chain mechanics or as structural inputs for molecular dynamics simulations of polymer chains. The capabilities of sequencing synthetic copolymers is expected to open new opportunities in testing synthetic methods that control polymer sequences and in decoding information in sequence-defined polymers for information storage.

Methods. Synthesis and characterization of monomers and labeled catalysts on marker particles. All reagents and solvents (ACS grade) were purchased through either Sigma-Aldrich, Fisher Scientific, or Alfa Aesar and used without purification. All solvents were used without drying unless otherwise indicated. The solvents n-hexane and toluene involved in single-molecule imaging were dried and stored under nitrogen atmosphere since purchased and further photobleached before use.

The caged monomers and the labeled Grubbs 2^{nd} generation catalyst were synthesized in house and structurally characterized by ¹H NMR, ¹³C NMR, and/or mass spectrometry. The photo-uncaging properties of the caged monomers and the photobleaching properties of the uncaged monomers were characterized at both the ensemble and single-molecule level. The labeled Grubbs 2^{nd} generation catalyst was subsequently grafted onto silica coated magnetic particles (SS0201 Super Mag Silica Beads, Ocean NanoTech).

Analytical thin-layer chromatography (TLC) was performed on glass plates coated with silica (60, F₂₅₄) from EMD Chemicals Inc. Visualization was performed with a 254 nm ultraviolet lamp. Column chromatography was carried out with silica gel (60-200 μm, 60 A) from Acros Organics. The ¹H and ¹³C NMR spectra were recorded at room temperature on a Varian Inova 400 (400 MHZ) or Bruker Advance 500 (500 MHZ) in CDCl₃ solution, and chemical shifts were referenced with residual proton (7.26 ppm) or carbon (77.16 ppm) signal of the deuterated solvent. High resolution mass spectrometry analyses were performed on a Thermo Scientific Exactive Orbitrap MS system equipped with an electrospray ionization source (ESI-HRMS) or with an Ion Sense DART ion source (DART-HRMS).

Solvent photobleaching. Organic solvents (e.g., n-hexane, toluene) used for imaging experiments are irradiated under blue light emitting diodes (Blue LED Tape Light, 24 Volt, FLX-00136, PLT Solutions) for at least 24 h to photobleach potential florescence impurities (FIG. 5e). This treatment lowers the background in fluorescence imaging.

Single-molecule fluorescence imaging experiments and data analysis. All single-molecule fluorescence microscopy experiments were carried out on a home-built prism-type wide-field microscope (Olympus IX71) in total internal reflection fluorescence (TIRF) geometry. A flow reactor cell, 100 μm (height)×3˜5 cm (length)×1 cm (width), formed by sandwiching a quartz slide [Technical Glass, drop casted with fluorescent nanodiamonds (NV, ADAMAS NANO) for drift correction and dried], epoxy glue with minimal double-side tape for spacing, and a borosilicate coverslip (Gold Seal), was used for in operando imaging.

The catalysts on marker particles were introduced into the flow cell in toluene, washed by n-hexane, and then imaged/photobleached. Monomer A and/or B at 1 nM to 0.1 μM in n-hexane under N₂ protection (a positive pressure of N₂ was maintained by a balloon filled with N₂ connected to the monomer solution reservoir) was supplied steadily at ˜2 μL/min to probe real-time polymerization kinetics. The reflective index of n-hexane is 1.375, suitable for TIRF imaging with a quartz prism and quartz slide, as the reflective index of quartz is 1.458.

Continuous wave circularly polarized laser beam of was focused onto the sample (of ˜60×100 μm²) in the flow cell to directly photo-uncage the monomers (10.0 mW at 375 nm), or image & photobleach the uncaged monomers (˜33.0 mW at 488 nm for Monomer A, or 12.9 mW at 532 nm for Monomer B). The timing of uncaging and imaging lasers are shown in FIG. 1b. The fluorescence emitted by the product was collected by a 60×NA1.2 water-immersion objective (UPLSAPO60XW, Olympus), filtered (in single-color imaging: ET525/50m, Chroma for 488-nm illumination or HQ580m60, Chroma for 532-nm illumination), and detected by a back-illuminated ANDOR iXon EMCCD camera (DU897D-CSO-#BV) operated at 100 ms frame time. Both 488 nm and 532 nm laser were used in two-color imaging experiments (FIG. 5c), and the emitted light passed through a Photometrics® DV2 two-channel imaging system (FIG. 5d), which contained a notch filter (ZET532TopNotch™) and a dichroic (FF560-FDi01) before the light was split into two channels, and one filter (ET525/50m or HQ580m60) in each channel. The two channels were imaged on the two halves of the EMCCD camera.

Information of single-molecule polymerization was extracted using a home-written MATLAB program from the fluorescence images in the movies, ‘iQPALM’ (image-based quantitative photo-activated localization microscopy). The initial results were further analyzed based on the SEM images of the marker particles.

Materials and methods. General chemicals and instruments. All reagents and solvents (ACS grade) were purchased through either Sigma-Aldrich, Fisher Scientific, or Alfa Aesar and used without purification unless otherwise specified. All solvents were used without drying unless otherwise indicated. The solvents n-hexane and toluene involved in single-molecule imaging (HX0304-6 and TX0732-6, DriSolv®, MilliporeSigma) were dried and stored under nitrogen atmosphere since purchased, and further photobleached before use. List of chemicals: salicylaldehyde (S356 Aldrich), paraformaldehyde (158127 Sigma-Aldrich), 5-norbornene-2-carboxylic acid (predominantly endo; exo isomer is undetectable in ¹H NMR spectrum; 446440 Aldrich), 2,6-dinitrotoluene (D200603 Aldrich), 1,3-dibromo-5,5-dimethylhydantoin (157902 Aldrich) and azoisobutyronitrile (441090 Aldrich), 2,4-dimethylpyrrole (390836 Aldrich), 2,3-dichloro-5,6-dicyano-p-benzoquinone (D60400 Aldrich), boron trifluoride diethyl etherate (Aldrich 175501), cesium carbonate (441902 Aldrich), triethylamine (T0886 Sigma-Aldrich), trifluoroacetic acid (W729-05 JT Baker), suberic acid (A13963 Alfa Aesar), exo-5-norbornene-2-methanol (771953 Aldrich), 5-norbornene-2-methanol (98%, mixture of endo and exo, ˜100:66 ratio; 248533 Aldrich), N,N′-dicyclohexylcarbodiimide (D 80002 Aldrich), 4-dimethylaminopyridine (107700 Aldrich), calcium carbide (270296 Sigma-Aldrich, was ground before use), 2-acetonaphthone (134775 Sigma-Aldrich), hydroxylamine hydrochloride (159417 Sigma Aldrich), sodium bicarbonate (792519 Sigma Aldrich), potassium hydroxide (PX 1480 Millipore Sigma), 18-crown-6 (274984 Sigma Aldrich), acetophenone oxime (647659 Sigma Aldrich), Grubbs catalyst Generation 2 (G2, 98%, AstaTech), 4-pentenoyl chloride (488679 Millipore Sigma).

Analytical thin-layer chromatography (TLC) was performed on glass plates coated with silica (60, F254) from EMD Chemicals Inc. Visualization was performed with a 254 nm ultraviolet lamp. Column chromatography was carried out with silica gel (60-200 μm, 60A) from Acros Organics. The 1H and ¹³C NMR spectra were recorded at room temperature on a Varian Inova 400 (400 MHZ) or Bruker Advance 500 (500 MHZ) in CDCl₃ solution, and chemical shifts were referenced with residual proton (7.26 ppm) or carbon (77.16 ppm) signal of the deuterated solvent, or in toluene-ds for Ru-containing species where chemical shifts were referenced with residual aromatic protons (˜7.0 ppm). High resolution mass spectrometry analyses were performed on a Thermo Scientific Exactive Orbitrap MS system equipped with an electrospray ionization source (ESI-HRMS) or with an Ion Sense DART ion source (DART-HRMS). Gel permeation chromatography (GPC) analyses were carried out using an Agilent 1260 Infinity GPC System equipped with a refractive index detector, an Agilent 1260 Infinity autosampler, and two Agilent PolyPore columns (5 micron, 4.6 mm ID) which were eluted with THF at 30° C. at 0.3 mL/min and calibrated using monodisperse polystyrene standards. The UV-Vis absorption spectra were obtained with a Beckman Coulter DU 800 spectrometer and the fluorescence emission spectra were recorded on a Varian Cary Eclipse fluorescence spectrometer.

The UV-Vis absorption spectra were obtained with a Beckman Coulter DU 800 spectrometers at a scan speed of 600 nm/min, and the fluorescence emission spectra were recorded on a Varian Cary Eclipse fluorescence spectrometer. The emission spectra were recorded with excitation wavelength of 488/560/575 nm for Monomer A/B/C, respectively, excitation/emission slit widths of 2.5 nm, and a scan speed of 600 nm/min.

Synthesis of short linker caged green-emission monomer (Compound 5).

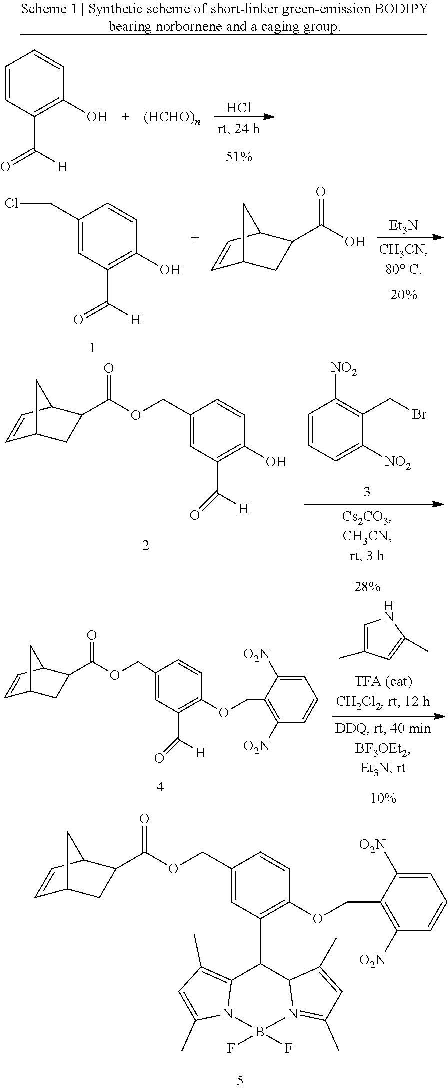

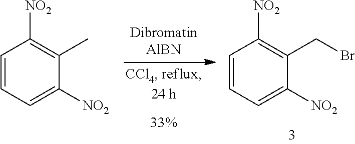

Preparation of 5-Chloromethyl-2-hydroxybenzaldehyde (compound 1). To a well-stirred mixture of concentrated hydrochloric acid (100 mL) and paraformaldehyde (1.6 g, 53.3 mmol) was added salicylaldehyde (5.8 g, 47.5 mmol). The reaction was stirred at room temperature for 24 hours. The solid separated from the reaction mixture was filtered, dissolved in diethyl ether, and then washed with water. After that, the organic phase was dried over Na₂SO₄. The crude product was obtained after filtration and removal of solvent under reduced pressure. Recrystallization from n-hexane afforded the white needle crystals (3.7 g, 51%). ¹H NMR (400 MHz, CDCl₃)δ: 11.07 (s, 1H), 9.90 (s, 1H), 7.55-7.60 (m, 2H), 6.99 (d, J=8.6 Hz, 1H), 4.53 (s, 2H).

Preparation of 3-formyl-4-hydroxybenzyl (1R,4R)-bicyclo[2.2.1 ]hept-5-ene-2-carboxylate (compound 2). To a stirred mixture of 5-norbornene-2-carboxylic acid (553 mg, 4 mmol) and trimethylamine (570 μL, 4.5 mmol) in 50 mL CH₃CN at 80° C., Compound 1 (679 mg, 4 mmol) was added under nitrogen. The reaction mixture was stirred for 3 hours, and then the mixture was evaporated under reduced pressure. The residue was purified by silica column chromatography (petroleum ether/ethyl acetate) to give Compound 2 (218 mg, 20%) as yellow oil. ¹H NMR (400 MHz, CDCl₃)δ: 11.06 (s, 1H), 9.86 (s, 1H), 7.57 (d, J=4.5 Hz, 1H), 7.53 (dd, J=8.6, 4.5 Hz, 1H), 6.99 (d, J=8.6 Hz, 1H), 6.17-6.20 (m, 1H), 5.81-5.83 (m, 1H), 5.04 (d, J=4.5Hz, 2H), 3.20-3.21 (m, 1H), 2.96-3.01 (m, 1H), 2.90-2.91 (m, 1H), 1.88-1.95 (m, 1H), 1.41-1.45 (m, 2H), 1.26-1.29 (m, 2H).

Preparation of 2,6-Dinitrobenzyl bromide (compound 3). 2,6-Dinitrotoluene (1.091 g, 6 mmol), 1,3-dibromo-5,5-dimethylhydantoin (2.57 g, 9 mmol) and azoisobutyronitrile (54 mg, 0.3 mmol) were suspended in CCl₄ (100 mL). The mixture was heated to reflux at 85° C.for 16 hours under nitrogen with stirring, and then cooled to room temperature. The whole reaction mixture was filtered and the filtrate was dried under reduced pressure. The residue was purified by means of silica gel column chromatography (Petroleum ether/ethyl acetate) to give Compound 3 (516 mg, 33%) as light-yellow crystals. ¹H NMR (400 MHZ, CDCl₃)δ: 8.10 (d, 2H, J=8.3 Hz), 7.68 (m, 1H), 4.94 (s, 2H).

Preparation of 4-((2,6-dinitrobenzyl)oxy)-3-formylbenzyl (1R,4R)-bicyclo[2.2. 1 ]hept-5-ene-2-carboxylate (compound 4). To a stirred mixture of Compound 3 (475 mg, 1.8 mmol) and Cs₂CO₃ (593 mg, 1.8 mmol) in 20 mL CH₃CN at room temperature, Compound 2 (496 mg, 1.8 mmol) was added under nitrogen. The reaction mixture was stirred for 3 hours at room temperature, and then the mixture was filtered. The filtrate was poured into CH₂Cl₂. The organic solution was washed with H2O, dried over anhydrous sodium sulfate, filtered and evaporated under reduced pressure. The residue was purified by silica column chromatography (petroleum ether/ethyl acetate) to give Compound 4 (230 mg, 28%) as a yellow solid. ¹H NMR (400 MHZ, CDCl₃) δ: 10.17 (s, 1H), 8.14 (d, J=8.6 Hz, 2H), 7.83-7.84 (m, 1H), 7.74-7.78 (m, 1H), 7.57 (dd, J=8.6, 2.3 Hz, 1H), 7.04 (d, J=8.6 Hz, 1H), 6.19-6.21 (m, 1H), 5.86-5.88 (m, 1H), 5.62 (s, 2H), 5.03 (s, 2H), 3.22-3.21 (m, 1H), 2.98-3.00 (m, 1H), 2.90-2.91 (m, 1H), 1.89-1.94 (m, 1H), 1.42-1.45 (m, 3H).

Preparation of compound 3-(5,5-difluoro-1,3, 7,9-tetramethyl-5H-4l4,5l4-dipyrrolo[1,2-c:2′, l′-f][1,3,2]diazaborinin-10-yl)-4-((2,6-dinitrobenzyl)oxy)benzyl (1R,4R)-bicyclo[2.2. 1 ]hept-5-ene-2-carboxylate (compound 5). A mixed solution of 2,4-dimethylpyrrole (42 μL, 0.4 mmol), Compound 4 (90 mg, 0.2 mmol) and trifluoroacetic acid (2 μL, 0.02 mmol) in anhydrous CH₂Cl₂ (20 mL) was stirred for 12 h under nitrogen at room temperature. Then the solution was cooled to 0° C., 2,3-dichloro-5,6-dicyano-p-benzoquinone (DDQ, 43 mg, 0.2 mmol) in CH₂Cl₂ (5 mL) was added, and the solution was stirred for an additional 30 min. Et₃N (350 μL, 2.8 mmol) and Boron trifluoride diethyl etherate (445 μL, 3.2 mmol) were added, and the mixture was stirred for another 30 min, washed with H₂O (3×30 mL), and dried over Na₂SO₄. The solvent was distilled off under reduced pressure, and the residue was purified by preparative thin layer chromatography (petroleum ether/ethyl acetate) to yield Compound 5 (13 mg, 10%) as a brown solid. ¹H NMR (400 MHZ, CDCl₃) ¹H NMR (400 MHZ, CDCl₃) δ: 7.91 (d, J=8.6 Hz, 2H), 7.55-7.59 (m, 1H), 7.47 (d, J=8.6 Hz, 1H), 7.17 (m, 1H), 7.10 (d, J=8.6 Hz, 1H), 6.13-6.15 (m,1H), 5.95 (s, 3H), 5.80-5.82 (m, 1H), 5.43 (s, 2H), 5.03 (s, 2H), 3.17 (m, 1H), 2.95-2.97 (m, 1H), 2.90-2.91 (m, 1H), 2.51 (s, 12H), 1.88-1.93 (m, 1H), 1.42-1.45 (m, 3H) .. DART-MS (m/z): [M−H]⁺ calcd. For C₃₅H₃₃BN₄O₇F₂, 671.2485; found 671.2494.

Synthesis of long-linker caged green-emission Compound 9 (Monomer A).

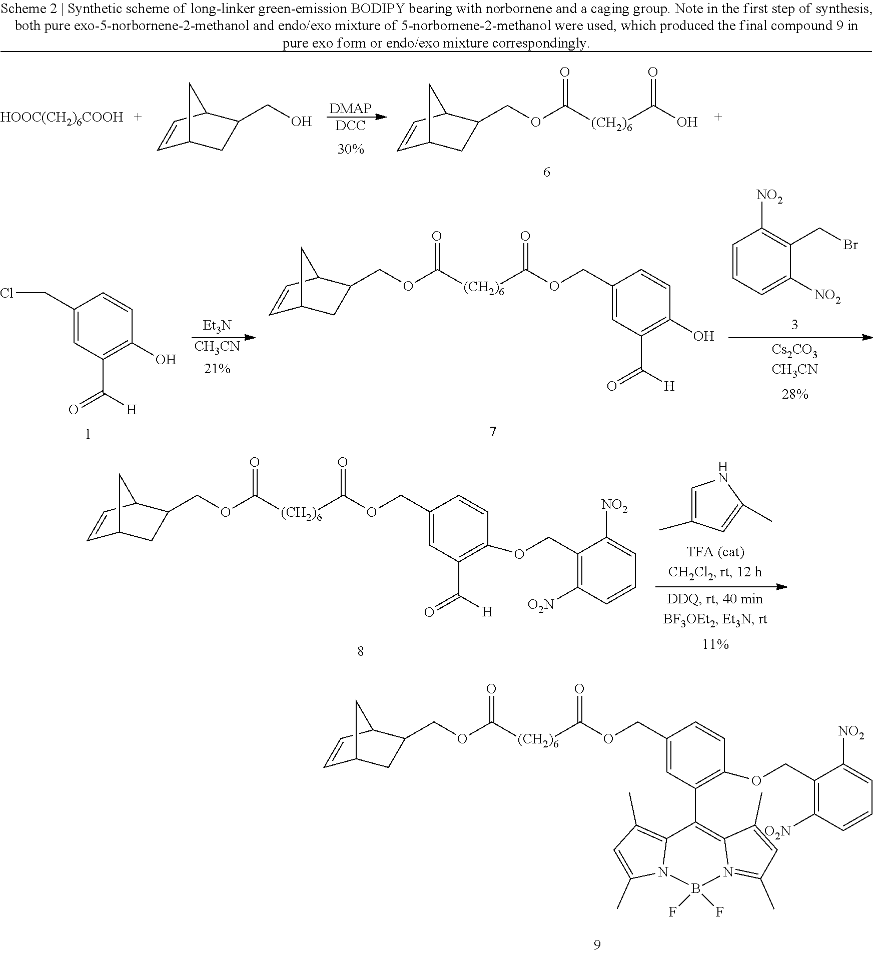

Synthesis of 8-(((1R,4R)-bicyclo[2.2.1]hept-5-en-2-yl)methoxy)-8-oxooctanoic acid (compound 6). Suberic acid (1.045 g, 6 mmol) and 4-dimethylaminopyridine (80.6 mg, 0.66 mmol) were dissolved in anhydrous CH₂Cl₂. The solution was cooled to 0° C., N,N′-dicyclohexylcarbodiimide (1.361 g, 8 mmol) was added under nitrogen; after 30min, exo-5-norbornene-2-methanol (0.62 g, 5 mmol) was added. And the mixture was stirred at 0° C. for another 1 hour and then at room temperature overnight. Precipitated urea is filtered off and the filtrate was evaporated under reduced pressure. The residue was then taken up with ethyl acetate and filtered again. The ethyl acetate solution was evaporated under reduced pressure. Crystalline product 6 (0.42 g, 30%) was obtained. ¹H NMR (400 MHZ, CDCl₃) was used to characterize the compound. ¹H NMR (400 MHZ, CDCl₃) δ: 6.06-6.12 (m, 2H), 4.12-4.18 (m, 1H), 3.93-3.99 (m, 1H), 2.81-2.86 (m, 1H), 2.68-2.70 (m, 1H), 2.30-2.37 (m, 4H), 1.62-1.67 (m, 5H), 1.24-1.39 (m, 6H), 1.12-1.24 (m, 2H).

Synthesis of 1-(((1S,2R)-bicyclo[2.2.1]hept-5-en-2-yl)methyl) 8-(3-formyl-4-hydroxybenzyl) octanedioate (compound 7). To a stirred mixture of Compound 6 (586 mg, 2.1 mmol) and trimethylamine (735 μL, 5.8 mmol) in 50 mL CH₃CN at 80° C., Compound 1 (400 mg, 2.4 mmol) was added under nitrogen. The reaction mixture was stirred for 4 hours, and then the mixture was evaporated under reduced pressure. The residue was purified by silica column chromatography (petroleum ether/ethyl acetate) to give the Compound 7 (183 mg, 21%) as yellow oil. ¹H NMR (400 MHZ, CDCl₃) of Compound 7 (400 MHZ, CDCl₃) δ: 11.05 (s, 1H), 9.91 (s, 1H), 7.59 (d, J=4.5 Hz, 1H), 7.54 (dd, J=8.6, 4.5 Hz, 1H), 7.00 (d, J=8.6 Hz, 1H), 6.06-6.12 (m, 2H), 5.08 (s, 2H), 4.11-4.17 (m, 1H), 3.92-3.99 (m, 1H), 2.81-2.85 (m, 1H), 2.68-2.70 (m, 1H), 2.28-2.37 (m, 4H), 1.60-1.65 (m, 5H), 1.24-1.36 (m, 6H), 1.12-1.24 (m, 2H).

Synthesis of 1-(((1S,2R)-bicyclo[2.2.1]hept-5-en-2-yl)methyl) 8-(4-((2,6-dinitrobenzyl)oxy)-3-formylbenzyl) octanedioate (compound 8). To a stirred mixture of Compound 7 (414.5 mg, 1 mmol) and Cs₂CO₃ (325.8 mg, 1 mmol) in 20 mL CH₃CN at room temperature, Compound 3 (261 mg, 1 mmol) was added under nitrogen. The reaction mixture was stirred for 3 hour at room temperature, after confirmation of disappearance of starting material, the whole was poured into CH₂Cl₂. The organic solution was washed with H₂O, and evaporated under reduced pressure. The residue was purified by silica column chromatography (petroleum ether/ethyl acetate) to give Compound 8 (166 mg, 28%) as a yellow solid. ¹H NMR (400 MHZ, CDCl₃) spectrum of Compound 8 (400 MHZ, CDCl₃) δ: 10.13 (s, 1H), 8.10 (d, J=4.5 Hz, 2H), 7.80-7.81 (m, 1H), 7.72-7.75 (m, 1H), 7.55 (dd, J=8.6, 2.3 Hz, 1H), 7.02 (d, J=8.6 Hz, 1H), 6.03-6.07 (m, 2H), 5.58 (s, 2H), 5.04 (s, 2H), 4.09-4.12 (m, 1H), 3.90-3.94 (m, 1H), 2.79-2.81 (m, 1H), 2.65-2.67 (m, 1H), 2.27-2.33 (m, 4H), 1.57-1.70 (m, 5H), 1.27-1.32 (m, 6H), 1.10-1.24 (m, 2H). ¹³C NMR (126 MHZ, CDC13,) 8: 188.30, 173.78, 173.38, 159.38, 150.77, 136.90, 136.20, 135.83, 130.65, 130.18, 128.76, 128.13, 125.39, 125.15, 112.60, 68.38, 64.92, 62.54, 44.94, 43.66, 41.58, 37.97, 34.26, 34.11, 29.57, 28.73, 28.72, 24.79, 24.69. HRMS (ESI+): m/z calcd for [M+H]⁺, 595.2292; Found, 595.2278.

Synthesis of 1-(((1S,2R)-bicyclo[2.2.1]hept-5-en-2-yl)methyl) 8-(3-(5,5-difluoro-1,3,7,9-tetramethyl-5H-414,514-dipyrrolo[1,2-c:2′, 1′-f][1,3,2]diazaborinin-10-yl)-4-((2,6-dinitrobenzyl)oxy)benzyl) octanedioate (compound 9). A mixed solution of 2,4-dimethylpyrrole (56 μL, 0.54 mmol), Compound 8 (160 mg, 0.27 mmol) and trifluoroacetic acid (2 μL, 0.02 mmol) in anhydrous CH₂Cl₂ (20 mL) was stirred for 12 h under nitrogen at room temperature.

Then the solution was cooled to 0° C., 2,3-dichloro-5,6-dicyano-p-benzoquinone (DDQ, 61.3 mg, 0.3 mmol) in CH₂Cl₂ (5 mL) was added, and the solution was stirred for an additional 30 min. Et₃N (527 μL, 4.2 mmol) and BF3 Et₂O (535 μL, 3.8 mmol) were added, and the mixture was stirred for another 30 min, washed with H₂O (3×30 mL), and dried over Na₂SO₄. The solvent was distilled off under reduced pressure, and the residue was purified by silica column chromatography (petroleum ether/ethyl acetate) to yield Compound 9 (24 mg, 11%) as a brown solid. ¹H NMR (400 MHZ, CDCl₃) spectrum of Compound 9 (400 MHZ, CDCl₃) δ: 7.96 (d, J=4.5 Hz, 2H), 7.58-7.60 (m, 1H), 7.45 (dd, J=8.6, 2.3 Hz, 1H), 7.16 (d, J=2.0 Hz, 1H), 7.08 (d, J=4.1 Hz, 1H), 6.04-6.09 (m, 2H), 5.93 (s, 2H), 5.41 (s, 2H), 5.06 (s, 2H), 4.11-4.13 (m, 1H), 3.92-3.96 (m, 1H), 2.81 (m, 1H), 2.67 (m, 1H), 2.50 (s, 6H), 2.27-2.31 (m, 4H), 1.57-1.70 (m, 5H), 1.39 (s, 6H), 1.27-1.32 (m, 6H), 1.12-1.16 (m, 2H). ¹³C NMR (126 MHZ, CDC13, 8: 173.73, 173.30, 155.21, 154.62, 150.52, 150.51, 142.63, 136.93, 136.61, 136.20, 131.34, 131.30, 130.68, 130.26, 130.19, 128.80, 128.21, 125.49, 124.67, 120.95, 113.23, 68.41, 65.05, 63.09, 44.93, 43.66, 41.59, 37.98, 34.28, 34.16, 29.58, 28.77, 28.76, 24.79, 24.74, 14.60, 13.91. HRMS (ESI*): m/z calcd for [M+Na]⁺, 835.3302; Found, 835.3314.

Similarly following Scheme 2, 5-norbornene-2-methanol (mixture of exo and endo) was used as starting material, Compound 9 (mixture of exo and endo) was also obtained. ¹H NMR (400 MHZ, CDCl₃) spectrum of Compound 9 shows a mixture of exo and endo.

Synthesis of long-linker caged red-emission Compound 11 (Monomer C).

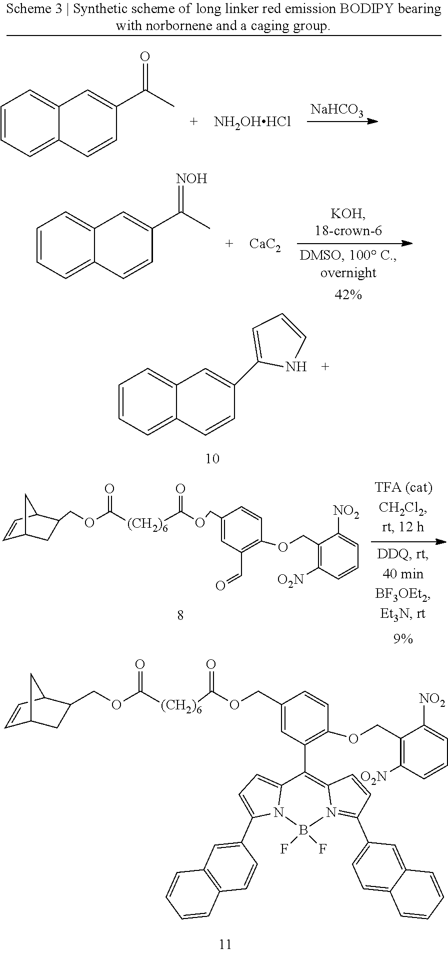

Synthesis of 2-(Naphthalen-2-yl)pyrrole (compound 10). Hydroxylamine hydrochloride (12 mmol, 0.85 g) was dissolved in DMSO (50 mL) in a flask with a magnetic stirrer bar, and then NaHCO₃ (17 mmol, 1.45 g) and 2-acetonaphthone (6.7 mmol, 2.2 g) were added. The reaction mixture was stirred at 60° C. for 4 h. After completion of the reaction, calcium carbide (75.5 mmol, 4.84 g), potassium hydroxide (20 mmol, 1.14 g) and 18-crown-6 (0.28 mmol, 73 mg) were added and the mixture was heated to 100° C.overnight. The reaction was cooled to room temperature and diluted by the dropwise addition of H₂O (10 mL). The reaction mixture was filtered and the solution was extracted with ethyl ether. The combined extracts were washed with brine, dried over Na₂SO₄ and evaporated under reduced pressure to give the crude product, which was further purified by silica gel column chromatography (eluted with ethyl acetate/petroleum ether) to afford the corresponding 2-(Naphthalen-2-yl)pyrrole as a purple solid (1.06 g, 42% yield). Proton and carbon NMR spectra matched those previously reported in the literature. ¹H NMR 400 MHZ, CDCl₃) 8: 8.59 (br, 1H), 7.85-7.79, (m, 4H), 7.67 (dd, J=8.4, 1.6, 2H), 7.49-7.40 (m, 2H), 6.93 (s, 1H), 6.66 (s, 1H), 6.35 (s, 1H). ¹³C NMR (500 MHz, CDCl₃): δ ppm 133.8, 132.1, 132.1, 130.2, 128.6, 127.7, 127.7, 126.5, 125.4, 123.2, 121.1, 119.2, 110.3, 106.6.

Synthesis of 1-(((1S,2R)-bicyclo[2.2.1]hept-5-en-2-yl)methyl) 8-(3-(5,5-difluoro-3,7-di(naphthalen-2-yl)-5H-414,514-dipyrrolo[1,2-c:2′, 1′-f][1,3,2]diazaborinin-10-yl)-4-((2,6-dinitrobenzyl)oxy)benzyl) octanedioate (compound 11). A mixed solution of Compound 10 (104.4 mg, 0.54 mmol), Compound 8 (mixture of exo and endo, 160 mg, 0.27 mmol) and trifluoroacetic acid (2 μL, 0.02 mmol) in anhydrous CH₂Cl₂ (20 mL) was stirred for 12 h under nitrogen at room temperature. Then the solution was cooled to 0° C., 2,3-dichloro-5,6-dicyano-p-benzoquinone (DDQ, 61.3 mg, 0.3 mmol) in CH₂Cl₂ (5 mL) was added, and the solution was stirred for an additional 30 min. Et₃N (527 μL, 4.2 mmol) and BF3 .Et₂O (535 μL, 3.8 mmol) were added, and the mixture was stirred for another 30 min, washed with H₂O (3×30 mL), and dried over Na₂SO₄. The solvent was distilled off under reduced pressure, and the residue was purified by silica column chromatography (petroleum ether/ethyl acetate) to yield Compound 11 (24.5 mg, 9%) as a brown solid. ¹H NMR (400 MHZ, CDCl₃) spectrum of Compound 11 (400 MHz, CDCl₃) δ: 7.21-8.38 (m, 20H, Ar-H), 6.68-6.70 (m, 4H), 5.91-6.14 (m, 2H), 5.52 (s, 2H), 5.15 (s, 2H), 3.62-4.14 (m, 2H), 2.62-2.84 (m, 2H), 2.28-2.40 (m, 4H), 1.79-1.83 (m, 1H), 1.61-1.70 (m, 5H), 1.45-1.44 (m, 6H), 1.12-1.24 (m, 2H). ¹³C NMR (126 MHz, CDCl₃): 173.9, 173.6, 159.0, 156.1, 150.5, 138.7, 137.7, 137.1, 136.3, 133.8, 133.1, 132.3, 132.1, 131.3, 130.4, 130.2, 129.6, 128.5, 127.9, 127.7, 127.1, 126.8, 126.4, 126.1, 124.7, 121.5, 115.2, 68.6, 67.9, 65.2, 64.7, 49.5, 45.1, 44.0, 43.8, 42.3, 41.7, 38.1, 37.9, 34.3, 29.9, 29.7, 29.1, 28.9, 25.0, 24.9. HRMS (ESI⁺): m/z calcd for [M+Na]⁺, 1031.3615; Found, 1031.3640.

Synthesis of long-linker caged yellow-emission Compound 13 (Monomer B).

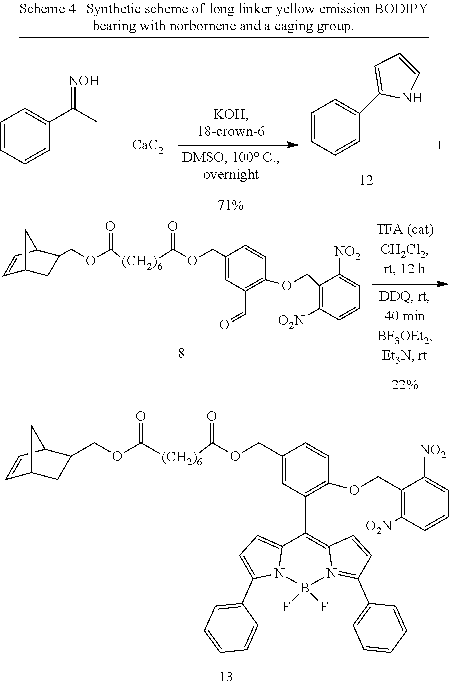

Synthesis of 2-phenylpyrrole (compound 12). A mixture of calcium carbide (60 mmol, 3.85 g), acetophenone oxime (10 mmol, 1.3516 g), potassium hydroxide (15 mmol, 0.84 g), and 18-crown-6 (0.21 mmol, 55 mg) was suspended in 30 ml of (50:1) DMSO-H₂O. The mixture was heated to 100° C. overnight. The reaction was cooled to room temperature and diluted by the dropwise addition of H₂O (10 mL). The reaction mixture was filtered and the solution was extracted with ethyl ether. The combined extracts were washed with brine, dried over Na₂SO₄ and evaporated under reduced pressure to give the crude product, which was further purified by silica gel column chromatography (eluted with ethyl acetate/petroleum ether) to afford the corresponding 2-phenylpyrrole as a purple solid (1.02 g, 71% yield). Proton and carbon NMR spectra matched those previously reported in the literature. ¹H NMR (400 MHZ, CDCl₃) δ: 8.44 (br, 1H), 7.49-7.47, (m, 2H), 7.35-7.38 (m, 2H), 7.23-7.19 (m, 1H), 6.86 (s, 1H), 6.54 (s, 1H), 6.31(s, 1H). ¹³C NMR(500 MHz, CDCl₃): δ ppm 132.8, 132.1, 128.9, 126.2, 123.9, 118.8, 110.1, 106.0.

Synthesis of 1-(((1S,2R)-bicyclo[2.2.1]hept-5-en-2-yl)methyl) 8-(3-(5,5-difluoro-3,7-diphenyl-5H-414,514-dipyrrolo[1,2-c:2′,l′-f][1,3,2]diazaborinin-10-yl)-4-((2,6-dinitrobenzyl)oxy)benzyl) octanedioate (compound 13). A mixed solution of Compound 12 (43.4 mg, 0.3 mmol), Compound 8 (mixture of exo and endo, 90 mg, 0.15 mmol) and trifluoroacetic acid (1.5 μL, 0.015 mmol) in anhydrous CH₂Cl₂ (20 mL) was stirred for 12 h under nitrogen at room temperature. Then the solution was cooled to 0° C., 2,3-dichloro-5,6-dicyano-p-benzoquinone (DDQ, 34 mg, 0.15 mmol) in CH₂Cl₂ (5 mL) was added, and the solution was stirred for an additional 30 min. Et₃N (290 μL, 2.3 mmol) and BF3 Et₂O (330 μL, 2.3 mmol) were added, and the mixture was stirred for another 30 min, washed with H₂O (3×30 mL), and dried over Na₂SO₄. The solvent was distilled off under reduced pressure, and the residue was purified by silica column chromatography (petroleum ether/ethyl acetate) to yield Compound 13 (30.0 mg, 22%) as a brown solid. ¹H NMR (400 MHZ, CDCl₃) spectrum of compound (400 MHz, CDCl₃) δ: 7.85-7.90 (m, 6H), 7.52-7.54 (dd, J=6.4, 2.0 Hz, 1H), 7.36-7.48 (m, 8H), 7.19-7.21 (d, J=7.2 Hz, 1H), 6.64-6.65 (d, J=3.6 Hz, 2H), 6.54-6.55 (d, J=3.6 Hz, 2H), 5.91-6.14 (m, 2H), 5.49 (s, 2H), 5.13 (s, 2H), 3.62-4.15 (m, 2H), 2.62-2.86 (m, 2H), 2.27-2.39 (m, 4H), 1.61-1.72 (m, 5H), 1.31-1.45 (m, 6H), 1.13-1.17 (m, 2H). ¹³C NMR (126 MHZ, CDCl₃) 8: 173.9, 173.8, 173.6, 159.0, 156.1, 150.4, 139.0, 137.7, 137.1, 136.8, 136.3, 132.8, 132.3, 132.0, 131.3, 130.4, 130.3, 130.2, 129.6, 129.5, 128.5, 128.4, 128.3, 125.9, 124.6, 121.1, 115.1, 68.5, 67.9, 65.2, 64.6, 49.5, 45.1, 44.0, 43.8, 42.3, 41.7, 38.1, 37.9, 34.4, 34.3, 29.8, 29.7, 29.1, 28.9, 25.0, 24.9. HRMS (ESI⁺): m/z calcd for [M+Na]⁺, 931.3302; Found, 931.3257.

Synthesis of BODIPY-labeled G2 catalyst and its immobilization on magnetic marker particles.

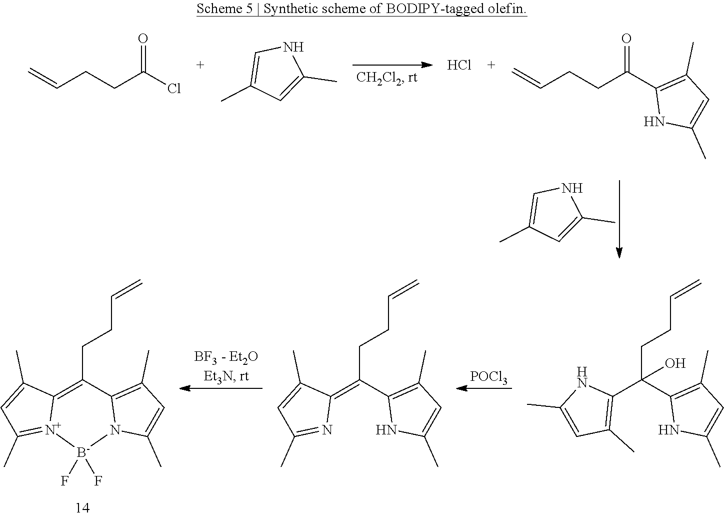

Synthesis of Compound 14. The synthesis of BODIPY-tagged olefin has been published by Blum et al. and reproduced in this work to tag the second-generation Grubbs catalysts (Scheme 5). In a round bottom flash, 4-pentenoyl chloride (0.207 g, 1.745 mmol) and 2,4-dimethyl pyrrole (0.454 g, 4.775 mmol) were mixed in 30 mL of dry CH₂Cl₂. The solution has a yellow color, but it changes to a red-brown color over 5 minutes. Phosphorus oxychloride (0.180 mL, 1.93 mmol) was added dropwise while the solution was stirred with a magnetic stirrer bar. The solution was refluxed and stirred overnight. The solution was concentrated in vacuo. Afterward, the residue was submerged in reagent-grade hexanes. The mixture was stored at −35° C. for up to 5 hours, and subsequently, the solvent was decanted. Dry toluene (30 mL) was added to the vessel, and the mixture was heated to 80° C. Triethylamine (0.651 mL, 4.675 mmol) was added dropwise with stirring. After 40 minutes, boron trifluoride dimethyletherate (0.336 mL, 2.725 mmol) was added, and the solution was stirred for an additional 1 hr. The solution was transferred to a separatory funnel and washed with brine. Afterwards, the solution was dried over sodium sulfate and concentrated in vacuo. The material was purified by flash chromatography (100% toluene R_{f}=0.5). A second flash chromatography purification step (5% ethyl acetate in hexanes' R_{f}=0.4) was performed to obtain 57.95 mg (0.191 mmol, 10.8%) of Compound 14 an orange solid. ¹H NMR (500 MHZ, CDCl₃) 67 6.06 (s,2H), 5.94 (ddt, J=17,10,6.5 Hz, 1H), 5.16 (app d, J=17 Hz, 1H), 5.10 (app d, J=10 Hz, 1H), 3.07-3.03 (m,2H), 2.52 (s, 6H), 2.41-2.34 (m,2H); ¹³C NMR (126 MHZ, CDCl₃) 8 154.1, 145.5, 140.5, 136.6, 131.5, 121.8, 115.8, 35.4, 27.2, 16.4, 14.6 (t, JC-F=2.5 Hz).

Synthesis of BODIPY-labeled G2 catalyst. Step 1: The Grubbs generation 2 catalyst (G2, 4.0 mg, 4.7x 10-6 mol) was mixed with Compound 14 (6.0 mg, ˜2.0×10⁻⁵ mol) in 1 mL toluene/CH₂Cl₂ mixture (1/1 v/v) for 48 h under N₂ protection. Even though a mixture of products including Rul and Ru2 is expected, Rul is known to dominate among the Ru-containing species (˜65%)+5 because the formation of the gaseous ethylene drives the consumption of Ru2 (to form either Rul or back to the original G2). From the ¹HNMR, the sp² carbene a-proton on Ru-CH in G2 shows up at ˜19.6 ppm, while no apparent peak is seen after the reaction. Only one relevant peak at ˜18.4 ppm (singlet) is observed from the product mixture, and we assign it to Rul because a doublet is expected for a terminal alkene group in Ru2. Judging from the ˜10:1 signal to noise ratio based on the peak height, >90% of the G2 is converted to Rul. Therefore, we used the product mixture of Step 1 for the next step without further purification because the <10% Ru2, if it were there, will not be visible under fluorescence microscopy.

Immobilization of labeled G2 on magnetic marker particles. The BODIPY-labeled G2 catalyst is immobilized on the surface of the ˜200 nm silica coated magnetic beads (Super Mag Silica Beads, SS0202, Ocean NanoTech). The 200-nm diameter is suitable for the total internal reflection fluorescence imaging condition, where the evanescent field can penetrate to ˜200 nm. The magnetic property allows for facile handling (washing the particles by clean solvents and separation them from the liquid) inside a glovebox. The silica surface is suitable the installation of the G2 catalyst using silane chemistry.

Step 2: 50 μL of the magnetic bead suspension (containing ˜ 4×10⁻¹⁴ mol of particles) was washed with acetone 3 times, then resuspended in ˜0.1 mL of acetone, mixed with ˜4×10⁻⁹ mol of [(5-bicyclo[2.2.1 ]hept-2-enyl)ethyl]trimethoxysilane ('norbornene-silane', SIB0988.0, Gelest Inc.) in ˜0.1 mL acetone. The mixture was sonicated for 5 min (min=minute(s)) and then left undisturbed for 48 h. The particles were washed with acetone 3 times, dried in air, then dried in vacuum.

Step 3: The product from Step 1 was diluted by 500 fold in CH₂Cl₂, then 2 μL of the diluted solution (containing ˜2.0×10⁻¹¹ mol Ru species) was mixed with the particles from Step 2. The mixture was left in dark for over 48 h. Afterwards, the particles were washed by 0.5 mL of toluene for 3 times, then by 0.5 mL of CH₂Cl₂ for 3 times, and finally by 0.5 mL of pre-photobleached CH₂Cl₂ for 3 times to remove undesired fluorescent species (FIG. 5e). The particles were dried for storage under N₂ before use.

The number of Ru catalysts on each marker particle and their locations can be determined via single-molecule fluorescence imaging, after the particles are introduced into the reaction flow cell. The catalyst loading on the particles synthesized according to the procedure above typically ranges from 0 to ˜7 per particle.

Reaction and imaging scheme. The mechanism of the chain propagation step of ROMP³² is shown in FIG. 5a.

Single-molecule fluorescence image analysis. The data analysis pipeline comprises six main modules. Each of these modules are briefly discussed in the following sections.

Step 1: iqPALM. The fluorescence movies obtained by using CREATS for single-molecule super-resolution imaging of ROMP at various monomer concentrations for both homopolymerization and copolymerization were analyzed using a home-written MATLAB program, iqPALM (image-based quantitative photo-activated localization microscopy). Briefly, in each fluorescent image, the pixels with an intensity value larger than the mean pixel intensity plus six standard deviations were identified as potential single molecule fluorescence signals. Next, a 11×11 pixel2 area (each pixel is ˜267 nm) centered at each selected pixel was fitted with a two-dimensional Gaussian point spread function (PSF) to determine the centroid position (x₀, y₀) of each fluorescent product molecule. Such fitting also yields the standard deviation (σₓ, σ_{y}, which quantify the PSF width) and the integrated intensity of the PSF, as well as the localization error (Err», Err) of the centroid position.

Step 2: Fluorescence filtering. Candidate events with their PSF σₓ or σ_{y}<100 nm are rejected because these are representative of “hot” pixels since their PSF are too narrow for a single-molecule event (the ideal, theoretical σₓ, σ_{y} of the diffraction-limited PSF of a BODIPY dye is ˜150 nm). Next, candidate events with their PSF width greater than 100 nm and less than a filter threshold value (σ_{filter}, usually ˜500 nm) are selected as single-molecule events.

Step 3: Drift correction. Drift correction was necessary to handle the stage drift during the imaging time. Nanodiamonds were used as position markers and they could be localized in every frame. Each imaging cycle typically consists of 100 frames in 10 s. It was assumed the drifting in 10 s is negligible compared with the localization error. Therefore, all frames from each cycle were averaged to generate the averaged frame “AF”. The localizations of >4 position markers were determined from each AF and compared with their corresponding localizations in the first AF in the experiment to obtain the drift distances for each position marker. The drift distances from multiple position markers in each cycle were averaged to give the average drift distance for that cycle, and this average drift distance is applied to correct the localizations of all candidate events in each frame in that cycle.

Step 4: OM-SEM correlation. First, symmetrically shaped objects that are visible in both the optical microscopy (OM) image and SEM image were selected to establish the OM-SEM correlation. Those symmetrically shaped position markers are typically small Au nanoparticles instead of silica-coated magnetic particles modified with Grubbs catalysts. Intensity-weighted centroids of each position marker that is present in both the OM and SEM images were calculated, and these centroids were used to establish a transformation relation from the SEM image to the OM image. Such transformation involves both translational and rotational moves. Therefore, the overlay error has contributions from both translational error and rotational error and is generally about 24 nm, which is comparable to our single-molecule fluorescence localization error (˜23 nm). The error of the overall overlay procedure has contributions from the error single-molecule localization, the SEM resolution, and the overlay error, and it ˜39 nm. Next, we performed edge detection on the SEM image using the MATLAB build-in function (“edge, ‘canny’, [0.2, 0.7]”) to generate the contour of the silica-coated magnetic particles. The spatial coordinates of this contour was first expanded by 267 nm (the pixel size of the imaging camera) and then mapped onto the OM image; the purpose of expanding the particle contour was to ensure that the boundary is comfortably large enough to confidently include all the candidate fluorescence bursts from reacted monomers, and reduce the potential interferences of noises or drifting that might lead to undercounting reacted monomers. The convex hull of these magenta squares was then generated to produce the final magnetic particle boundary that was used to distinguish between on-particle and off-particle events.

Step 5a: Space-time filtering. Based on the final contour of magnetic particle determined, we used MATALB built-in function, “inpolygon”, to select the drift-corrected candidate events that occur on the particle, termed on-particle events. Next, based on the timing and location of these on-particles events during each imaging cycle (100 frames), we determined which events correspond to single monomer insertions within a single polymer chain. Briefly, the first-frame events (i.e., the first image frame after the photo-uncaging in each imaging cycle) were selected, which were considered newly inserted, just uncaged monomers after the previous imaging-bleaching cycle, and registered their locations within each imaging cycle that consists of 100 frames (see, e.g., solid dots in FIGS. 2e/2i). Counting first-frame events per unit time gives the reaction rate. The subsequent events that occur i) within a distance of 100 nm (about 2× of the FWHM of the monomer position distribution range near a catalyst from the first-frame events and ii) immediately following the first-frame events are deemed to represent the same uncaged monomer prior to photobleaching. From these selected events within the same imaging cycle, we determined tau_on (τₒₙ) distributions and photobleaching time (FIGS. 8a-j). Among different imaging cycles, the locations of their respective first-frame events were further compared to determine if these cycles were from the same single polymer chain. If the first-frame events across different imaging cycles occur within a distance of 100 nm, they were considered different monomers within the same single polymer, which was further corroborated by our labeled-catalyst imaging experiments. The timings and locations of these events were recorded for single-polymer kinetics/dynamics analysis at the single-monomer resolution.

Step 5b: Catalyst localization. The localizations of the dye-labeled catalysts were done in parallel to the localization analysis of reacted monomers since Step 1. For marker particles (diameter ˜200 nm) that carry multiple catalysts, the pair-wise distance between catalysts were below the diffraction limit. In addition, the movies in which the dye-labeled catalysts were imaged before they photobleached tended to be nosier than the ones that monitored polymerization reactions, likely because the dyes or other fluorescent impurities from the synthesis of the labeled-catalyst still remained after extensive washing. Therefore, an additional step was taken to localize the labeled catalysts: each frame of the original movie was subtracted by its immediate subsequent frame to generate a new set of “subtracted movie”, where the Frame k in the “subtracted movie” is generated from Frame k minus Frame (k +1). If a labeled catalyst photobleaches from Frame n to n+1 in the original movie, the fluorescence signal will appear clearly in Frame n in the “subtracted movie” with the noises removed. If a marker particle only carried one catalyst, Frame 1 to Frame n in the original movie can all be subtracted by Frame (n+1), giving n frames in which the catalyst can be localized. If a marker particle carried multiple catalysts, each of the catalysts can be localized in (n−m) frames from subtracting Frame m+1 (m n) to Frame n each by Frame (n +1), in which Frame m is the last frame before the previous photobleaching event (i.e., photobleaching occurs from Frame m to m+1); e.g., for the most short-lived catalyst, m 1. The subtracted frames were used as the input and followed the rest of the data analysis procedure (Step 1-4). Each catalyst could be determined in a few frames as described (open circles in FIG. 2a), so these frames were averaged for PSF fitting to get more accurate positions (star in FIG. 2a). The localizations of the catalysts and reacted monomers were in proximity as expected.

Kinetics dynamics analysis. The remaining steps of data analysis in deriving single polymer growth kinetics and dynamics are described in the main text. Treatment of copolymerization sequences is discussed below.

Additional results and discussion. Polymerization studies at the bulk level. Monomer with a short spacer lacks ROMP reactivity. We attempted ROMP of Compound 5 with G2 in the bulk level at room temperature and followed the reaction by ¹HNMR in situ on a Varian Mercury-400 NMR spectrometer. An NMR tube containing 0.6 mL of 5 (15 mM) in CDCl₃ was capped with a septum and wrapped with parafilm and inserted into the NMR instrument. NMR spectra of the samples were obtained. After that, as-prepared G2 solution in CDCl₃ was added into this NMR tube so that the final concentration of G2 was 0.15 mM. The sample was shaken and quickly re-inserted into the instrument. Spectra were recorded every 5 minutes for a period of ˜30 min with the sample staying in the instrument. The NMR spectra of polymerization of monomer 5 at different times were obtained. The peak at 6.14 ppm and 5.81 ppm (C═C double bond in norbornene) didn't change during the period. Even at 12 h after the addition of catalysts, the NMR spectrum of monomers didn't change apparently. Therefore, Compound 5 does not have apparent reactivity toward ROMP with G2 at room temperature.

The lack of reactivity of Compound 5, compared to monomer A, is attributed to that the 3-atom-long spacer between norbornene and the fluorophore is too short to alleviate the steric effect of the fluorophore.

Bulk polymerization shows that monomer A is reactive for ROMP and its endo:exo isomer reactivity ratio is ˜0.6:1. ROMP activity for monomer A catalyzed by G2 was investigated by in situ NMR experiments which were performed on an INOVA 500 instrument. A mixture of monomer A (mixture of endo and exo, 2.5 mM) and mesitylene (˜0.85 mM) in

CDCl₃ was transferred into an NMR tube. After adding the catalyst (<0.025 mM, monomer/catalyst >100) into the NMR tube, the tube was then capped with septa and wrapped with parafilm. The sample was shaken and quickly inserted into the instrument. Spectra were recorded every 10 minutes for 3 hours with the sample left in the instrument at constant temperature for the duration of the experiment. After the experiment, the polymerization was terminated by the addition of ethyl vinyl ether. Concentrations of monomer A were monitored by comparing the resonance for the protons attached to the strained double bond (δ 6.08 ppm for exo-compound, 6.15 ppm for endo-compound) to the internal standard signal (δ 6.80 ppm for mesitylene group).

It can be clearly seen from the spectra that monomer A could be successfully polymerized by G2 in the bulk experiment. The monomer (both exo- and endo- ones) conversion with different polymerization time were calculated. After a period of 1 h, the exo-monomer conversion is about 60%, and it reaches as high as 90% after 2 h of polymerization. Linear fit of the conversions within the first hour gives initial rates as slops of 0.0053±0.0004 and 0.0083±0.0015 for endo- and exo-monomers, respectively, showing the endo:exo isomer reactivity ratio is ˜0.6:1. Note that these apparent reaction rates contain contributions from both catalyst initiation and chain propagation reactions.

After polymerization, the product using THE as solvent were characterized through gel permeation chromatography. The number average molecular weight (Mn) and polydispersity index (PDI) were determined as 13,900 g/mol (22 repeating units) and 2.36, respectively. Photophysical properties of monomers and catalyst label. Caging-induced fluorescence quenching for monomer B and C: on-off ratio of 23 and 5.9, respectively. The uncaging of monomer B and C are clear from the time-dependent fluorescence spectra after periods of uncaging by 375 nm light (FIGS. 6a-b). The fluorescence emission intensity ratios of uncaged vs. caged monomer B and Care ˜23 and 5.9, respectively (FIGS. 6a-b, inset). Due to the low fluorescence on-off ratio, monomer C is not further studied.

Uncaging efficiency under polymerization imaging conditions is 77-80% per cycle (and 96.0% and 94.7% in two cycles), while the imaging time in each cycle ensures complete photobleaching of uncaged monomer A control experiment is designed to explore the 375 nm illumination conditions (intensity and duration) for complete uncaging of monomer A (and B) in 1˜2 cycles (FIG. 7a). Uncaging test of monomers was carried out in the same setup as in the polymerization imaging experiment, where the fluorescence of the uncaged monomers was excited by ˜33 mW (over an area of 0.015 mm²) of 488 nm laser for A or 12.9 mW (over an area of 0.015 mm²) of 532 nm laser for B, except that a fixed amount of solvent n-hexane stays in the reaction flow cell in this experiment instead of a constant supply of monomer solution in the polymerization imaging. A solution (˜2 μL) containing ˜10⁻¹⁴ molar of monomer A (or B) and ˜10⁻³ molar of poly(methyl methacrylate) (PMMA) in toluene was spin-coated on a quartz slide and dried, before the quartz slide was assembled into the corresponding flow cell, into which the solvent n-hexane was introduced. The embedding in PMMA was for immobilizing the monomers for imaging. The 488 nm illumination & imaging step in each cycle guarantees total photobleaching of the uncaged monomers within the same cycle.

The total intensity of the first frame in each imaging cycle represents the intensity of the just photouncaged monomers plus the background intensity; it decays as the cycle number until all monomers are photo-uncaged, imaged, and photobleached (FIG. 7b). At 1 s/cycle with 10 mW 375 nm laser, the exponential decay constant/of monomer A under this condition is 6.2±1.3 cycles, and that of monomer B is 6.8±1.0 cycles. Control experiments (FIG. 7b) show that keeping everything else the same, either tripling the 375 nm illumination time to 3 s per cycle or tripling the power of the 375 nm light to 30 mW can effectively decrease the exponential decay time constant to ˜2 cycles (˜1/3 of that in FIG. 3b). These results indicate that the 375 nm dosage effect is cumulative for the uncaging reaction. The uncaging condition in the polymerization imaging is 10 s/cycle under 10 mW 375 nm irradiation (i.e., 10 times of that in FIG. 7b; FIG. 1B), where the uncaging efficiency is expected to be (1−e^{-10/6.2})=80.1% for monomer A and (1−e^{-10/6.8})=77.0% for monomer B for each cycle, and will be 96.0% and 94.7% for two cycles. This uncaging efficiency ensures that for every inserted monomer, it will be uncaged, imaged, and photobleaching within 1-2 uncaging/imaging cycles.

Photobleaching efficiency of monomer A: 98.9% per cycle. The photobleaching kinetics of the uncaged monomer A can be measured in three methods below. All results (under the same 488 nm laser power density) are consistent.

Method I, photobleaching kinetics of monomer A was studied under typical polymerization imaging conditions (uncaging-imaging/photobleaching cycles for the caged monomer A, FIGS. 7d-e. In other words, each cycle in the polymerization imaging movie is treated as one photobleaching test. The total intensity of the field of view, consisting of the emission of monomers and the background, follows an exponential decay as the 488 nm laser irradiation time increases. The data is fitted by I=A+Be^{-x/t} according to the literature, where the decay constant/of a representative cycle is 1.8±0.1 s (FIGS. 7a-l), while a histogram of 720 similar cycles roughly follows a normal distribution with an average of 2.2±0.3 s (FIGS. 7a-l). Under such polymerization imaging conditions (10 s imaging time per cycle), the photobleaching efficiency per cycle is (1−e^{-10/2.2})=98.9%.

Method II, photobleaching of the uncaged monomer A immobilized in a PMMA matrix was studied by directly imaging the sample at 488 nm illumination (FIGS. 7f-g). Specifically, a solution (˜2 μL) containing ˜10⁻¹⁴ molar of monomer A and ˜10⁻³ molar of PMMA in toluene was spin-coated on a quartz slide, which was then assembled into a flow cell after the solvent evaporated. The measurement was done at the same conditions as the polymerization imaging, i.e., in hexane under N₂ protection. The total intensity of the field of view also decays exponentially with time, where decay constant/of 1.4±0.1 s is comparable to the results in Method I.

Method III, the single-molecule fluorescence on-time Ton was obtained from the polymer-growth analysis algorithm. Photobleaching efficiency of monomer B: 92.8% per cycle. Similarly, photobleaching of monomer B was studied under typical polymerization imaging conditions (FIGS. 7h-i). The total intensity follows an exponential decay as the 532 nm laser irradiation time increases. The exponential decay constant/of a representative cycle is 5.8±0.7 s (FIG. 7h), while a histogram of 130 similar cycles roughly follows a normal distribution with an average of 4±1 s (FIG. 7i). Under such polymerization imaging conditions, the photobleaching efficiency per cycle is (1−e^{-10/3.8})=92.8%.

Fluorescence photobleaching lifetime of labeled catalyst: 1.3 s. Similarly, the lifetime of dye-labeled catalysts was investigated through the total intensity of the field of view, which consisted of the emission of catalyst and the background. The intensity decreases exponentially with time with decay constant/of 1.3±0.1 s (FIG. 7j). This is consistent with the histogram of the lifetime extracted from the intensity trajectories of resolved single dye-labeled catalysts, which follows an exponential distribution with a time constant of 1.1±0.2 s. (FIG. 7k).

Intensity of single labeled-catalysts: 17±6 kcts. A PAINT experiment was conducted to estimate the intensity of single labeled-catalysts. Under N₂ protection, 0.48 nM of Compound 14, the dye that labels the G2 catalyst, in n-hexane was introduced into a flow cell. A movie of 500 frames at 100 ms/frame was recorded under 33.0 mW of 488 nm illumination over an area of 0.015 mm². Single-molecule detection of Compound 14 was achieved. The single-molecule intensity (FIG. 7l) of Compound 14 is (1.7±0.6)×10⁴ EMCCD counts, which is expected to also be the intensity range of the dye-labeled catalyst under similar imaging conditions. This range is consistent with the intensity steps in the trajectories of labeled catalysts (FIG. 2).

Control experiments and additional results on polymerization kinetics. SEM images of marker particles. FIGS. 8a-c) shows the SEM images of marker particles displayed in FIG. 2.

Distribution of microscopic reaction time during polymerization. The histogram of τ from 174 catalysts at [A]=0.1 μM (FIG. 8d) follows an exponential distribution with a time constant τ₀ of 0.48±0.02 h. The inverse of τ is ˜2.1 h⁻¹ catalyst⁻¹, consistent with the average TOF evaluated from counting the number of fluorescence bursts in a unit time.

Distribution of TOF. Distribution of TOF from the 174 catalysts at 2 nM of Monomer A follows a normal distribution (FIG. 8e) (FIGS. 8a-j), and the average is 0.14 +0.11 h⁻¹ catalyst⁻¹.

Calculation of dispersity. From the distribution of polymerization degrees (FIG. 8f) from 174 polymers and the molar mass of uncaged monomer A (632 g/mol), the dispersity can be calculated as follows: number average molar mass

$${M}_{n} = \frac{\sum {M}_{i} {n}_{i}}{\sum {n}_{i}} = 30309 ,$$

mass average molar mass

$${M}_{w} = \frac{\sum {M}_{i}^{2} {n}_{i}}{\sum {M}_{i} {n}_{i}} = 41292 ,$$

and dispersity Ð_{M}=M_{w}/Mₙ=1.36.

Marker particles without catalysts show negligible TOF. In a control experiment, 109 marker particles without catalysts were imaged for 2 h at 2 nM of Monomer A. The histogram of detected turnovers gives an average apparent TOF of 0.0092 h⁻¹ particle 1 (FIGS. 8a-j), trivial compared to the TOF of catalysts. Therefore, marker particles without catalysts show negligible detection of polymerization reactions.

Detection of fluorescence bursts outside marker particles. Some fluorescence bursts were detected outside marker particles, due to nonspecific adsorption of uncaged free monomers onto the slide or occasionally false detections induced by noise. Considering an area of 100 nm×100 nm, where 100 nm is about the twice of the 1-dimensional FWHM of detected events around a catalyst, the average detection frequency at 50 regions (typically 1˜3 μm², randomly picked from the open space around particles) are analyzed at 2 nM of monomer A (FIG. 8h), where the detection frequency scaled down proportionally to 100 nm×100 nm is 0.010±0.005 h⁻¹ in an area comparable to the cluster size around a catalyst.

Duration of fluorescence bursts on and off marker particles. The durations of fluorescence bursts (i.e., fluorescence on-time) during a typical polymerization imaging experiment within marker particles follow an exponential distribution with a time constant of 2.2±0.1 s (FIG. 8i), which is also the average fluorescence on-time. This average on-time is consistent with the fluorescence photobleaching time of independent control experiments of the monomers. The durations of fluorescence bursts outside marker particles are generally shorter (FIG. 8j), because the disappearance of fluorescence bursts can result from desorption of uncaged monomers or fluorescent impurities that physically adsorbed on the quartz slide. Such differences between fluorescence burst on times on and off marker particles indicate that the fluorescence bursts detected on marker particles mainly originate from uncaged monomers that were inserted into growing polymers.

Surface effects on polymerization kinetics. Method to evaluate the effects of PD on TOF. The relation of PD and TOF is challenging to access from ensemble measurements. In this work, we were able to correlate the microscopic monomer insertion time r before each monomer insertion (e.g., FIG. 2c) with the monomer index in the growth polymer. Since we tracked the polymerization right after introducing the monomer, the monomer reaction index on each single polymer chain is the PD. The scatter plot of microscopic monomer insertion time τ vs. PD was sorted into bins of equal distance in PD (an example is shown in (FIG. 9a), and the data in each bin were averaged. The inverse of the average τ reports the reaction rate, equivalent to TOF in the context of single-chain reactions on single catalysts. Consequently, the PD-TOF relation shown in FIG. 3e (and (FIG. 9b) was obtained.

Acceleration of surface ROMP saturates at ˜20˜400 nm. The global fitting of single-catalyst TOF vs. the polymerization degrees for monomer A with y=ax/(x+L_{1/2})+c gives L_{1/2}=270±50 monomers, which is the polymerization degree where the TOF is half-way toward saturation (FIG. 3e and (FIG. 9b). The average end-to-end distance R for a semiflexible polymer follows R=L₀N^{δ}, where L₀ is the Kuhn length, N is the number of repeating units, and δ is the scaling factor ranging from 0.5 to 1 depending on the goodness of the solvent relative to the polymer⁵⁰. The Kuhn length follows L₀=2p₀ for worm-like chain, where po is the persistence length, which is ˜0.71 nm for polynorbornene. Therefore, L_{1/2} of 270±50 monomers corresponds to an end-to-end distance of ˜20˜380 nm. Similarly, the fitted L_{1/2} for homopolymerization of B is 210±40 monomers (FIG. 10b), corresponding to an end-to-end distance of ˜20˜320 nm.

Limiting ROMP rates on or away a surface. For the global fitting of single-catalyst TOF vs. the polymerization degrees with y=ax /(x+L_{1/2})+c, when x approaches 0, y approaches c, corresponding to the limiting rate on the surface; when x approaches infinite, y approaches a+c, corresponding to the limiting rate at a distance sufficiently far away from the surface. Both limiting rates increase with the monomer concentration (FIGS. 9c and 10c: c scales linearly with monomer concentration, revealing the first-order kinetics of the limiting rate on the surface; a+c shows a pseudo-saturation behavior against [A], suggesting that far from the surface, the kinetics of ROMP will reach a maximum when [A] further increases. Interestingly, a+c is about two orders of magnitude larger than c, indicating the strong influence of surface on the ROMP kinetics.

First-order kinetics holds at fixed polymerization degrees (PD). Alternatively, to decouple the contribution of PD to the observed polymerization rate with regarding to the kinetics, we analyzed a titration experiment that was carried out in the order of increasing monomer concentrations over the same set of catalysts in the following way. The number of turnovers for a catalyst at a monomer concentration was determined. This number of turnovers was divided by the imaging time at this concentration to get the TOF value. The index of the last turnover at each concentration was used to represent PD: at the first monomer concentration, PD was equal to the number of turnovers (i.e., the index of the last turnover); at higher concentrations, PD was equal to the PD from the previous concentration plus new number of turnovers in the current concentration. The TOF vs. monomer concentration and PD (using monomer A as the representative; FIG. 9d) were plotted, which clearly showed that TOF increases when either monomer concentration or PD increases. We further segmented the 3-dimentional plot into 3 regions of PD; in each region of similar PD, the TOF increases linearly with the monomer concentration (FIGS. 9e-g), confirming that first-order kinetics still holds at fixed polymerization degrees.

Temporal dynamics of single-chain polymerization. No discernible temporal dynamics at low monomer concentrations. Unlike the case at [A]=0.1 μM (FIG. 3f) where temporal dynamics of monomer A polymerization is clearly identified in the exponential decay behavior of the autocorrelation function C_{τ}(m) of the microscopic reaction r, the autocorrelation function does not have discernible amplitude when the monomer concentration [A] is 0.03 μM or lower. In other words, the temporal dynamics of single-chain polymerizations only becomes significant when the monomer concentration is higher, where monomer binding to the catalyst becomes less rate-limiting and kinetics of the monomer insertion in the catalytic cycle contributes more to the overall rate-limiting step.

Potential origins of underlying dynamic processes for temporal dynamics. The temporal dynamics of single-chain ROMP kinetics might originate from (1) intra-chain monomer-monomer interactions, (2) the polymer-surface interaction dynamics, or (3) polymer conformation dynamics. At [A]=0.1 μM, the autocorrelation C_{τ}(m), averaged over many polymers, shows a clear exponential decay with a time constant of 2±1 turnovers (FIG. 3f), suggesting the neighboring monomer-monomer interactions. Moreover, with the average monomer insertion rate of 2.1 h⁻¹ catalysth⁻¹, this autocorrelation time constant would correspond to a correlation time of ˜1 h, which is likely too slow for (3) polymer conformational dynamics.

Additional results on homopolymerization kinetics of Monomer B. Duration of fluorescence bursts of monomer B is consistent with control experiments. The duration of fluorescence bursts (i.e., fluorescence on-time Ton) during a typical polymerization imaging experiment within marker particles follow an exponential distribution with a time constant of 3.3±0.1 s (FIGS. 10a-d), which is also the average fluorescence on-time. This average fluorescence on-time is comparable to the fluorescence photobleaching lifetime of independent control experiments of the monomer B where the photobleaching lifetime is 4±1 hgs (FIG. 7i).

Surface effects on ROMP kinetics are also observed for monomer B. Monomer B also shows a generally higher TOF at a larger polymerization degree (FIG. 10b). Through a similar analysis applied to monomer A, both limiting rates increase with the monomer concentration [B] (FIG. 10c): c scales linearly with [B], revealing the first-order kinetics of the limiting rate on the surface; a+c shows a pseudo-saturation behavior against [B].

Monomer B polymerization shows similar temporal dynamics at [B]=0.1 μM. Once averaged over 5 polymers that had ≥10 turnovers at [B]=0.1 μM, the autocorrelation function C_{τ}m) of the microscopic reaction time τ also shows an exponential decay behavior, with an amplitude of 0.20 +0.02 and time constant of 2±1 turnovers (FIG. 10d), comparable to those of monomer A. Likewise, such behavior is indiscernible from polymers grown at [B]=0.03 μM (FIG. 10d).

Additional analyses and discussions of copolymerization kinetics. Using reactivity ratios to predict the sequence architecture of linear copolymers. The two reactivity ratios, defined as r₁(=K_{AA}/k_{AB}, and here k_{AB} is the rate constant of an incoming monomer B reacting with a propagating chain that is currently ending with an inserted A; similar definitions for k_{AA}, K_{BA}, and k_{BB}) and r₂(=k_{BB}/K_{BA}), can be used to predict the type of copolymers consisting of monomer A and B, as formulated and discussed in detail by Grubbs and coworkers. Briefly, 1) when both r₁<<1 and r₂<<1, alternating copolymers will be obtained; 2) when r₁<<1 and r₂<<1, blocky copolymers will be obtained; 3) when both r1=1 and r2=1, random copolymers will be obtained; 4) when both r₁<1<r₂, gradient copolymers will be obtained. The sequence structures of the copolymers are typically analyzed by tracking the concentrations of the two monomers during polymerization by NMR and compare the monomer consumption patterns with simulation based on the rate constants and instant monomer concentrations.

Analysis of block size distribution and simulation of random copolymers.

TABLE 1
List of the sequence of 33 copolymers at equal concentrations of monomers (both 0.05
μM). Polymers No. 14, 24, 13, 5, 23, and 10 are displayed in this order in FIG. 4c.

| Index | Sequence |
|---|---|
| 1 | ABABABAAAAAABAAAAAAAAAAABAAAAAAAAAAAAABABAAAAAAAAAAAAAAAAAAAAAAAAAAAAA |
| | AAAAAAAAAAAAAAAAAAAAAAAABAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAABAAAAAAAABAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAABAABAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAABAAAABAAABAAAAAAAAAABAAAAAAAAAB |
| 2 | AAAAAAAAAABABABABABAABABABABABABABABABABABABABABABABABABABABABABABABAB |
| | ABABABABABAAABABABABABABABABABABABABABABABABABABABABABABABABABABABABAB |
| | ABABABABABABABABABABABABABABABABABABABABABABABABABABABABABABABABABABAB |
| | ABABABABABABABABABABABABABABABABABABABABABABABABABABABABABABABABABABAB |
| | ABABABABABABABABABABABABABABABABABABABABABABABABABABABABABABABABABABAB |
| | ABABABABABABABABABABABABABABABABABABABABABABABABABABABABABABABABABABAB |
| | ABABABABABABABABABABABABABABABABAABAABABABABABABAAAAAAAABAABAABAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAABAAAAAAAAAAAABAAAAAAAAAAAAAAAAAAABAABAAAAAAAAAAAAAAAAAAAAAA |
| | AAAAAAAAABAAABABABAAABAAAAAAAABABABABABAABABAAABABABAABABAABABABABAABA |
| | BAB |
| 3 | BBABBBABBBBBBBBBBBBBAABBBBBBBBBBBBBBBBBBBBBBBBBBABBBBBBBBBBBBBBBABABBA |
| 4 | AAAABBBABABBABABBAABABBBBBBAABBABAABBBBBAABABBBABBABBBABAABBAABBBABABA |
| | BBABABAABAAABBBABABABAAAAAAAAAAAAABBAABAAABBAABABAAAAAAAABAAAAAAAAAAAA |
| | BAAAABAAAAAAAAAAAAAAAAAAAAAAAAAAAAAAAAAAAAAAAAAAAAAAAABAAAAABBAAAAAABB |
| | BAAAAAAAAAAAAAABAAABABB |
| 5 | BABBBBBBBBBBBBBBBBBBBBBBBBBBBBBBBBBBBBBBBBBBBBBBBABBBBBBBBBBBBBBBB |
| 6 | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAABAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAAAAAAAAAAAAAAAAAAAAAAAAAAAAAAAAAAAAAAAAAAAA |
| | AAAAAAAAAAAAAAAAAAAAAAAAAAAA |
| 7 | BBBBBABABBBBBBBBBBABBABABBBBABBBBBBBBABBBBBBBBBBBBABBABBBBBBBBBBBABBBB |
| | BBBABBBBBBBBBBBBBBBBBBBBBBBBBBBBBBBBABBBBBBBBABBBBBBBBBBBBBBBBBBBBBBBB |
| | BBBBBBBBABBBBBBBBBBBBBBBBBBBBBBBBBBBBBBBBBBBBBBBBBBBBBBBBBBBBBBBBBBBBB |
| | BBBBBBBBBBBABBBBBBBBBBBBBBBBBABBBBBBBBABBBBBBBBBBBBBBBBBBBBBBBBBBBBBBB |
| | ABBBBBBBABBBBBBBBBBBBBBBBBABBBBBBBBBBBBBBBBABBBBBBABBBBBBBBBABBBBBBBBB |
| | BBBBBBBBBBBBABABBBBBBBBB |
| 8 | BBBBBBBBABABBBBBBBBBBBBBABBBBBBBBBBBBBBBBABABABBBABBBBBBBABBBBBBBBBABB |
| | BBBBBBBBBBBBBABABBBBBBBBBBBBBBBBBBBABBBBBBBBBBBBBBBBBBBBBBBBBBBBBBBBBB |
| | BBBBBBBBBBBBBBBBBBBBBBBBBBBBBBBBABBBBBBBBBBBBBBBBABABBBBBBABBBBBBBBBBB |
| | ABBABBBBBBBBBBBBBABBBBBABBABBBBBBBBABBBBBBBBABBBBBBBBBBBBABBBBBBBBBBBA |
| | BBBBBBBBBBBBBBBBBBBABBBBBBBBBBBBBBBBBBBBBABBBBBBBBBBBBBBBBBBBBBABBBBBB |
| | BBBBBBBBBBBBBBBBBBBBBBBBBBBBBBBBBBBBBBBBBBBBBBBBBBBBBBBBBBBABBBBBBBBBB |
| | BBBBBBBBBBBBBBABBBBBBBBBBBBBBBBBBBBBBBBBBBBBBBBBBBBBBBBBB |
| 9 | BBABBBBBBBABBBBABBBABBBBBBBBBAABBBBBABABBBBBBBBBBABABBBBB |
| 10 | BAABBAAABBBABABABABBAAABAAAAAAAAAAAAAAAAAAAAAABAAABABAAAAAAAAAAAAAAAAA |
| | AAAAAAAAAAAAAAAAABAABAAAAA |
| 11 | BBBABBBBABBBBBBBBBBBBBBBBBBBBBBBBBBBBBBBBBBBBBBBBBBABBBBBBBBBBBBBBBBBB |
| | BBBBBBBBBBBBBBBBBBBBBBBBBBBBBBBBBBBBBBBBBBBBBBBBBBBBBABBABBABBBBBBBBBB |
| | BABBBABBBBBBBBABBABBBBBBBABBABBABBBBBBBBBBBBBBABBABBBBBBBBAABBBBBBAABB |
| | BBBBBBBBABBBBBBBBBAABBBBBBBBBABBBBBBBBBABBBABBBBB |
| 12 | BBBBBBBBBBBAABBBBBBBBBBBBBBBBBBBBBBBBBBBBBBBBABBABBBBBBBBBBBBBBBBBABBB |
| | BBABABBBBBBBABBBBBBBBBBBBBBBBABBBBBBBBBBBBBBBBBBBABBBBBBABBBBBBBBBBABB |
| | BBBABBABBBBBBABBBBBBBBBBBBBBBBBBBBBBBBBBBBABBBBBBBBBBBBBBBBBBBBBBBABBA |
| | BBBBBBBBBBBBBBBABBBBBBABBBBBBBBBABBBBBBBBBBBBBBBBBBBBBBABABBBBBBBAABBB |
| | BABBBBBBBBBABBBBABBBBBBABABBABABBABBBBBBBBBBBABBBBBBBBBBBBBBABBBBBBBBA |
| | BBBBBBBBBBBBBBBBBBBBBBBBABBBBBBABABBBABBBBBBABBBBBBBBBBBBBB |
| 13 | ABABBAAAAAAAAABAABAABBAAAABBABBBAAABAABABAAAABAAAABAAAB |
| 14 | BAABBBBAABBBBBBAAAABABABBBAAAABBBABABBABAAAAAABBBAABBABAAAAABBA |
| 15 | AABBBBBBABBBBBBBBBABBBBBBBBBABBBBBBBBBBBBBBBBBBBBBBBBBBBBBBABBBABBBBBB |
| | BABBBBBBBBBBBBBBBABBBBBBBBABBBBBBBBBBABBBBBBBBABBBBBBBBBBBBBBBBBBBBBBB |
| | BBBBABBBABBBBBBBBBBBBBBBABBBBBBBBBBBBBBBBBBBBBABBBBBBBBBBBBABBBBABBBBB |
| | BBABBBBABBABABAABBBBABBABABBBBBBBBBABBBBBABBBBBBBBBBBBABBBBBBBABBBBBBB |
| | BBBBABBBBBBBBAABBBBBBABABBBBBBBBBBBBBBBBBBBBBBBBABBBBBABBBBBBBBABBBBBB |
| | BBBBBBBBBBBBBBBBBBBBBBBAABBBBBBBBBBBBBBBBBBBBBBBBBBBBBBBB |
| 16 | AAAAAAAAAAAAAAAAAAAAAAAAAAABAAABBBAAABBBAABABBABABBABBABBBBBABABBABBBA |
| | ABABABBABAABAABAAABAAAABAABABAABBAAAAABABAAAAAAAAAAAAAAAAAAAAABAAABBBB |
| | BABABABAAAAAAABBABBBBAAABAA |
| 17 | AAAAAAAAAAAAAAAAAAAAAAAAAAAAAAAAAAAAAAAAAAAAAAAAAAAAAAAAAAAAAAAAABAA |
| 18 | BBBBBBBBBBBBBBBBBBBBBBBBABBBBABAAB |
| 19 | BABBBBBBBBAAAAAABBAABBBBABBABBABABAABBBBBBBABBBBBBBBABBBAAAAABBABABBAA |
| | BBAABAABBBBBBABBBBBBBBABBBBABAB |
| 20 | AAAAAAAAAAAAAAAAAAABAAAAAAAAAAAABAAAAAAAAAAAAAAAABAAAAAAAAAAAAA |
| 21 | BBBBBBBBBBBBBBBBBBBBBBBBABBBBBBBBBBBBBBBBBBBBBBBBBBBBBBBBBBBBBBBBBBBAB |
| | BBBBBBBBBBBBBBBBBBBBBBBBBBBBBBBBBBBBBBBBBBBBABABBBBBBABBBBB |
| 22 | AAAAAAAAAAAABAAAABABBAAAAAAAAAAAAAAAAAAAAAAAAABAAAAAAAAAAAAAAAAAAAAAAA |
| | AAAABAAAAAAAAAA |
| 23 | BAAAABABABBABBBBBAABBAABBBBAABBAAABBABABBBBBAABBABAAAAAAAAAAAABBAAABBB |
| | BBBAABBBBBABBABBA |
| 24 | BBBBBBBABBBBABBBBBBABBABBBABABBABBAABAAAABAAABABA |
| 25 | ABABAABABABBBAABBBBBABBBBBBABBBBBABBBBBBBBBBBBABBBBBABBBBBBBBBBBBBBBBB |
| | ABBBBBBBAAABBABBAABAABBBABAABBAABABABBABBBBBBBABBABABBABBBBBBBBBBABBBB |
| | ABBBBBBBBBBBBBBBBBB |
| 26 | BABABABABAABABAAABAAABABAAAAABABAABABAAAAABAAABAAAABBAAAABABBBABBAABBA |
| | AAAAABAABBBABABBAAAAABBABABAABAABAAAAABBABBBBABBABABABBBAAABBBBABABAAA |
| | ABAABBBAABBBAAAAAAAAAAAABAAAAAAAAAAAAAAAAAAAAAAAABABABAAAAAAAAAAAAAAAA |
| | ABAAAAAAAAAAAAAAAAAAAAAABABBABAAAAAABAAAAAAAABABBABABBBAAAA |
| 27 | BBABBBBBABBBBBBBBBBBABBBBBBBBBBBBABBBAAAABAABABAAAAAAAAAAAABBBBABBABBB |
| | ABBBBBBBBBBBBBBBBAABBBBBABABBBBABAB |
| 28 | AAABAAAAAABBAAAAAAAAAAAAABAAAAAAABAAABAAAABAABAAAAAAABAAABAAAAAAAAAAAB |
| | AAABABAAAAAAAAAAAAAAAAAAAAAAAAAAAAAA |
| 29 | BAAAAABBAABABABAAABAABBABAAAAAAAABBABAABBAAAABBAABAABABABABBABAAAABAAA |
| | ABABBABAABABABAAABABABBABABAABBBBABAABAABBABBBBAAAABBABBABABABBBABAABB |
| | BABABBBABABABBAAABABABBABABBAABAABBBBBBAABABBAABAAAABABABABAAABAABBBAB |
| | BABABABBABBAABBBABABBABABBABBABB |
| 30 | BAABABAAABAABABAAAAAAABAAAAABAAABBAAAABAABABAABAAAAABAAAAAAAB |
| 31 | ABBABBBBABBBBBBBBBBBBBBABBBABBBBABBBABBBBABBABBABBABABBAABABABBBBAABAB |
| | AABAABBBBBABBBBBBBBBBBBBABAABBBBBABBBBBBBBBBBBBBBBBBBBBBBBBBBBBBABBBBB |
| | BBABBABBBBABABABBBBBBBBBABBABBBABBBBBBBBBBBBBBABBAABBABBBBBAABBBABAAB |
| 32 | AABBAAAABBAAAAABBABABAABABBABAAABABBBABBABAAAAAAABABBABABABAAABBBAABBB |
| | ABABBABABABBBABAABBABBBBBABABABBBABAAAAAABBABABABBAAAABABAABABAAAABABA |
| | BBAAABABAABAAAABAAABAABAABBAAAAABAAABABABAAABABABBAAABABAAAAABBABAABAB |
| | ABABAABAAAAAAABAAABAAAAAAAAABABAABAAABAAABAABAABBABAABAAAAAABABAAAAAAB |
| | ABABABABABAABAAABAABAABABAABAAAAABBAABABAABAAABABABBABABAAABAAABABAABA |
| | AABAAABAABAABAAAABAABABAABABBBBABABAAAAAAAABAABBAABAAAAAAAAAAAABABAAAA |
| | BAAABABABAAABAAABABAAAAAAAAABBABAABAAA |
| 33 | BBBBABBAAAABABBBAABBBBBBBBABBBBBABBBABBBBBBBBABABBBBABBBBBBBBBABBBBBBB |
| | BABBABBBBABABBABBABBBBBBABABBBBBABABBBABBBABBBBAAABABBAABBBABBBBBBABBB |
| | BABBBBABBBABABBBBABBBBABBBBBBBBABBBBBBBBABABBBBBBBBBABABABBBBBBABAABBB |
| | BBBAAABAAAABAABBBBBBBBBABBBABABBABBBBABBBABBBBBBABBBBBBBABBABBAB |

Our block size distribution analysis counts the longest block of the same monomer once without repetitive counting of shorter blocks within. For example, a copolymer “AAABBAAAABB” will count as 1 of “block of 3 for A”, 2 of “block of 2 for B”, and 1 “block of 4 for A”, and will not count any smaller blocks. Converting to the number of monomers in the corresponding block size, “block of 3 for A” has 3 counts, “block of 2 for B”, has 4 counts, and “block of 4 for A” has 4 counts. As such, the sum of these counts, which is the total number of monomers, is naturally equal to the length of the copolymer.

Even random copolymers should contain segments with the same monomer, and these segments (i.e., blocks) should be dispersed in length. At 1:1 ratio of copolymerization, and if the copolymerization is completely random, the probability for a continuous block of length x of any monomer should be (1/2)^{x}. The probability for the total number of monomers in a block size x should then scales with x(1/2(^{x}, i.e., x/2^{x}. To compare with our experimental re)sults, we simulated the sequence of random

copolymers to compare with the experimental results. Since monomer A and B show comparable polymerization rate constants, to compare with the copolymers synthesized at equal concentrations of monomer A and B, the simulation was performed in the following way: in one set of simulation, a (a is equal to the number of copolymers) sets of random number ranging from 0 to 1 were generated, where the size of each set is equal to the number of monomers in each experimentally sequenced copolymer. Random numbers smaller than 0.5 is marked as monomer A, while those greater than 0.5 as monomer B. In other words, in one set of simulation, the identity of each monomer in the whole set of sequenced copolymers is replaced by a randomly determined identity A or B with 0.5 probably for each choice. Then this set of “simulated copolymers” is used for block size distribution analysis in the same way as the experimental data. Such simulation can be repeated multiple times to approach the mathematical expectation for comparison with the experimental results. The distribution of the blocks of the simulated random copolymers follows the (1/2)^{x} distribution as expected. Moreover, the distribution of the total number of monomers in each block size follows the expected x/2^{x} distribution as well; both supporting the reliability of our simulations.

Extracting conditional probability from experimental and simulation data. The conditional probability shown in FIG. 4 is evaluated in the following way. The probability of A (or B) is computed from the counts of A (or B) divided by the sum of A and B. Other probabilities are conditional probabilities that only evaluate the last element assuming all the previous elements are satisfied. For example, the conditional probability of “AAA” is equal to (No. of “AAA”)/(No. of “AAA”+No. of “AAB”). The entire sample is examined for calculating the conditional probability of each block. For example, for the copolymer “AAABBAAAABB”, P_{AA}=5/7 (with 7 occurrences of A, 5 are followed by another A), P_{AB}=2/7, P_{AAA}=3/5=1−P_{AAB}, P_{AAAA}=1/3. For this exemplary copolymer, the condition of evaluating PBBBB is not satisfied since no “BBB” block exists, but PBBBB is still treated as 0 for simplicity for statistics in analyzing experimental or simulation data.

The simulation data on random copolymers are obtained in the same way as described in the former section. The simulation is repeated multiple times to reach statistical saturation and obtain statistical errors. In fact, the mathematical expectation is 0.5 for the conditional probabilities of all blocks for completely random copolymers, because the conditional probabilities only evaluate the odds of the last element. For this reason, it is useful to use P_{XX}=P_{AA∥BB} to evaluate the tendency of block formation instead of using PAA or PBB alone.

The conditional probability analysis can also evaluate the tendency of forming alternating copolymers by calculating P_{XY}=P_{AB∥BA} Or P_{XYXY}−P_{ABAB∥BABA}, whose information is not in the block size distribution analysis. Since the copolymers sequenced in this work are blocky (P_{XX}>0.5), it is reasonable that they are less likely to have alternating features (P_{XY}<0.5).

Example of analyzing the conditional probability of continuous blocks of Copolymer No. 14. “BAABBBBAABBBBBBAAAABABABBBAAAABBBABABBABAAAAAABBBAABBAB AAAAABBA”. In this polymer, the longest continuous block is 6A (1 count) and 6B (1 count). For calculating P_{6X}, the numerator is 1+1 (No. of 6A +No. of 6B), and the denominator is 1+1+2+1 (No. of 6A +No. of 6B +No. of AAAAAB +No. of BBBBBA), so P_{6X}=2/5=0.4. There is no 7A or 7B, but the condition of calculating P_{7X} is satisfied, so P_{7X}=0. The condition of calculating Pxx is not fulfilled, so it is not meaningful and excluded from the statistics. The conditional probabilities up to the longest block, Pex for this copolymer, are used for data averaging within the set of 33 copolymers to obtain the results shown in FIG. 4j. The simulated sequences are treated in the same way as the experimental data, and average results from 1000 sets of simulations are plotted in FIG. 4j.

Autocorrelation analysis of digitized copolymer sequence. Autocorrelation measures the relationship between a variable's current value and its past values. It is useful to evaluate the autocorrelation of the experimentally determined sequences. In doing so, the identities of monomers were digitized, for example, A is assigned as 0 and B as 1. It is worth noting that the choice of this binary numerical values does not affect the results of the autocorrelation analysis.

The autocorrelation function of digitalized copolymer sequences shows an exponential decay with a decay constant of 4±3 subunits, indicating a sequence memory that is consistent with the half saturation point (i.e., parameter b 1.1±0.1 subunits) of the conditional probability (FIG. 4j). Moreover, this sequence memory is comparable to the temporal memory of 2.1±1.3 turnovers in real-time polymerization kinetics (FIG. 3f), suggesting that such sequence block pattern originates from interactions between neighboring monomer insertion events.

### EXAMPLE 2

The following are examples of methods of polymer sequencing and/or imaging and systems for polymer sequencing and/or imaging.

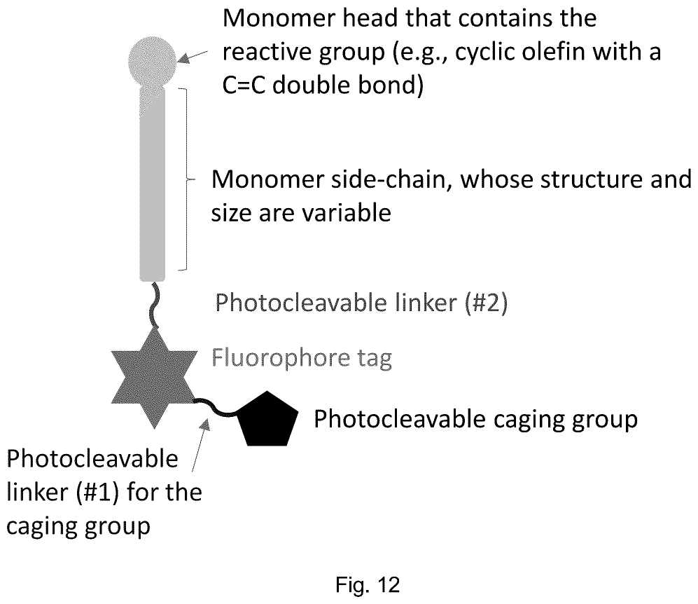

A general design of monomers used in CREATS imaging and sequencing of synthetic polymers is shown in FIG. 12.

A general design of monomer used for implementing CREATS imaging and sequencing of synthetic copolymers included the following, as shown in FIG. 12.

I. A monomer for polymerization can be further divided into two parts. One, the head of monomer, which contains a reactive group that undergoes polymerization chemistry. Examples include: internal C═C double bond within a cyclic olefin for ring opening metathesis polymerization, like norbornene, as shown FIG. 14a, and terminal C═C double of a linear olefin, for living anionic or cationic polymerization (FIG. 14a). The side chain of the monomer, whose structure and size are highly variable. Examples could be linear side chains as shown in the monomers in FIG. 14a, or dendronized side chains as in references, or other types of structures or sizes.

II. A fluorophore that is linked to a monomer side chain (or to the head group directly), where the linkage could be a photocleavable (i.e., photocleavable linker #2). This fluorophore could be an integral part of the monomer or considered a tag (i.e., an addition). The fluorophore can emit different wavelengths of fluorescence to be differentiable through imaging, as we demonstrated in the manuscript. A variety of fluorophores are available, such as BODIPY-based or fluorescein-based.

III. A photocleavable caging group that quenches the fluorescence of the fluorophore tag. Examples are include using a nitrobenzyl caging group, which quenches the fluorescence of BODIPY fluorophores and can be photocleaved (i.e., “uncaging”) to restore the fluorescence of BODIPY. Nitrobenzyl caging on fluorescein-based fluorophores has also been demonstrated.

IV. Another photocleavable linker (II) may be added between the monomer and the fluorophore tag to remove the tag after polymerization. Besides the nitrobenzyl photocleavable group, other types of photocleavable linkages are available, such as, for example, coumarin conjugates, RuBEP photolinker, α-thioacetophenone-type linker, and 3-acetyl-9-ethyl-6-methylcarbazole (AEMC) moiety linker with substitutions at both the phenacyl and benzylic positions with different carboxylic acids. Some of these linkers can be photocleaved at different light wavelengths, offering orthogonal photocleavage. Note this cleavable group could also be chemically cleavable, instead of photocleavable, although photocleavable is preferred as it is likely faster and has no need to introduce new chemical reagents into the reaction.

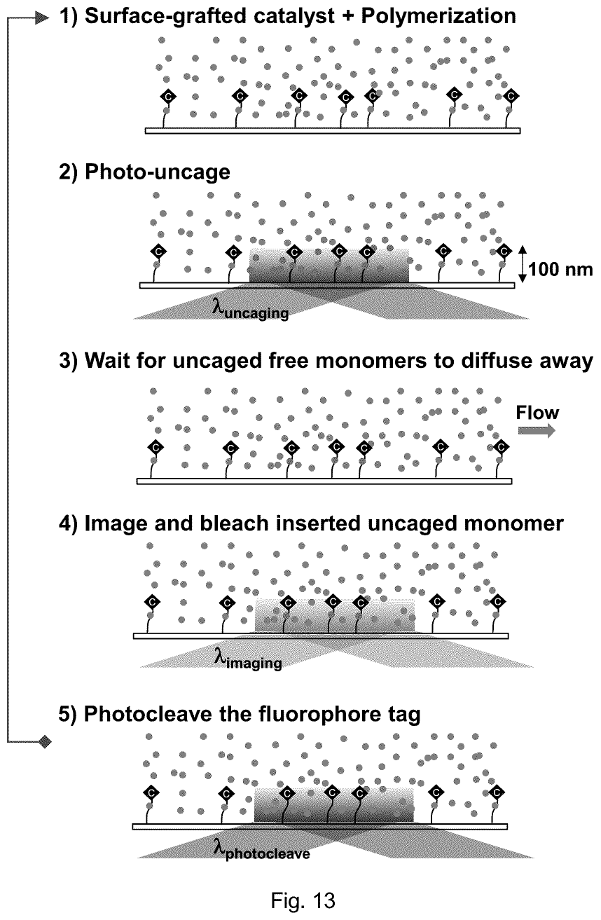

General imaging process for CREATS imaging and sequencing. A general imaging process is shown in FIG. 13. In various examples, one or more or all of steps 1) -5) in FIG. 13 are repeated in any desired order and/or a desired number of times.

First, catalysts were immobilized on the surface for surface-grafted polymerization reaction. Then the caged nonfluorescent monomer, which can be at high, relevant, concentration for polymerization, was supplied without causing undesirable background in the fluorescent images.

A laser, in total internal reflection (TIR) geometry (or epi-illumination geometry), was used to unphotocages inserted monomers on the surface, as well as some free monomers in solution.

Then waited a period of time for those uncaged monomers in solution to diffuse away (e.g., out of the TIR thin layer, which may be facilitated by a solution flow, but the polymerized monomers will stay).

Then the 2^{nd} laser was used o image the inserted monomers at the single-molecule level in the polymer, and eventually photobleach them. This imaging allows detection and localization of the position of the inserted monomer at nanometer precision.

A 3^{rd} laser was turned on to photocleave the fluorophore tag from the polymer, leaving the polymer without a tag.

Optionally, the process was repeated for imaging next monomer.

Generality of applying CREATS for other types of polymerization reactions. Besides norbornene-based cyclic olefins for ROMP, it can be applied to study other cyclic olefins as monomers, such as cyclooctene-based ones as well as macromonomers FIG. 14a.

Besides ring-opening metathesis polymerization, the methods are applicable to any chain-growth polymerization, including living anionic polymerization, living cationic polymerization, living free radical polymerization, and living chain-growth polycondensations: Living anionic polymerization. FIG. 14b shows the general mechanism of organolithium-initiated polymerization of styrene via living anionic polymerization. Here CREATS can be used to study the propagation of styrene-based polymerization, by immobilization of an organolithium initiator on the surface and tag styrene with a caged fluorophore. The caged fluorophore certainly needs to be designed to not interfere with the polymerization chemistry (same for the other polymerization chemistry below); Living cationic polymerization. FIG. 14c shows the general mechanism for styrene polymerization. Similarly, the propagation could be imaged by CREATS if we immobilize the ion-pair catalyst on the surface and tag the monomer styrene here. A variety of initiators (i.e., catalysts) were used for styrene-based polymerization, such as n-Bu₄NI, (CH₃)₂CHCH₂OCH(CH₃)Cl, (CH₃);CCH₂C(CH₃)₂Cl, etc .; and Living free radical polymerization. FIG. 14d shows a general mechanism for atom transfer radical polymerization (ATRP). After immobilization of an R-X species and tagging the monomer, the addition and propagation can be imaged via CREATS. The activation/deactivation step would cause a pause in the propagation of the polymer, and it could be avoided by removing the Cu^{Y}X/L species in the solution after the initiation.

Living chain-growth polycondensations. There is no universal mechanism for chain-growth polycondensations, but as long as polycondensation proceeds by a chain-growth mechanism, it is expected that CREATS will be able to study it. For example, polypeptide synthesis via living chain growth polycondensation could be studied, in which the amino group of amino acid monomer reacts with the terminal carboxylate moiety of another monomer could proceed in the chain propagation mechanism.

Besides polymerization chemistry, CREATS can be applied to other solution chemical reactions, such as cross-coupling reactions (e.g., Suzuki coupling), in which one can tag the reactants with caged-fluorophores.

Although the present disclosure has been described with respect to one or more particular embodiments and/or examples, it will be understood that other embodiments and/or examples of the present disclosure may be made without departing from the scope of the present disclosure.

1. A method of imaging a fluorescent polymerization product comprising a photo-uncaging reaction, wherein the photo-uncaging reaction produces a plurality of un-caged monomers, each un-caged monomer comprising a reactive group, and a fluorophore group;
a fluorogenic polymerization, wherein the fluorogenic polymerization comprises reaction of at least a portion of the plurality of the un-caged monomers to form one or more fluorescent polymerization product(s), and wherein each of the uncaged monomers reacts with a catalyst or a polymer chain disposed on a substrate; and
obtaining one or more fluorescence image(s), each fluorescent image comprising one or more of the fluorescent polymerization product(s), wherein a change or changes in the fluorescence image(s) is/are indicative of one or more feature(s) of the reacted un-caged monomer and/or the catalyst or the substrate.

2. The method of claim 1, wherein the substrate is a particle, a planar substrate, or a non-planar substrate.

3. The method of claim 1, wherein at least a portion of or all the un-caged monomers further comprise a side-chain group, wherein the fluorophore group is covalently bound to the monomer.

4. The method of claim 3, wherein the side-chain group does not substantially interfere with the fluorogenic polymerization.

5. The method of claim 1, wherein the plurality of uncaged monomers comprises at least two different uncaged monomers.

6. The method of claim 5, wherein the at least two different uncaged monomers are different in terms of fluorescence emission.

7. The method of claim 1, the method further comprising, prior to the photo-uncaging reaction, providing a mixture comprising a plurality of caged monomers, each caged monomer comprising a reactive group, a fluorophore group, and a photocleavable caging group.

8. The method of claim 6, wherein all the caged monomers present in the mixture comprise a fluorophore group.

9. The method of claim 8, wherein the un-caged monomer(s) is/are present at a concentration of less than about 10⁻⁹M.

10. The method of claim 1, the method further comprising, after the fluorogenic reaction and prior to the obtaining the fluorescence image(s), waiting a period of time sufficient for substantially all the unreacted uncaged monomers to diffuse or be removed from proximity to the reacted uncaged monomer(s).

11. The method of claim 1, wherein at least a portion of or all the fluorescence image(s) is/are single-molecule localization microscopy image(s).

12. The method of claim 1, wherein two or more fluorescence images are obtained using different wavelengths.

13. The method of claim 1, the method further comprising substantially or completely bleaching the fluorophore.

14. The method according to claim 13, wherein the obtaining the one or more fluorescent image(s) results in bleaching of substantially all or all the fluorophore(s).

15. The method of claim 1, the method further comprising repeating the photo-uncaging reaction, the fluorogenic polymerization, or the obtaining one or more fluorescence image(s), or any combination thereof a desired number of times.

16. The method of claim 1, the method further comprising photocleaving the fluorophore group(s) from substantially all or all the product of the reaction of the un-caged monomer(s) and the catalyst(s), the polymer chain(s), or both.

17. The method of claim 1, wherein the method is used to determine a polymer sequence, reaction kinetics, reaction dynamics, catalysis cooperativity between spatially distinct sites, or molecular adsorption onto a surface.

18. A system for imaging a fluorescent polymerization product comprising
a first laser configured to provide coherent electromagnetic radiation comprising a first wavelength, wherein the first wavelength is suitable to initiate a photo-uncaging reaction; and
a second laser configured to provide coherent electromagnetic radiation comprising a second wavelength, wherein the second wavelength is suitable to obtain one or more fluorescent image(s) of a product of a fluorogenic polymerization of a monomer comprising a fluorophore and the product is disposed on a substrate.

19. The system of claim 18, the system further comprising one or more reactor(s), each reactor independently configured to carry out a photo-uncaging reaction and/or a fluorogenic polymerization.

20. The system of claim 19, wherein one or more or all the one or more reactor(s) is/are microfluidic reactors.

21. The system of claim 18, wherein the second laser is configured for activation for a duration sufficient to both image and to substantially or completely photobleach a product of a fluorogenic polymerization of a monomer comprising a fluorophore.

22. The system of claim 18, the system further comprising a third laser configured to provide coherent electromagnetic radiation comprising a third wavelength,
wherein the third wavelength is suitable to obtain one or more florescent image(s) of a product of a fluorogenic polymerization of a monomer that is different than the product of the fluorogenic polymerization of that can be imaged using the second laser.

23. The system of claim 22, wherein the first laser, the second laser, and third laser, if present, are arranged in a total internal reflectance geometry or epi-illumination geometry.

24. The system of claim 22, wherein the third laser is configured for activation for a duration sufficient to both image and to substantially or completely photobleach a product of a fluorogenic polymerization of a monomer comprising a fluorophore.

25. The system of claim 18, wherein the system is configured to optically image a product of a fluorogenic polymerization of a monomer.

26. The system of claim 25, wherein at least a portion of or all the optical image(s) is/are single-molecule localization microscopy image(s).
